(19) United States
(12) Patent Application Publication
(10) Pub. No.: US 2025/0256864 A1
(43) Pub. Date: Aug. 14, 2025

(54) Methods and Systems for Using Artificial Intelligence to Improve Space Launch Operations

(71) Applicant: Launch on Demand Corporation, Cocoa Beach, FL (US)

(72) Inventors: Burton H. CATLEDGE, Cocoa Beach, FL (US); Subash CHELLAPPAN, Cocoa Beach, FL (US)

(21) Appl. No.: 19/049,696

(22) Filed: Feb. 10, 2025

Related U.S. Application Data
(60) Provisional application No. 63/552,005, filed on Feb. 9, 2024.
(60) Provisional application No. 63/644,635, filed on May 9, 2024.

(51) Int. Cl. B64G 1/00; G06Q 10/0631

(52) U.S. Cl. CPC B64G 1/002; G06Q 10/06312

(57) ABSTRACT

Systems and methods for providing a space launch service platform (SLSP) that integrates artificial intelligence and data analytics to support launch operations. The SLSP may connect to multiple data sources, collect data, and standardize the collected data according to regulatory and operational standards. The SLSP may evaluate launch safety and risks using standardized data and generate a situational analysis for decision-making. The SLSP may provide graphical overlays and decision-support tools to highlight optimal launch windows and potential risks.

### RELATED APPLICATIONS

This application claims the benefit of priority to U.S. Provisional Application No. 63/552,005, entitled “Methods and Systems for Enhancing Space Launch Operations” filed Feb. 9, 2024 and U.S. Provisional Application No. 63/644,635, entitled “Methods and Systems for Using Artificial Intelligence to Improve Space Launch Operations” filed May 9, 2024, the entire contents of both of which are hereby incorporated by reference herein for all purposes.

### BACKGROUND

Generally, space launch vehicle operators (e.g., NASA, Blue Origin Enterprises, L.P., etc.) are public and/or private organizations or entities responsible for overseeing processes involved in launching launch vehicle from Earth's surface into space. These operators handle numerous facets of space missions, from the technical to the logistical and regulatory. Spacelift is the process of transporting payloads, such as satellites, launch vehicle, equipment for scientific research, etc., from Earth's surface into space. Traditionally, spacelift depends heavily on infrastructure and support from various agencies, including the Department of Defense.

Operators must navigate various technical challenges and regulatory processes, including coordinating air traffic diversion and receiving launch windows from the Federal Aviation Administration. Due to public safety considerations, conventional spacelift solutions are tightly controlled, and space launch vehicle operators are often forced to use pre-set launch windows with limited access to airspace. Such constraints may delay key aspects of launch readiness, including aligning with orbital mechanics and optimal weather. In the event of launch windows being scrubbed and a secondary launch time is chosen within the approved launch window, there is an increased risk of misinformation to air traffic and marine traffic operators, including population within a 20 nautical mile radius, risk of misalignment across environmental constraint conditions, launch vehicle constraints, which lead to scheduling risks and uncalculated risks to close out of an approved FAA launch window.

In response to these and other challenges, there has been a marked increase in the demand for advanced space launch opportunity determination and coordination systems. These systems may be configured to integrate and monitor extensive data sets from diverse sources (e.g., satellite and orbital debris catalogs, airspace and maritime tracking systems, weather monitoring, range monitoring systems, etc.) to enhance mission assurance and public safety, such as by providing dynamic, real-time decision-making capabilities.

New and improved systems that provide advancements in the field of spacelift to offer safer, more reliable, more efficient, and more adaptive solutions will benefit a broad community of stakeholders, including space launch operators, payload owners, and the general public.

### SUMMARY

Various aspects include methods for identifying a launch window for a launch vehicle, which may include receiving constraint data associated with launch operations (the constraint data including at least one of terrestrial, atmospheric, orbital, or operational constraints derived from real-time monitoring systems, historical records, or predictive models), normalizing the received constraint data into a standardized format by performing operations including resolving inconsistencies, aligning measurement units to a common scale, and structuring data for computational analysis into numerical, categorical, or vectorized representations, generating a constraint graph based on the standardized constraint data (the constraint graph including nodes representing individual constraints and edges representing interdependencies between the constraints), identifying a plurality of time intervals from the constraint graph, in which each time interval is associated with a computed metric indicating constraint overlap across the time interval, computing a confidence score for each identified time interval based on a statistical analysis of historical launch outcomes, real-time monitoring data, and predictions generated by machine learning models trained to evaluate constraint variability and operational feasibility, selecting a launch window from the identified time intervals based on the confidence scores (in which the selected launch window corresponds to the time interval with the highest confidence score and satisfies predefined launch criteria associated with safety, resource availability, and regulatory compliance), and adjusting at least one operational parameter associated with the launch based on the selected launch window (in which the adjustment may include modifying a trajectory profile, rescheduling ground operations, or reallocating resources at the launch site to align with the selected window).

Some aspects may further include generating a launch readiness report including the selected launch window, adjusted operational parameters, and an evaluation of constraint satisfaction. In some aspects, receiving the constraint data further may include aggregating terrestrial object data, orbital object data, weather data, upper atmospheric data, and operational data from multiple sources, including real-time monitoring systems, historical databases, and predictive modeling systems, and to categorize the received constraint data into structured datasets corresponding to predefined categories for terrestrial, atmospheric, orbital, and operational parameters.

In some aspects, normalizing the received constraint data further may include applying an artificial intelligence model configured to correct inconsistencies, fill missing values, and classify the constraint data into predefined categories. In some aspects, generating the constraint graph may include mapping temporal relationships between airspace availability, maritime clearance zones, weather conditions, and orbital conjunction risks, in which the constraint graph encodes interdependencies among constraints to enhance the accuracy of launch feasibility assessments. In some aspects, computing the confidence score for each identified time interval may include executing a machine learning model trained on historical launch schedules, atmospheric conditions, mission outcomes, and real-time constraint variability to predict the likelihood of satisfying operational criteria. In some aspects, selecting the launch window further may include generating a ranked list of alternative launch windows, each associated with a respective confidence score, to provide contingency options in response to real-time changes in constraint conditions.

Some aspects may further include monitoring real-time updates to constraint data, and dynamically adjusting the selected launch window to accommodate changes in constraint conditions and maintain compliance with predefined operational requirements. Some aspects may further include modifying a planned trajectory of the launch vehicle based on real-time updates to constraint data to remain in compliance with airspace, maritime, and orbital clearance regulations. Some aspects may further include executing a reinforcement learning model to iteratively refine the launch window selection by incorporating feedback from prior launches and updating machine learning parameters based on historical and real-time performance data.

Further aspects may include a computing device having a processor configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary embodiments of the claims and, together with the general description given and the detailed description, serve to explain the features herein.

FIG. 1 is a component block diagram illustrating example components in a system in package (SIP) that may be included in a computing device and configured to implement some embodiments.

FIGS. 2A and 2B are component block diagram illustrating components of a system that could be configured to determine launch windows for advanced collision avoidance in accordance with some embodiments.

FIG. 3 is a process flow diagram illustrating a method of determining launch windows for advanced collision avoidance in accordance with some embodiments.

FIG. 4 is a component block diagram illustrating example components in an updated space launch service platform (SLSP) that could be configured to use artificial intelligence to improve launch operations in accordance with some embodiments.

FIG. 5 is a process flow diagram illustrating a method for AI-based risk analysis and decision support in launch operations in accordance with some embodiments.

FIG. 6 is a process flow diagram illustrating a method for AI-based launch window identification and constraint optimization in launch operations in accordance with some embodiments.

FIG. 7A is a process flow diagram illustrating a method for AI-based weather hazard detection and launch risk mitigation in accordance with some embodiments.

FIG. 7B is a process flow diagram illustrating a method for AI-based risk assessment of three-sigma launch trajectory deviations in accordance with some embodiments.

FIG. 8A is a process flow diagram illustrating a method for AI-based correlation of launch trajectory data with hazard information in accordance with some embodiments.

FIG. 8B is a process flow diagram illustrating a method for adaptive AI-based hazard analysis in launch decision-making in accordance with some embodiments.

FIG. 9A is a process flow diagram illustrating a method for AI-based identification of terrestrial object hazards in launch operations in accordance with some embodiments.

FIG. 9B is a process flow diagram illustrating a method for AI-based detection and prediction of anomalous terrestrial object movements in accordance with some embodiments.

FIG. 10A is a process flow diagram illustrating a method for AI-based lightning hazard identification and risk assessment in launch operations in accordance with some embodiments.

FIG. 10B is a process flow diagram illustrating a method for AI-based prediction of hazardous weather conditions affecting launch operations in accordance with some embodiments.

FIG. 11A is a process flow diagram illustrating a method for AI-based orbital object collision prediction in launch planning in accordance with some embodiments.

FIG. 11B is a process flow diagram illustrating a method for AI-based collision avoidance and trajectory optimization for orbital objects in accordance with some embodiments.

FIG. 12A is a process flow diagram illustrating a method for AI-based logistics coordination in launch operations in accordance with some embodiments.

FIG. 12B is a process flow diagram illustrating a method for AI-based dynamic scheduling adjustments in launch operations in accordance with some embodiments.

FIG. 13A is a process flow diagram illustrating a method for AI-based multi-stakeholder logistics management in launch operations in accordance with some embodiments.

FIG. 13B is a process flow diagram illustrating a method for AI-based dynamic launch schedule adjustments in accordance with some embodiments.

FIG. 14 is a process flow diagram illustrating a method for AI-based conflict resolution in launch operations in accordance with some embodiments.

FIG. 15 is a process flow diagram illustrating a method for identifying constraints in accordance with some embodiments.

FIG. 16 is a process flow diagram illustrating a method for dynamically adjusting a launch schedule in response to real-time events in accordance with some embodiments.

FIG. 17 is a process flow diagram illustrating a method for generating launch relevant information in accordance with some embodiments.

FIG. 18 is a process flow diagram illustrating a method for determining launch trajectory conditions for a vehicle in accordance with some embodiments.

FIG. 19 is a process flow diagram illustrating a method for mitigating risks associated with rocket launch delays in accordance with some embodiments.

FIG. 20 is a process flow diagram illustrating a method coordinating rocket launches across multiple stakeholders in accordance with some embodiments.

FIG. 21 is a process flow diagram illustrating a method generating actionable insights from launch-related data in accordance with some embodiments.

FIG. 22 is a process flow diagram illustrating a method enhancing launch site resource allocation in accordance with some embodiments.

FIG. 23 is a process flow diagram illustrating a method managing and monetizing spaceport facilities in accordance with some embodiments.

FIG. 24 is a process flow diagram illustrating a method for generating and outputting launch constraints and recommendations in accordance with some embodiments.

FIG. 25 is a component diagram of an example laptop computing device suitable for implementing some embodiments.

FIG. 26 is a component diagram of an example mobile computing device suitable for implementing some embodiments.

FIG. 27 is a component diagram of an example server computing device suitable for implementing some embodiments.

### DETAILED DESCRIPTION

Various embodiments will be described in detail with reference to the accompanying drawings. Wherever possible, the same reference numbers will be used throughout the drawings to refer to the same or similar parts. References made to particular examples and implementations are for illustrative purposes and are not intended to limit the scope of the claims.

For the sake of clarity and ease of presentation, the methods herein (e.g., 300, 500, 600, 700, 750, 800, 850, 900, 950, 1000, 1050, 1100, 1150, 1200, 1250, 1300, 1350, 1400-2400, etc.) are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. to produce a modified or alternative result or solution. The presentation of individual methods, blocks, operations, etc. should not be interpreted as mutually exclusive, limiting, or as being required unless expressly recited as such in the claims.

In overview, the embodiments include a sophisticated space launch service platform (SLSP) that provides a comprehensive and integrated approach to launch operations. The SLSP may use advanced artificial intelligence (AI) and data analytics technologies across multiple operational domains to improve the efficiency, safety, and reliability of launches. The SLSP may coordinate and integrate diverse technologies and components into a single operational platform that may be used to manage the complexities of space launches or spacelift operations.

The SLSP may be configured to incorporate a safety perspective into launch day services. The increasing number of launches across various regions has caused various challenges, including adverse weather conditions, problematic flight or marine traffic patterns, and the unclear risk of in-orbit collisions. These elements contribute to bottlenecks that can delay or interrupt scheduled launches. The SLSP may be configured to mitigate these challenges through comprehensive flight safety analysis and advanced surveillance technologies.

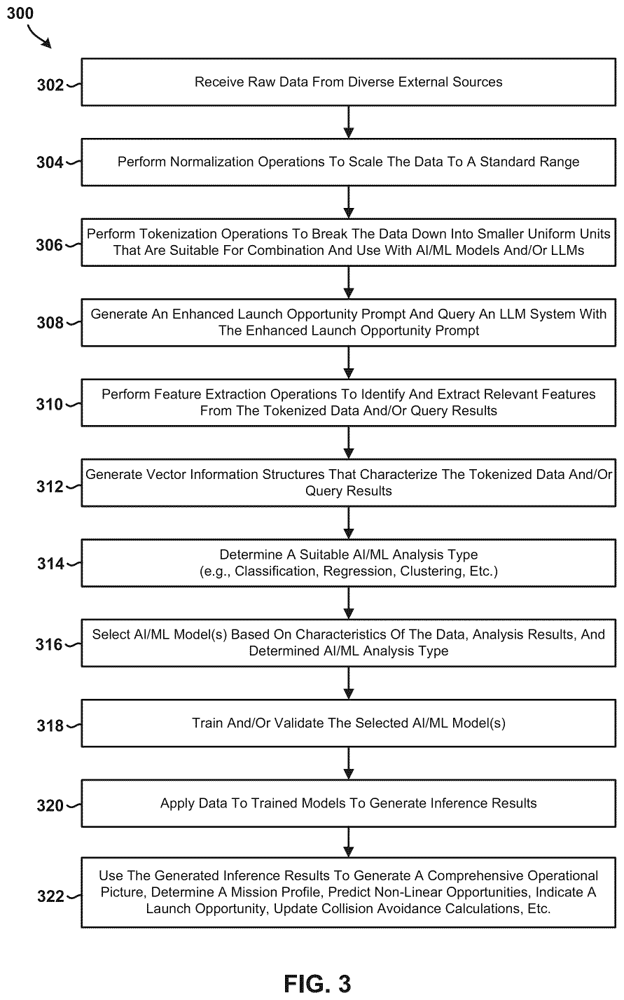

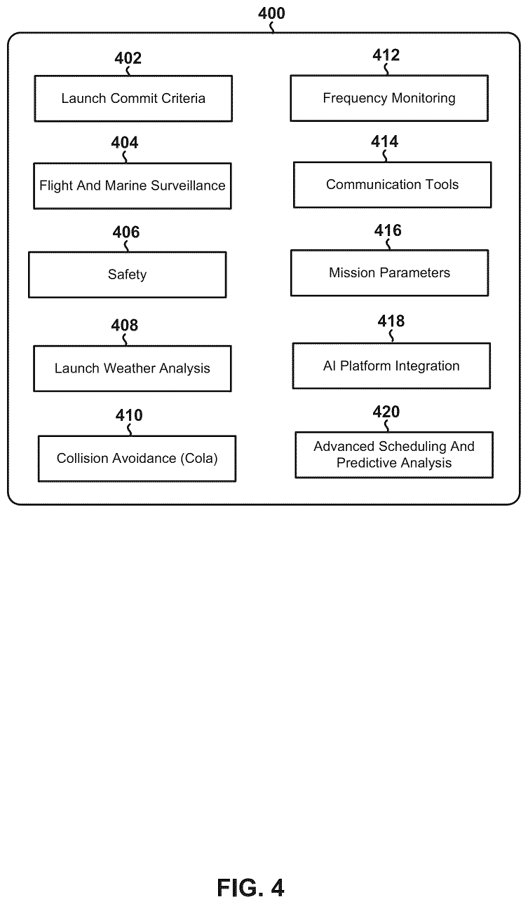

As is discussed in more detail below (e.g., with reference to FIGS. 3 and 4, etc.), in some embodiments, the SLSP may be configured to visually represent trajectories and Notices to Airmen (NOTAMs) and Notices to Mariners (NOTMARs) on operational maps. The SLSP may enhance data reliability by correcting FAA-published information, which sometimes does not display correctly, appearing skewed like hourglasses. The SLSP may identify temporary flight restrictions (TFRs) and predict their future configurations based on historical data and current trends. During launch operations, the SLSP may allow for the simultaneous tracking of multiple trajectories in real-time.

In some embodiments, the SLSP may be configured to aggregate data from various sources, including the National Weather Service, to assess launch viability. For example, this analysis may be performed up to four hours prior and up to two days ahead of a scheduled launch, focusing on specific launch pads. The SLSP may provide a current snapshot of weather conditions and/or a secondary confirmation for launch readiness. The SLSP may analyze key metrics analyzed, including lightning probability, Doppler radar data, and upper air observations to gauge atmospheric pressure at different altitudes. The SLSP may digitize and apply the weather data to specific vessels or clients, tailored to their unique thresholds for elements such as radiation exposure and atmospheric conditions.

In some embodiments, the SLSP may be configured to use simulations derived from comprehensive orbital catalog data to identify optimal and risky launch times. The SLSP may use this data to predict potential collisions with space debris or other orbiting objects (known as conjunctions) and to schedule launches when the risk is minimized.

In some embodiments, the SLSP may include advanced scheduling capabilities that use AI to forecast and dynamically adjust to live constraints based on flight and marine schedules. This may include identifying which assets will be in specific areas at given times and adjusting accordingly. In some embodiments, the SLSP may use AI systems to continuously refine these projections. The SLSP may continuously assess changes in weather and other environmental factors to identify optimal launch windows that align with client specifications and safety standards.

The various embodiments may enhance the functionality, performance, and reliability of computing systems and launch solutions by optimizing the process of satellite launches and enhance the reliability, efficiency, and safety of space missions. These and other improvements may be achieved through the integration of comprehensive real-time data analysis, the application of advanced artificial intelligence technologies, and the enhancement of dynamic decision-making capabilities. In addition, the methods allow more accurate predictions of optimal launch conditions, enhanced situational awareness, and effective risk management (e.g., by using diverse data sources and AI to standardize and analyze the data, etc.). In addition, the embodiments improve and allow the launch systems to be highly adaptable and dynamically respond to unforeseen changes in the operational environment.

Various other and additional features, functions, enhancements, and/or improvements to the performance and functioning of computing systems and launch solutions will be evident from the disclosures below.

The term “space launch vehicle operator” may be used herein to refer to an entity or organization responsible for managing and executing the launch of launch vehicle or satellites into space. A space launch vehicle operator may oversee the entire launch process, including vehicle design, launch preparation, scheduling coordination, compliance with safety and regulatory standards, and payload deployment.

The term “spacelift” may be used herein to refer to operations associated with launching payloads from Earth's surface into space. Spacelift operations may include planning, preparation, execution, and management of launch vehicle or satellite launches, encompassing technical, logistical, and regulatory aspects.

The term “computing device” may be used herein to refer to any one or all of personal computing devices, personal computers, workstations, laptop computers, Netbooks, Ultrabook, tablet computers, mobile communication devices, smartphones, user equipment (UE), personal data assistants (PDAs), palm-top computers, wireless electronic mail receivers, multimedia internet-enabled cellular telephones, media and entertainment systems, gaming systems (e.g., PlayStation™, Xbox™, Nintendo Switch™), media players (e.g., DVD players, Roku™, apple TV™), digital video recorders (DVRs), vehicle systems such as rockets and drones, airplanes, automobiles and other similar devices that include a programmable processor, SOC, or processing system that may be configured to provide the functionality of various embodiments.

The terms “component,” “module,” “system,” “engine,” and the like are used in this application to refer to a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer-readable media that have various instructions and/or data structures stored thereon. Components may communicate by way of local and/or remote processes, function or procedure calls, electronic signals, data packets, memory read/writes, and other known network, computer, processor, and/or process-related communication methodologies.

The term “processing system” may be used herein to refer to one or more processors, including multi-core processors, that are organized and configured to perform various computing functions. Various embodiment methods may be implemented in one or more of multiple processors within a processing system as described herein.

The term “system on chip” (SoC) may be used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system also may include software for controlling integrated resources and processors, as well as for controlling peripheral devices.

The term “system in a package” (SIP) may be used herein to refer to a single module or package that contains multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The terms “machine learning algorithm” and “artificial intelligence model” may be used herein to refer to any of a variety of information structures that may be used by a computing device to perform a computation or evaluate a specific condition, feature, factor, dataset, or behavior on a device. Examples of machine learning (ML) algorithms include network models, neural network models, inference models, neuron models, classifiers, random forest models, spiking neural network (SNN) models, convolutional neural network (CNN) models, recurrent neural network (RNN) models, deep neural network (DNN) models, generative network models, ensemble networks, generative adversarial networks, and genetic algorithm models. In some embodiments, a machine learning algorithm may include an architectural definition (e.g., the neural network architecture, etc.) and one or more weights (e.g., neural network weights, etc.).

The term “neural network” may be used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” may be used herein to refer to a process that is performed at runtime or during the execution of the software application program corresponding to the neural network. Inference may include traversing the processing nodes in the neural network along a forward path to produce one or more values as an overall activation or overall “inference result.”

The term “deep neural network” may be used herein to refer to a neural network that implements a layered architecture in which the output/activation of a first layer of nodes becomes an input to a second layer of nodes, the output/activation of a second layer of nodes becomes an input to a third layer of nodes, and so on. As such, computations in a deep neural network may be distributed over a population of processing nodes that make up a computational chain. Deep neural networks may also include activation functions and sub-functions between the layers. The first layer of nodes of a multilayered or deep neural network may be referred to as an input layer. The final layer of nodes may be referred to as an output layer. The layers in-between the input and final layer may be referred to as intermediate layers.

The term “convolutional neural network” (CNN) may be used herein to refer to a deep neural network in which the computation in at least one layer is structured as a convolution. A convolutional neural network may also include multiple convolution-based layers, which allows the neural network to employ a very deep hierarchy of layers. In convolutional neural networks, the weighted sum for each output activation is computed based on a batch of inputs, and the same matrices of weights (called “filters”) are applied to every output. These networks may also implement a fixed feedforward structure in which all the processing nodes that make up a computational chain are used to process every task, regardless of the inputs. In such feed-forward neural networks, all of the computations are performed as a sequence of operations on the outputs of a previous layer. The final set of operations may generate the overall inference result of the neural network, such as a probability that an image contains a specific object (e.g., a person, cat, watch, edge, etc.) or information indicating that a proposed action should be taken.

The term “recurrent neural network” (RNN) may be used herein to refer to a class of neural networks particularly well-suited for sequence data processing. Unlike feedforward neural networks, RNNs may include cycles or loops within the network that allow information to persist. This enables RNNs to maintain a “memory” of previous inputs in the sequence, which may be beneficial for tasks in which temporal dynamics and the context in which data appears are relevant.

The term “long short-term memory network” (LSTM) may be used herein to refer to a specific type of RNN that addresses some of the limitations of basic RNNs, particularly the vanishing gradient problem. LSTMs include a more complex recurrent unit that better facilitates the flow of gradients during backpropagation. This in turn facilitates the model's ability to learn from long sequences and remember over extended periods, making it apt for tasks such as language modeling, machine translation, and other sequence-to-sequence tasks.

The term “transformer” may be used herein to refer to a specific type of neural network that includes an encoder and/or a decoder and is particularly well-suited for sequence data processing. Transformers may use multiple self-attention components to process input data in parallel rather than sequentially. The self-attention components may be configured to weigh different parts of an input sequence when producing an output sequence. Unlike solutions that focus on the relationship between elements in two different sequences, self-attention components may operate on a single input sequence. The self-attention components may compute a weighted sum of all positions in the input sequence for each position, which may allow the model to consider other parts of the sequence when encoding each element. This may offer advantages in tasks that benefit from understanding the contextual relationships between elements in a sequence, such as sentence completion, translation, and summarization. The weights may be learned during the training phase, allowing the model to focus on the most contextually relevant parts of the input for the task at hand. Transformers, with their specialized architecture for handling sequence data and their capacity for parallel computation, often serve as foundational elements in constructing large generative AI models.

The term “large generative AI model” (LXM) may be used herein to refer to an advanced computational framework that includes any of a variety of specialized AI models including, but not limited to, large language models (LLMs), large speech models (LSMs), large/language vision models (LVMs), vision language models (VLMs)), hybrid models, and multi-modal models. An LXM may include deep neural network layers (e.g., RNN, LSTM, transformers, etc.) that contain millions or even billions of parameters. Unlike conventional systems that convert user prompts into a navigable series of files or web pages, LXMs facilitate interactive dialogues and store extensive knowledge internally. Consequently, LXMs may provide concise answers directly, bypassing the need to sift through a list of web pages, and excel at tasks such as text summarization, translation, complex question answering, and serving as conversational agents. In various embodiments, LXMs may operate independently as standalone units, may be integrated into more comprehensive systems and/or into other computational units (e.g., those found in a SoC or SIP, etc.). They may also be linked with specialized hardware accelerators to enhance performance indicators such as response time and processing capacity. In some embodiments, the capabilities of an LXM may be augmented with adaptive algorithms that refine its ability to process and understand context-specific information, including details pertinent to space launches. These adaptive algorithms may be performed by the same processing system that manages the core functionality of the LXM and/or may be distributed across multiple independent processing systems.

The terms “contextualized query” and “contextualized query response” may be used herein to refer to a query or query response that has been augmented with additional contextual data or metadata to improve the relevance and specificity of information contained therein. For example, some embodiments may include components configured to generate and send a contextualized query to an external system (e.g., LXM, etc.) to receive a contextualized query response.

The term “embedding layer” may be used herein to refer to a specialized layer within a neural network, typically at the input stage, that transforms continuous or discrete categorical values or tokens into continuous, high-dimensional vectors. An embedding layer may also transform high-dimensional data into low-dimensional vectors (e.g., using “dimensionality reduction” techniques, etc.), which may be particularly useful when the original data is complex or too large to handle efficiently. The embedding layer may also convert tokens (typically low-dimensional entities) into high-dimensional vectors. An embedding layer may operate as a lookup table in which each unique token or category is mapped to a point in a continuous vector space. The vectors may be refined during the model's training phase to encapsulate the characteristics or attributes of the tokens in a manner that is conducive to the tasks the model is configured to perform.

The term “token” may be used herein to refer to a unit of information that a generative AI model (e.g., LXM, etc.) may read as a single input during training and inference. Each token may represent any of a variety of different data types. For example, in text-centric models such as in LXMs, each token may represent a textual element such as a paragraph, sentence, clause, word, sub-word, character, etc. In models designed for auditory data, each token may represent a feature extracted from audio signals, such as a phoneme, spectrogram, temporal dependency, Mel-frequency cepstral coefficients (MFCCs) that represent small segments of an audio waveform, etc. In visual models, each token may correspond to a portion of an image (e.g., pixel blocks), sequences of video frames, etc. In hybrid systems that combine multiple modalities (text, speech, vision, etc.), each token may be a complex data structure that encapsulates information from various sources. For example, a token may include both textual and visual information, each of which independently contributes to the token's overall representation in the model.

Each token may be converted into a numerical vector via the embedding layer. Each vector component (e.g., numerical value, parameter, etc.) may encode an attribute, quality, or characteristic of the original token. The vector components may be adjustable parameters that are iteratively refined during the model training phase to improve the model's performance during subsequent operational phases. The numerical vectors may be high-dimensional space vectors (e.g., containing more than 300 dimensions, etc.) in which each dimension in the vector captures a unique attribute, quality, or characteristic of the token. For example, dimension 1 of the numerical vector may encode the frequency of a word's occurrence in a corpus of data, dimension 2 may represent the pitch or intensity of the sound of the word at its utterance, dimension 3 may represent the sentiment value of the word, etc. Such representation in high-dimensional space may help the LXM understand the semantic and syntactic subtleties of its inputs. During the operational phase, the tokens may be processed sequentially through layers of the LXM or neural network, which may include structures or networks appropriate for sequence data processing, such as transformer architectures, recurrent neural networks (RNNs), or long short-term memory networks (LSTMs).

The term “SmartLaunch Edge” may be used herein to refer to a remote computing device (e.g., at the launch site, etc.) configured with processor-executable instructions to extend and bridge cloud technologies with the existing infrastructure at launch facilities. In the various embodiments, any or all of the components discussed in this application may be included within the SmartLaunch Edge remote computing device. This integration may augment or enhance the capabilities of launch sites by leveraging data pertinent to launch conditions. Examples of functionalities that could enabled by SmartLaunch Edge in accordance with the various embodiments include extracting meteorological data directly from the launchpad area and utilizing various tracking technologies (such as RFID, LoRa, BLE, GPS, etc.) to monitor the movement of assets within the launch site. In addition, computer vision cameras may be used to assess environmental conditions near the launch area, identify factors such as cloud formations, and ensure personnel safety through lockout/tagout procedures. The SmartLaunch Edge may also facilitate the collection and analysis of launch vehicle telemetry to enhance operational efficiency and safety of space launch activities.

The term “constraint” may be used herein to refer to a parameter, condition, or rule that defines a boundary within which a process, operation, or computation may be executed. A constraint may be based on measurable physical, environmental, regulatory, operational, or computational factors and may be applied to decision-making processes in automated or semi-automated systems. A constraint may be dynamically determined based on input data received from sensors, databases, predictive models, or real-time monitoring systems. For example, a constraint may define a permissible or restricted time interval based on the presence or absence of interfering factors, such as airspace constraints (e.g., restricted flight zones, commercial air traffic, FAA-mandated no-fly periods, etc.), maritime constraints (e.g., vessel proximity to a launch corridor and navigational hazards, etc.), orbital constraints (e.g., potential collision risks from tracked space debris and satellite trajectories), weather constraints (e.g., atmospheric conditions such as wind shear, cloud coverage, and lightning activity, etc.), and logistical constraints (e.g., personnel availability, fuel preparation time, pre-launch sequencing of ground operations, etc.). In various embodiments, constraints may be expressed as quantifiable data points, threshold values, or time-dependent conditions that govern whether an event or operation may proceed. A constraint may be evaluated computationally using structured rules, machine learning algorithms, neural network models, or other decision-making systems. In some embodiments, a constraint may be represented as a computational function, which when applied to a given input dataset, generates an output that determines whether a particular action (e.g., a launch, etc.) may be initiated, delayed, or adjusted. A constraint may serve as the basis for a constraint line that dynamically represents the constraint's applicability over time to allow for predictive scheduling, automated decision-making, etc.

The term “constraint line” may be used herein to refer to a data structure, mathematical function, or graphical representation that encodes the time-dependent status of a constraint. For example, a constraint line may be a function of time that represents the changing applicability of a constraint based on real-time system conditions. A constraint line may define one or more discrete or continuous time intervals during which an associated constraint is satisfied, unsatisfied, or subject to conditional dependencies. In various embodiments, a constraint line may be derived from sensor data, historical datasets, predictive modeling, probabilistic estimations, or computational rule evaluations. The constraint line may be stored in a memory structure such as a time series database, vector-based storage format, or graph-based data model. The constraint line may be generated, updated, or modified using algorithms that incorporate dynamic inputs (e.g., satellite tracking data, real-time meteorological observations, aerospace flight patterns, etc.). For example, a constraint line associated with airspace clearance may represent time intervals during which a specified airspace region is unoccupied by aircraft, a constraint line associated with weather conditions may indicate whether wind speeds at a launch altitude remain below a defined threshold, a constraint line associated with orbital debris tracking may define windows when no high-risk debris objects intersect a planned launch trajectory. Some embodiments may analyze, process, or combine multiple constraint lines using computational techniques such as intersection analysis (e.g., in which overlapping intervals across multiple constraint lines determine an optimal execution window), machine learning-based forecasting (e.g., in which neural network models predict future constraint line modifications based on historical trends, etc.), time series analysis (e.g., in which constraint line fluctuations are evaluated to assess operational feasibility over a specified timeframe). Some embodiments may implement a multi-variable computational technique in which constraint lines for independent constraints (e.g., weather, airspace, orbital conditions, etc.) are weighted and evaluated in a cost-function model to determine an optimal time window. In some embodiments, constraint lines may be transmitted between computing devices, servers, or networked systems for distributed launch feasibility determinations.

The term “constraint graph” may be used herein to refer to a computational data structure representing the relationships between multiple constraints affecting a process, operation, or decision-making system. A constraint graph may include nodes representing individual constraints and edges defining dependencies, interactions, or conditional relationships among the constraints. The constraint graph may be dynamically generated and updated based on real-time or historical data sources, including sensor readings, predictive models, regulatory requirements, and operational constraints. In various embodiments, the constraint graph may encode hierarchical, temporal, or probabilistic dependencies to model complex interactions between airspace restrictions, maritime traffic regulations, orbital conjunction risks, meteorological conditions, and logistical limitations affecting launch scheduling. A processing system may analyze the constraint graph to determine how the satisfaction or violation of one constraint influences the status of dependent constraints, facilitating automated feasibility assessments, risk evaluations, and launch window determinations. For example, a constraint graph may represent how a weather constraint (e.g., high wind speeds) affects airspace availability for launch vehicle ascent or how an orbital debris conjunction influences the scheduling of a planned trajectory. In some embodiments, the constraint graph may be stored in graph-based databases or in-memory data structures optimized for high-speed computational analysis. Some implementations may apply graph algorithms such as pathfinding, clustering, or shortest-path determination to identify optimal execution windows where multiple constraints align. In some embodiments, constraint graphs may be distributed across networked systems to support collaborative decision-making among multiple stakeholders, including space agencies, launch providers, and regulatory bodies.

Thus, a constraint line may define the time-dependent status of an individual constraint and a constraint graph may model the relationships and interdependencies between multiple constraints to provide a holistic view of operational feasibility. A constraint graph may include or use multiple constraint lines, using their time intervals and variability to analyze how different constraints interact and influence one another. For example, a constraint graph may use overlapping constraint lines for airspace availability, weather conditions, and orbital conjunctions to determine whether a launch window satisfies all operational requirements. The processing system may dynamically update the constraint graph as new constraint lines are generated or modified, allowing for real-time assessment of how changes in one constraint propagate through dependent constraints. By structuring constraints in both temporal and relational formats, the system improves decision-making by integrating time-series analysis with dependency mapping, allowing for improved and more adaptive scheduling, predictive forecasting, and automated launch feasibility evaluations.

The term “three-sigma trajectory deviations” may be used herein to refer to trajectory variations quantified using a statistical method that models deviations within three standard deviations from a reference trajectory. The deviations may result from uncertainties in propulsion system performance, atmospheric disturbances, guidance errors, or vehicle dynamics. A reference trajectory may define an idealized flight path, while three-sigma trajectory deviations represent the statistically probable range within which a launch vehicle's actual trajectory may vary. A processing system may use three-sigma trajectory deviations to assess compliance with operational constraints by comparing projected flight paths against hazard areas, airspace restrictions, and orbital conjunction risks. For example, if a three-sigma deviation indicates a potential intersection with restricted airspace, the processing system may adjust launch timing, trajectory parameters, or flight constraints to mitigate risks. In some embodiments, machine learning models or adaptive algorithms may refine three-sigma deviation calculations by incorporating real-time telemetry data, environmental conditions, and vehicle performance metrics to improve predictive accuracy.

The term “three-sigma deviation boundaries” may be used herein to refer to the computationally determined spatial and temporal limits that define the outermost extent of three-sigma trajectory deviations. These boundaries may represent the maximum expected dispersion of a launch vehicle's trajectory from its nominal path, accounting for propulsion variability, aerodynamic fluctuations, and environmental influences. A processing system may generate three-sigma deviation boundaries by analyzing historical launch performance data, real-time sensor inputs, and probabilistic flight simulations. These boundaries may be applied in launch planning to evaluate potential interactions with flight constraints, such as airspace restrictions, maritime activity zones, or orbital collision probabilities. In some embodiments, three-sigma deviation boundaries may be visualized as a dynamic safety corridor encompassing the range of expected vehicle movement, allowing real-time monitoring and adaptation of launch parameters. A processing system may continuously update these boundaries based on telemetry feedback, improving the responsiveness and accuracy of constraint evaluations during pre-launch and in-flight operations. In some implementations, three-sigma deviation boundaries may be integrated into automated decision-support systems, enabling predictive risk mitigation, adaptive trajectory corrections, and constraint-driven launch scheduling.

The various embodiments include computing devices equipped with processors and/or components configured to receive multiple data feeds from diverse data sets, receive or collect monitoring data, combine the received/collected data, generate a comprehensive operational picture, determine a mission profile, receive a launch goal, predict non-linear opportunities, evaluate condition-based criteria, and/or indicate a launch opportunity.

In some embodiments, the components may be configured to receive a first data feed that provides positional information about objects in orbit (e.g., from a satellite catalog, etc.), a second data feed that provides positional information about aircraft, a third data feed that provides positional information about maritime vessels, and a fourth data feed that provides monitoring data from the launch site (e.g., weather conditions, launch pad statuses, or other variables that could affect the launch, etc.). In some embodiments, the components may also receive and integrate data from additional sources, including national airspace system data (e.g., airspace availability, flight paths, traffic, Notices to Airmen, Notices to Mariners, etc.), marine transportation system data (e.g., maritime traffic, vessel positions, sea routes, etc.), orbital object catalog data (e.g., satellites, space debris, and other objects in orbit, etc.), weather monitoring system data (e.g., real-time and forecasted meteorological data, etc.), telemetry data from launch vehicles (e.g., real-time performance and positional data, etc.), satellite tracking system data (e.g., tracking data for orbital collision avoidance, etc.), flight tracking system data (e.g., air traffic monitoring data, etc.), spectrum monitoring data (e.g., radio frequency spectrum data for communication and navigation, etc.), geospatial information system (GIS) data (e.g., mapping and spatial data for launch areas, etc.), global positioning system (GPS) data (e.g., precise location data for tracking and navigation, etc.), launch vehicle performance data (e.g., status and capability data, etc.), and environmental monitoring data (e.g., local environmental conditions at the launch site, etc.).

In some embodiments, the components may be configured to perform computations to determine launch schedules. In some embodiments, the components may use LXMs and tailored prompts to analyze datasets based on constraint theory principles. These computations may identify sources of constraints, including both announced (e.g., Notices to Airmen, Notices to Mariners, etc.) and unannounced sources (e.g., data from space launch vehicle operators, etc.) to determine hazard areas. The components may use LXMs and custom prompts to refine this data by converting hazard area coordinates into numerical format (e.g., decimal, etc.), eliminating formatting inconsistencies, validating coordinates, linking coordinates to identify mapping errors, comparing identified patterns against historical launches by the same space launch vehicle operator, and performing related operations.

In some embodiments, the components may be configured to identify constraints. These constraints may include environmental conditions (e.g., weather patterns, lightning risks, etc.), regulatory requirements (e.g., airspace and maritime traffic regulations, etc.), technical limitations (e.g., launch vehicle performance parameters or required safety margins, etc.), and logistical challenges (e.g., coordination with air and maritime traffic, etc.). Constraints may also include criteria that affect launch operations, such as avoiding conflicts with commercial and recreational air and sea traffic, complying with environmental regulations, and adhering to national and international laws governing space launches. In some embodiments, the components may identify, analyze, and manage constraints as part of space launch operations to reduce risk and align operations with payload deployment requirements.

In some embodiments, the components may be configured to identify air and maritime traffic constraints, such as scheduled aircraft and vessels that could enter hazard areas during planned launch windows. The components may use data from FlightAware and MarineTraffic to track aircraft and vessels approaching airports or ports near the launch site. The components may perform data cleansing operations to correct formatting inconsistencies, use LXMs and tailored prompts to compare projected paths against historical trajectories, determine timeframes in which aircraft or vessels may enter hazard areas, and apply real-time adjustments for launch delays. If a scrub or delay occurs, the components may apply time deltas to update constraints and adjust scheduling.

In some embodiments, the components may be configured to identify weather constraints, including conditions affecting hazard areas and launch trajectories. The components may use a blend of LXM prompts and specialized algorithms to analyze weather data from multiple sources, including Weather.gov, NOAA, LightningMaps.org, Vaisala, Open Weather, Earth Networks, SmartLaunch Edge, and other platforms. The components may identify weather patterns that align with predefined thresholds established by the space launch vehicle operator. The components may continuously analyze current and forecasted weather conditions to predict launch conditions based on temperature, wind direction, wind speed, precipitation levels, and related parameters for up to 48 hours in advance. The components may use AI/ML models to identify historical weather patterns and precursor events. When scrubs or delays occur, the components may use precursor weather events to recommend launch windows in the next x-to-y (e.g., 48 to 96, etc.) hours. The components may use AI/ML algorithms to refine launch opportunity recommendations in response to detected postponements.

In some embodiments, the components may be configured to use LXMs to conduct searches to identify specific lightning patterns that could affect NASA Launch Lightning Commit Criteria 1 and 2, as defined in the NASA 4010 Standard. These operations may include searching and analyzing historical lightning-inducing conditions and related atmospheric data, including upper air observations, wind direction and temperature at various altitudes, atmospheric pressure, precipitation levels, cloud types, time of day, field mill readings, and data analyzed using GR2.3 Analyst software. The components may map potential lightning events within predetermined radii and altitudes relative to launch trajectories.

In some embodiments, the components may be configured to compute estimated casualty (EC) data and overlay this information on digital maps of launch sites. The components may use forecasted and real-time cellular-based data (e.g., from nContext, etc.) to plot human traffic patterns, estimate casualties along launch trajectories, compare estimates against EC thresholds in real time, and generate notifications and alerts to communicate risk levels. The components may be configured to determine EC thresholds and generate notifications to enhance safety near launch operations.

In some embodiments, the components may be configured to assess and manage reentry risks. The components may determine and use data pertaining to space launch vehicles or payloads (e.g., launch azimuth, geospatial orbital data, local north vector angle, latitude coordinates, etc.) to determine potential reentry locations on Earth's surface. The components may use LXMs to search for intersecting hazards associated with reentry events. The components may analyze precursor weather events, potential hazard area intersections, and real-time population movements to refine risk assessments.

The components may integrate data from received data feeds (e.g., positional information about orbital objects, aircraft, maritime vessels, etc.) to generate a combined launch dataset suitable for generating a comprehensive operational picture and resolving constraints. The components may generate the combined dataset to include integrated data that is more complete and reliable for forecasting than individual feeds. The components may use integrated data to resolve constraints or generate a mission profile that forecasts launch opportunities for planning and decision-making. In some embodiments, the mission profile may be based on historical air, maritime, and orbital traffic data, predictive weather modeling, and frequency monitoring data.

The components may receive a specific launch goal date and time, determine an overall launch window based on the received launch goal, predict non-linear launch opportunity windows (e.g., discontinuous or non-periodic clear launch windows) within the overall launch window based on the mission profile, determine whether specific launch criteria (e.g., safety conditions, regulatory considerations, etc.) are met during one or more of the predicted non-linear launch opportunity windows, and determine whether a launch opportunity exists based on the results. The components may generate a series of “Go/No Go” recommendations to support launch decision-making.

In some embodiments, the components may be configured to streamline spacelift operations by analyzing and integrating data from multiple technological systems, sources, and sensors.

In some embodiments, the components may be configured to collect and analyze exclusive range weather data (e.g., cloud type, precipitation, etc.) and public weather analytics data (e.g., national lightning information, etc.) via an application programming interface (API) and secured virtual private network (VPN), generate comprehensive weather analytics information, determine or predict high probability launch opportunity windows and/or constraints, and display real-time weather conditions, launch opportunities, and/or launch constraints.

In some embodiments, the components may be integrated within SmartLaunch Edge, which may be an edge device configured to extend and enhance launch site capabilities by collecting and analyzing exclusive weather data (e.g., cloud type, precipitation, etc.) and public weather analytics (e.g., national lightning information, etc.). The device may use application programming interfaces (APIs) and secured virtual private networks (VPNs) to aggregate comprehensive weather analytics. The components may use cloud technologies and existing launch facility infrastructure to predict high-probability launch opportunity windows and potential constraints based on real-time and forecasted weather conditions. The components may display real-time weather conditions, identify launch opportunities, and notify operational teams of potential launch constraints.

In some embodiments, the components may be configured to support continuous monitoring by meteorologists and authorized weather officers and dynamically update the weather conditions, launch opportunities, and/or launch constraints based on inputs or changing conditions. In some embodiments, the components/processors may be configured to collect and use user feedback, intervention history, and/or historical data to refine and improve forecasting accuracy over time.

In some embodiments, the components may be configured to implement dynamic launch scheduling. That is, conventional spacelift solutions are often constrained by predetermined schedules and limited airspace access. The embodiments overcome these and other limitations of conventional solutions by generating and using real-time data analytics to dynamically identify or create more flexible and efficient launch opportunity windows. The components may be configured to allow for the alignment of various factors critical to launch success, such as vehicle readiness, orbital mechanics, and optimal weather conditions.

In some embodiments, the components may include advanced collision avoidance components that are configured to use integrated data from diverse sources and domains (e.g., satellite tracking systems, orbital object catalogs, etc.) to construct a comprehensive operational picture that allows for the precise prediction and avoidance of potential collisions with space debris, satellites, and other orbital objects.

In some embodiments, the components may be configured to implement a condition-based launch criteria approach that analyzes multiple factors, including weather conditions, vehicle status, and regulatory compliance, to determine the feasibility of each launch opportunity. The components may evaluate whether a launch opportunity meets operational requirements and generate a series of “Go/No-Go” recommendations.

In some embodiments, the components may be configured to provide a modular cloud-based infrastructure for spacelift operations. The modular cloud-based infrastructure may provide enhanced flexibility and safety in launch operations and/or may significantly reduce the costs associated with spacelift operations. The modular cloud-based infrastructure may be configured to support a scalable and adaptable platform for spaceport users and/or otherwise accommodate a range of operational needs and requirements of modern users.

In some embodiments, the components may be configured to implement or provide a user-friendly interface and robust communication system, such as a graphical user interface (GUI) for displaying integrated launch data and a voice communication system that allows for efficient coordination and decision-making. The components may generate and render detailed analyses (e.g., debris analysis, weather plots, maritime surveillance data, etc.) to allow users to make informed decisions based on real-time data and insights.

In some embodiments, the components may be configured to continuously monitor and update launch conditions, dynamically adjust to changing conditions, and provide alerts and updates to relevant monitors and stakeholders.

In some embodiments, the components may be configured to monitor and analyze exclusive range weather data and public weather analytics to generate comprehensive weather analytics that may be used to predict launch opportunities and constraints.

In some embodiments, the components may be configured to perform predictive analytics for launch and recovery operations. The components may use historical and/or real-time data to predict potential launch windows and constraints, and/or otherwise generate predictive data that reduces or minimizes delays and cancellations. In some embodiments, the components may be configured to collect and use optic and/or imaging (e.g., electro-optical, infrared, radar, etc.) information for improved launch window predictions.

In some embodiments, the components may be configured to perform advanced vehicle tracking and monitoring operations. The components may collect and process performance information from the launch vehicle in real time, continuously monitor the vehicle's status throughout the launch process, and allow for timely interventions and adjustments based on the vehicle's performance data.

In some embodiments, the components may be configured to provide on-orbit collision avoidance, which may include continuously processing and updating orbital data for improved collision predictions and avoidance.

In some embodiments, the components may be configured to implement robust security measures that protect data integrity, regulate user access, and ensure that sensitive information related to spacelift operations is securely managed and protected against unauthorized access or breaches.

In some embodiments, the components may be configured to establish secure API connections (e.g., using security protocols such as, One Time Password (OTP), data encryption, VPN, OAuth2.0, etc.) to various weather data sources, such as Weather Research and Forecasting Model (WRF), National Oceanic and Atmospheric Administration (NOAA), National Centers for Environmental Prediction (NCEP), and national Lightning Feeds. In some embodiments, the components may be configured to set up data collection routines and/or use a scheduler to regularly receive structured data (e.g., JSON, XML, etc.) from these APIs.

In some embodiments, the components may be configured to perform data cleansing and standardization operations. In some embodiments, the components may be configured to use AI/ML techniques (e.g., tokens, transformers, generative AI models, etc.) to process and organize diverse data into a uniform format. In some embodiments, the components may be configured to use techniques such as K-nearest neighbors and the Z-Score method for data imputation and anomaly management. In some embodiments, the components may be configured to standardize the data (e.g., convert timestamps to UTC, normalize measurements, etc.).

In some embodiments, the components may be configured to use AI/ML models, techniques, and/or technologies for regression and classification. For example, the components may be configured to use the AI/ML models to analyze cleansed data to identify high-probability constraints (launch and lightning condition constraints, significant weather patterns, etc.). In some embodiments, the components may be configured to implement, use, and/or enforce constraint rules, such as avoiding launches near thunderstorm clouds or based on certain instrument readings.

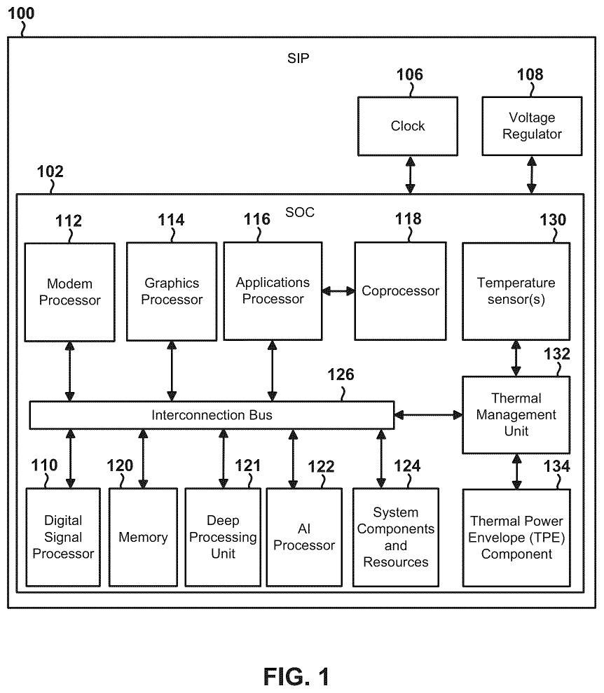

Various embodiments may be implemented on single-processor or multiprocessor computing systems, including a system-on-chip (SoC) or a system-in-package (SiP). FIG. 1 illustrates an example SiP 100 architecture that may be used in computing devices implementing the various embodiments.

With reference to FIG. 1, the SiP 100 includes at least one SoC 102, a clock 106, and a voltage regulator 108. The SoC 102 may include a digital signal processor (DSP) 110, a modem processor 112, a graphics processor 114, an application processor 116, one or more coprocessors 118 (e.g., vector coprocessor, etc.), memory 120, a deep learning processing unit (DPU) 121, an artificial intelligence processor 122, system components and resources 124, an interconnection bus 126, one or more temperature sensors 130, a thermal management unit 132, and a thermal power envelope (TPE) component 134. These components may be interconnected via the bus 126, which may utilize a high-performance network-on-chip (NoC).

In various embodiments, the SoC 102 and/or any of the processors 110, 112, 114, 116, 118, 121, 122 may operate as a central processing unit (CPU), microprocessor unit (MPU), arithmetic logic unit (ALU), or other processing units. For example, in some embodiments, the SoC 102 may function as the CPU of a computing device, executing software instructions by performing arithmetic, logical, control, and input/output (I/O) operations.

Any of the processors 110, 112, 114, 116, 118, 121, 122 may be included as one or more nodes in a CPU cluster. A CPU cluster may be a group of interconnected processing nodes (e.g., processor cores, processors, SoCs, SiPs, computing devices, etc.) configured to operate in coordination to execute computational tasks. Each node may run an independent operating system and include its own CPU, memory, and storage. A computational task assigned to the CPU cluster may be divided into smaller tasks that are distributed among the nodes. Each node may execute a portion of the task, and the results may be combined to generate the final computation output. CPU clusters may improve processing efficiency for parallelizable tasks. Additionally, because CPU clusters consist of multiple nodes, they may offer increased reliability compared to a single high-performance processor.

Each processor 110, 112, 114, 116, 118, 121, 122 may include one or more cores, and each processor or core may operate independently. For example, the SoC 102 may include a processor executing a first type of operating system (e.g., FreeBSD, Linux, macOS, etc.) and a processor executing a second type of operating system (e.g., Microsoft Windows 11). In addition, any of the processors 110, 112, 114, 116, 118, 121, 122 may be integrated into a processor cluster architecture, which may be synchronous, asynchronous, or heterogeneous.

The SoC 102 may include system components, resources, and custom circuitry for managing sensor data, analog-to-digital conversions, wireless data transmissions, and other specialized operations, such as decoding data packets and processing encoded audio and video signals for rendering in a web browser. For example, the system components and resources 124 of the SoC 102 may include power amplifiers, voltage regulators, oscillators, phase-locked loops, peripheral bridges, data controllers, memory controllers, system controllers, access ports, timers, and other components supporting processor operation and software execution. The system components and resources 124 may also include circuitry for interfacing with peripheral devices such as cameras, electronic displays, wireless communication devices, and external memory chips.

The SoC 102 may further include an input/output module (not illustrated) for communicating with external resources, such as the clock 106, voltage regulator 108, and a wireless transceiver (e.g., cellular transceiver, Bluetooth transceiver, etc.). External resources (e.g., clock 106, voltage regulator 108, etc.) may be shared among multiple processors or cores within the SoC 102.

In addition to the example SiP 100 discussed above, various embodiments may be implemented in computing systems that include a single processor, multiple processors, multicore processors, or combinations thereof.

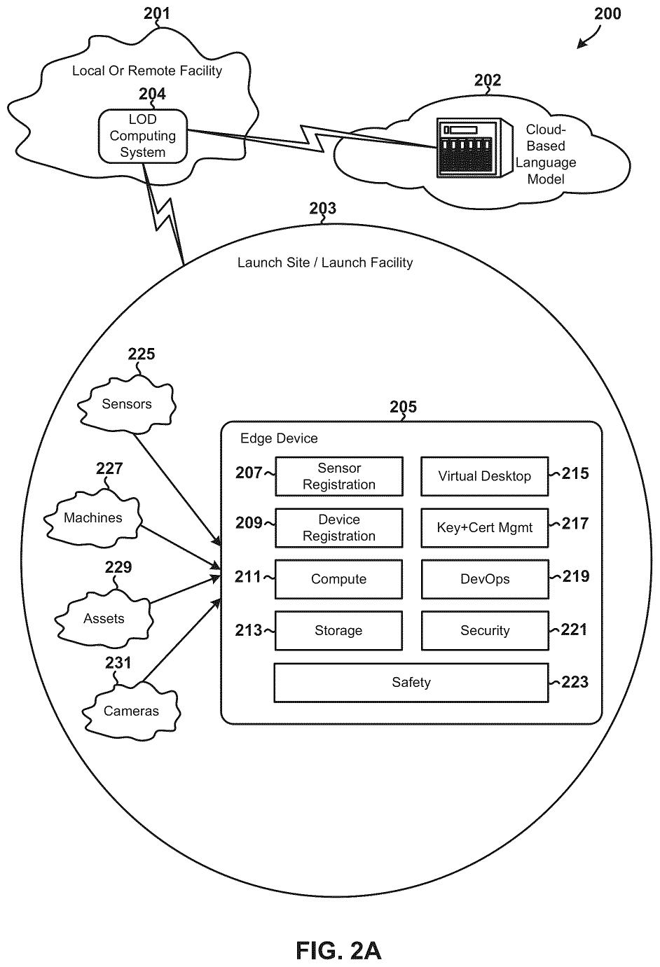

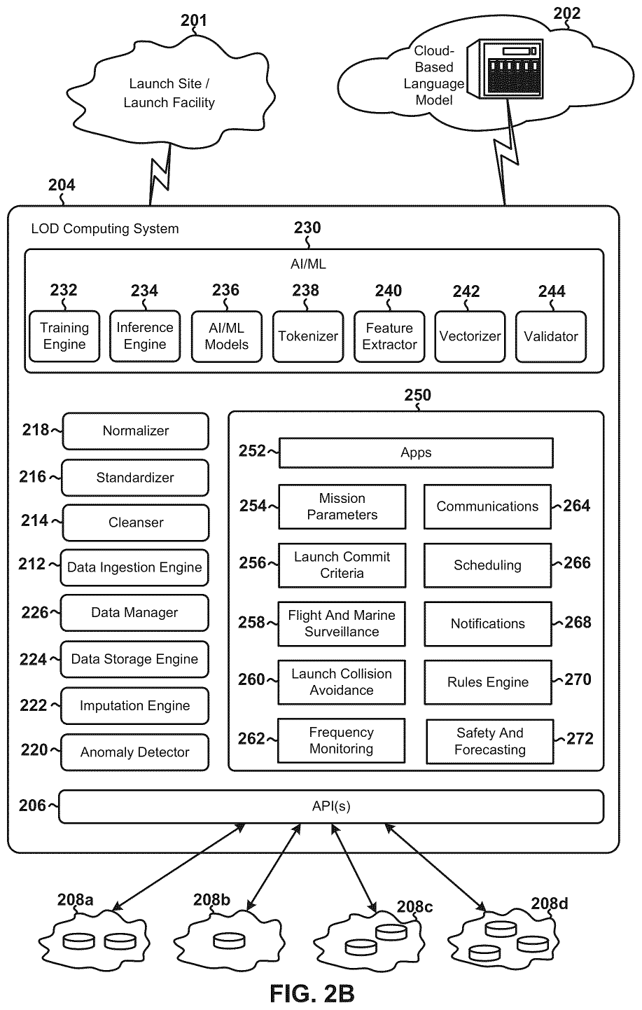

FIGS. 2A and 2B illustrate components of a system 200 configured to determine launch windows for advanced collision avoidance in accordance with the various embodiments. In the example illustrated in FIGS. 2A and 2B, the system 200 includes a local or remote facility 201, a cloud-based language model system 202, and a launch site 203. The local or remote facility 201 includes a launch-on-demand (LOD) computing system 204. The launch site 203 includes an edge device 205 (e.g., SmartLaunch Edge) configured to receive data from sensors 225, machines 227, assets 229, and cameras 231. The edge device 205 may include a sensor registration component 207, a device registration component 209, a compute component 211, a storage component 213, a virtual desktop component 215, a key and certificate management component 217, a DevOps component 219, a security component 221, and a safety component 223. Any or all of these components may be implemented using any of the components (e.g., SOC 102, AI processor, 122, etc.), described with reference to FIG. 1.

The cloud-based language model system 202, the LOD computing system 204, and the edge device 205 may collaborate to implement a space launch service platform (SLSP) computing architecture that integrates artificial intelligence (AI) to analyze and interpret historical and real-time data. The SLSP may collect, aggregate, and analyze data from diverse sources, including public and private sources, clients, third parties, and sensors embedded in machinery. The SLSP may use this data for specialized applications, including weather monitoring, radio frequency (RF) tracking, and visual analysis. The SLSP may collect and use data from any or all of the sensors 225, machines 227, assets 229, and cameras 231. The SLSP may use this data to train AI models capable of analyzing complex datasets and generating insights. In some embodiments, the SLSP may develop and refine AI models in a cloud environment, securely transfer the trained models to client systems or edge devices, analyze real-time data inputs at the client site or launch site, and provide actionable insights to support decision-making.

With reference to FIG. 2A, the sensor registration component 207 of the edge device 205 may be configured to recognize and integrate various sensors (e.g., oxygen sensors, barometers, or any of the sensors 225) and sensor data into the launch operations system or SLSP. In some embodiments, the sensor registration component 207 may assign unique identifiers to each sensor for tracking and management, generate a registry of active sensors, implement authentication measures to secure communications, and perform operations to enhance sensor data accuracy and reliability.

The registered sensors may transmit data to components of the SLSP, which may use the data to train AI models or apply the data to trained AI models during inference. Registering sensors may enable real-time data acquisition from otherwise unavailable sources, improving forecasting and scheduling. In some embodiments, the sensors 225 may be part of an Internet of Things (IoT) network, monitoring conditions such as gas levels in storage tanks or traffic flow in designated lanes. The sensor data may serve as input to AI models that analyze constraints, improve real-time predictions, and facilitate timely go/no-go decisions.

The device registration component 209 may be configured to register and manage devices other than sensors, such as actuators, controllers, and monitoring equipment. This component may authenticate devices, assign unique identifiers, integrate devices into the launch operations system or SLSP, and enable monitoring and data collection. Data from these devices may be used to train AI models or apply to trained AI models for constraint analysis, predictive modeling, and real-time decision support.

In some embodiments, the edge device 205 may include additional registration components, such as a machine registration component, an asset registration component, and a camera registration component, which may perform operations similar to those of the sensor registration component 207 and device registration component 209.

The compute component 211 may provide computational resources for data processing, analytics, and AI/ML model execution. This may include real-time data analysis, simulations, and predictive modeling to support launch operations. In some embodiments, the compute component 211 may include any of the components described with reference to FIG. 1.

The storage component 213 may store real-time and historical data, including sensor readings, system logs, video feeds, and analytical results. In some embodiments, the storage component 213 may include the memory 120 or other components described with reference to FIG. 1.

The virtual desktop component 215 may enable remote access to computing resources and operational data, allowing users to securely interact with the launch operations system.

The key and certificate management component 217 may manage encryption keys and digital certificates to secure communications and data within the launch operations network. This component may issue, renew, or revoke certificates and encryption keys.

The DevOps component 219 may enhance software development, deployment, and infrastructure management. This component may automate software delivery, improve system reliability and scalability, and ensure that software updates and configurations are deployed with minimal operational disruption.

The security component 221 may protect the launch operations system from cyber threats and unauthorized access.

The safety component 223 may monitor, analyze, and manage risks associated with launch operations. This component may implement safety protocols, conduct risk assessments, and enforce compliance with safety standards. In some embodiments, the safety component 223 may use data from sensors, devices, and other sources to proactively identify and mitigate safety concerns.

The sensors 225 may capture environmental data, system statuses, and physical parameters relevant to launch operations. These may include accelerometers, atmospheric gas sensors (e.g., oxygen, carbon dioxide, methane sensors, etc.), barometers, gyroscopes, humidity sensors, infrared sensors, lightning detection sensors, magnetometers, microphones, particulate matter detectors, precipitation sensors, pressure sensors, radiation detectors, sound level meters, spectrometers, temperature sensors, visibility sensors, and wind speed sensors.

The machines 227 may include mechanical and electronic systems for launch preparation, execution, and monitoring. These may include operational systems including computer systems and servers for data processing, analysis, and monitoring, programmable logic controllers (PLCs) that monitor fuel and oxygen levels, computing resources for weather pattern analysis and local data processing, ground support equipment (e.g., fueling systems, hydraulic lifts, payload processing facilities), and launch vehicle subsystems (e.g., propulsion systems, guidance and navigation systems, onboard computers). The edge device 205 may receive telemetry from ground support equipment to determine operational status during countdown and fueling.

The assets 229 may include physical and digital resources supporting launch operations. Physical assets may include PLCs monitoring machinery, cameras and surveillance equipment, launch vehicles, ground-based infrastructure (e.g., launch pads, control centers), and support vehicles. Digital assets may include mission planning software, telemetry data, weather analysis tools, and real-time decision-making systems.

The cameras 231 may include optical devices deployed for surveillance, monitoring, and data collection. These may include high-definition cameras for real-time monitoring, infrared cameras for thermal analysis, high-speed cameras for capturing launch sequences, and long-range cameras for tracking the launch vehicle's ascent.

The SLSP may use visual data from the cameras 231 for image recognition to identify objects and detect environmental changes. The SLSP may detect positional shifts in the launch vehicle, identify unauthorized access to restricted areas, and generate security alerts.

In some embodiments, the edge device 205 may collect and process data from any or all of the sensors 225, machines 227, assets 229, and cameras 231 to perform AI/ML operations, identify patterns, and generate insights. The proximity of computational resources to data sources may reduce latency, improve coordination, and enable real-time updates. Additionally, the edge device 205 may operate within a localized environment, using data to generate recommendations tailored to the operational needs of each client.

With reference to FIG. 2B, the LOD computing system 204 may include an API component 206 configured to receive data feeds from external systems 208a-208d. The LOD computing system 204 may also include a data ingestion component 212, a data cleansing component 214, a data standardization component 216, a data normalization component 218, an anomaly detection component 220, an imputation component 222, a data storage component 224, a data management component 226, and an AI/ML component 230. The AI/ML component 230 may include a training engine 232, an inference engine 234, AI/ML models 236, a tokenizer 238, a feature processing component 240, a vectorization component 242, and a validation component 244. The LOD computing system 204 may also include a launch operations decision support component (LODSS) 250 that includes an applications component 252, a mission parameters component 254, a launch commit criteria component 256, a flight and marine surveillance component 258, a launch collision avoidance component 260, a frequency monitoring component 262, a communications component 264, a scheduling component 266, a notifications component 268, a rules engine component 270, and a safety and forecasting component 272.

The LOD computing system 204 may be configured to receive data from external sources 208a-208d, process and format the data, evaluate it locally, generate an enhanced launch prompt based on the received or processed data, use the generated prompt to query the cloud-based language model system 202, and use the query results to integrate data, generate a comprehensive operational picture, determine a mission profile, predict non-linear opportunities, and indicate a launch opportunity.

The API component 206 may be configured to facilitate communication between the LOD computing system 204 and external systems 208a-208d, such as the national airspace system 208a, marine transportation system 208b, orbital object catalog and satellite tracking system 208c, weather monitoring system 208d, and other systems referenced in this application.

The data ingestion engine 212 may be configured to gather and integrate data from the edge device 205 and external sources 208a-208d, including sensors, databases, and external APIs. The data ingestion engine 212 may continuously receive streaming data in real time and may operate autonomously or semi-autonomously.

The data cleansing component 214 may be configured to identify and correct errors or inconsistencies in the ingested data. For example, it may use AI/ML models to detect anomalies (e.g., out-of-order values, out-of-range values, contradictory information) and verify data integrity for launch window determinations or collision avoidance calculations.

The data cleansing component 214 may be configured to use AI/ML techniques for pattern recognition, contextual validation, predictive cleansing, automated error correction, and data quality scoring. It may use unsupervised learning techniques (e.g., clustering, neural networks) to detect anomalies or apply natural language processing (NLP), LXMs, and semantic analysis to evaluate data context and structural correctness.

The data cleansing component 214 may also be configured to use regression analysis, time-series forecasting, and historical data modeling to predict and preemptively correct data errors. It may generate quality scores or other quantifiable measures that guide decision-making based on data reliability.

The data standardization component 216 may be configured to convert diverse data formats and units into a uniform structure. For example, it may convert time zone data to Coordinated Universal Time (UTC) and standardize measurement units for consistency.

The data normalization component 218 may be configured to scale data to a standard range. For example, it may apply min-max scaling to normalize values between 0 and 1, enhancing comparability across datasets.

The anomaly detection component 220 may be configured to identify irregular patterns or outliers that indicate unexpected conditions. For example, it may flag unusual satellite behavior or environmental conditions that could impact launch operations.

The imputation engine 222 may be configured to fill in missing or incomplete data points. For example, it may use predictive modeling to estimate missing environmental values, allowing for more complete analysis. It may also apply AI/ML models to infer missing values such as atmospheric pressure or temperature.

The data storage engine 224 may be configured to securely store processed and raw data. It may use distributed cloud storage solutions to manage large datasets and provide scalability.

The data management component 226 may be configured to coordinate access, retrieval, and utilization of stored data. It may include database management systems for efficient querying and real-time decision-making.

The AI/ML component 230 may use be configured to machine learning techniques to model, predict, and analyze orbital trajectories, optimal launch windows, and collision probabilities.

The AI/ML component 230 may be configured to analyze standardized data to generate predictive insights. For example, it may use regression models or decision trees to evaluate factors such as weather conditions, orbital traffic, and terrestrial activity to determine optimal launch windows.

The AI/ML component 230 may also be configured to use time-series forecasting models (e.g., LSTM networks) to predict satellite trajectories, detect potential collision risks, and adjust launch schedules or flight paths accordingly.

The AI/ML component 230 may be configured to employ probabilistic models (e.g., Bayesian networks) to determine collision likelihoods based on real-time trajectories and historical incident data. It may calculate probabilities of orbital collisions and recommend preemptive actions such as launch schedule adjustments or avoidance maneuvers.

The launch operations decision support system (LODSS) component 250 may be configured to define mission parameters, evaluate launch commit criteria, monitor flight and maritime traffic, perform collision avoidance analysis, manage frequency monitoring, coordinate communications, schedule launch operations, issue notifications, and generate real-time “Go/No-Go” decisions.

The applications component 252 may be configured to provide access to software tools that enhance launch operations. It may include day-of-launch (DOL) applications for analyzing launch conditions and determining launch window opportunities. It may also integrate functionalities such as mission planning, analytics, and real-time monitoring.

The mission parameters component 254 may be configured to manage mission-specific data, including objectives, trajectories, Notices to Airmen and Mariners, payload details, target orbits, and launch vehicle configurations.

The launch commit criteria component 256 may be configured to automate go/no-go decisions by evaluating weather conditions, system health, regulatory compliance, and trajectory safety. It may coordinate with key personnel, such as the launch director and regulatory authorities.

The flight and marine surveillance component 258 may be configured to continuously monitor airspace and maritime activity near the launch site. It may use AI/ML technologies, radar, and aeronautical surveillance systems to detect and classify objects (e.g., aircraft, ships) that could pose risks to launch operations.

The launch collision avoidance component 260 may be configured to analyze orbital object trajectories and space debris movement to mitigate potential collision risks. The launch collision avoidance component 260 may integrate data from ground-based radar, satellite tracking systems, and predictive AI models to identify safe launch windows.

The frequency monitoring component 262 may be configured to continuously scan the electromagnetic spectrum to detect and mitigate interference risks affecting launch vehicle communications, navigation, and telemetry.

The communications component 264 may be configured to provide a secure communication network for launch stakeholders. It may support encrypted transmissions, voice-over-internet-protocol (VOIP), and text-based communication systems.

The scheduling component 266 may be configured to optimize or enhance launch timing by analyzing weather forecasts, orbital mechanics, and ground operations schedules. It may use AI/ML algorithms to dynamically adjust schedules based on changing conditions.

The notifications component 268 may be configured to automatically generate and distribute alerts regarding launch conditions. The component may notify users of factors affecting launch opportunities, such as weather shifts, hazard area incursions, or changes in airspace regulations.

The rules engine 270 may be configured to apply predefined logic to automate aspects of launch operations, such as evaluating launch commit criteria, activating surveillance protocols, and issuing notifications.

The safety and forecasting component 272 may be configured to use predictive analytics to assess operational risks and forecast safety hazards. It may analyze weather conditions, airspace and maritime traffic, and other factors affecting launch schedules. It may generate safety briefings and risk assessments tailored to each mission.

FIG. 3 is a process flow diagram illustrating a method 300 of determining launch windows for advanced collision avoidance in accordance with some embodiments. Method 300 may be performed in a computing device (e.g., LOD computing system 204) by a processing system that includes one or more processors (e.g., 110, 112, 114, 116, 118, 121, 122, etc.), components (e.g., 207-272, 402-420, etc.) or subsystems discussed in this application. Means for performing the functions of the operations in method 300 may include these processors, components, and subsystems. One or more processors within the processing system may be configured with software or firmware to perform some or all of the operations of Method 300. In some embodiments, the processing system may operate within the LOD computing system 204.

In block 302, the processing system may receive raw data from diverse external sources. For example, the processing system may receive orbital data from satellite tracking networks, airspace availability information from air traffic control authorities, estimated future ship position information from a maritime tracking system, meteorological data from weather forecasting systems, and other information that may be used for a comprehensive evaluation of the factors that influence launch windows.

In block 304, the processing system may perform normalization operations to scale the data to a standard range (or standardize data values). For example, the processing system may normalize satellite altitude data from various sources to a uniform scale, convert different time zone data to UTC, and perform other similar standardization operations to ensure consistency across data sets and/or for accurate comparisons and analyses.

In block 306, the processing system may perform tokenization operations to break the data down into smaller uniform units that are suitable for combination and use with AI/ML models and/or LXMs. For example, the processing system may tokenize complex airman instructions or weather forecast reports into discrete data points such as temperature, wind speed, and humidity.

In block 308, the processing system may generate an enhanced launch prompt and query an L×M system. For example, the processing system may formulate a query regarding optimal launch conditions based on current orbital and weather data. The query may ask the LXM to identify potential launch windows within a specified timeframe. The query may ask the LXM to evaluate the received or tokenized data to extract the features most relevant to launch window determination.

In block 310, the processing system may perform feature extraction operations to identify and extract relevant features from the received data, the tokenized data and/or the query results. For example, the processing system may extract features such as peak wind speeds, historical satellite trajectory patterns, and forecasted solar activity levels, all of which are important factors that impact the launch windows.

In block 312, the processing system may generate vector representations (vector information structures) that characterize the tokenized data and/or query results. For example, the processing system may convert the extracted features into numerical vectors to create a structured representation of the data that may be processed by AI/ML models (LXM, etc.).

In block 314, the processing system may determine a suitable AI/ML analysis type (e.g., classification, regression, clustering, etc.). For example, the processing system may select regression analysis to predict the probability of favorable launch conditions or clustering to group or cluster potential launch windows based on similarities in atmospheric and orbital parameters.

In block 316, the processing system may select AI/ML models based on data characteristics, analysis results, and the determined AI/ML analysis type. For example, the processing system may select a neural network trained on space-based datasets to recognize complex patterns in orbital data.

In block 318, the processing system may train and/or validate the selected AI/ML models. For example, the processing system may use historical launch data to train a model for predicting successful launch windows and validate the trained model against recent launch outcomes to assess its accuracy.

In block 320, the processing system may apply the collected, generated, or received data to trained AI/ML models to generate inference results. For example, the processing system may use the trained models to analyze current data, generate real-time predictions on the viability of upcoming launch windows, and determine potential launch opportunity windows for an upcoming space mission.

In block 322, the processing system may use the generated inference results to construct a comprehensive operational picture, determine a mission profile, predict non-linear launch opportunities, indicate a launch opportunity, update collision avoidance calculations, etc.

FIG. 4 illustrates example components in an updated space launch service platform (SLSP) 400 that may be configured to use artificial intelligence to improve launch operations in accordance with some embodiments. In the example illustrated in FIG. 4, the SLSP 400 includes a launch commit criteria 402 component, a flight and marine surveillance 404 component, a safety 406 component, a launch weather analysis 408 component, a launch collision avoidance 410 component, a frequency monitoring 412 component, a communications 414 component, a mission parameters 416 component, an AI integration platform 418 component, and an advanced scheduling and predictive analysis 420 component, any or all of which may be designed to enhance the accuracy, safety, and efficiency of launch operations.

The SLSP 400 may be configured to incorporate a safety perspective into launch operations and reduce or eliminate bottlenecks caused by adverse weather conditions, problematic air or marine traffic, unclear orbital collision risks, or insufficient flight safety analysis.

In some embodiments, the SLSP 400 may be configured to establish connections to and collect data from any of a wide variety of diverse sources, including but not limited to: national airspace system data (detailing airspace availability, flight paths, and traffic), marine transportation system data (providing information on maritime traffic and vessel positions), orbital object catalog data (covering satellites, space debris, and other orbital objects), weather monitoring system data (including real-time and forecasted meteorological conditions), telemetry data from launch vehicles (capturing real-time performance and positional data), trajectory data (including standard deviations of nominal trajectories and simulated stages), satellite tracking system data (for collision avoidance), flight tracking system data, spectrum monitoring data (related to the radio frequency spectrum for communication and navigation), geospatial information system (GIS) data (mapping and spatial data pertinent to launch areas), global positioning system (GPS) data (providing precise tracking and navigation information), launch vehicle performance data, and environmental monitoring data (including local conditions at the launch site and relevant maritime and aviation notices).

The AI platform integration 418 component may be configured to use artificial intelligence and prompt engineering techniques to perform data standardization and validation (e.g., flight and marine surveillance data) according to regulatory standards (e.g., FAA). The advanced scheduling and predictive analysis 420 component may use AI-driven algorithms to analyze large datasets related to flight schedules, marine traffic, and potential orbital collisions. The SLSP 400 may use these analysis results to identify optimal launch opportunities that align with safety, regulatory, and operational requirements.

The launch commit criteria 402 component may be configured to assess and validate the readiness of all systems and environmental conditions prior to launch. This may include integrating launch vehicle status data, range safety analysis, and weather conditions into pre-launch protocols. For example, the launch commit criteria 402 component may automatically verify that all systems are “go” for launch by cross-referencing vehicle safety data against pre-launch checklists and confirming that weather conditions meet required safety thresholds.

The flight and marine surveillance 404 component may be configured to monitor and manage Notices to Airmen (NOTAMs) and Notices to Mariners (NOTMARs) while tracking airspace and maritime activity. The flight and marine surveillance 404 component may use real-time monitoring technologies to detect geographical constraints and track vessel and aircraft movements. The collected information may be used to prevent unauthorized entries, mitigate launch delays, and enhance safety coordination.

In some embodiments, the flight and marine surveillance 404 component may be configured to visually represent NOTAMs and NOTMARs on operational maps. For example, restricted airspace may be marked with red lines, the launch trajectory may be highlighted in yellow, and real-time aircraft and vessel positions may be displayed in distinct colors. The component may map geographical constraints ten days prior to launch to detect unauthorized entries. The component may also use AI-driven data standardization to align constraint data with FAA nomenclature.

The safety 406 component may be configured to oversee all launch safety aspects, from pre-launch checks and vehicle integrity assessments to the execution of emergency procedures. The component may integrate real-time data on vehicle status, environmental conditions, and personnel locations to support comprehensive safety monitoring. The safety 406 component may initiate an automatic countdown hold and alert mission control in response to detecting a fuel leak, pressure drop, or other safety risk.

The launch weather analysis 408 component may be configured to use meteorological data from weather services (e.g., National Weather Service) and satellite monitoring systems to provide predictive and real-time weather assessments. The component may evaluate whether environmental conditions meet predefined safety thresholds and adjust launch opportunity decisions accordingly.

The cola 410 component may be configured to simulate potential orbital collisions and predict safe launch opportunities. The component may analyze orbital object catalog data to identify and avoid conjunctions with space debris or active satellites.

The frequency monitoring 412 component may be configured to track and manage the use of communication frequencies during the launch sequence to prevent signal interference. This may include monitoring frequency use across various communication channels and ensuring that all communications are clear and without interference. For example, the frequency monitoring 412 component may automatically switch frequencies in response to detecting interference on a primary channel so as to maintain clear communication lines for mission control and launch vehicle coordination.

The communication tools 414 component may provide advanced communication capabilities that allow for or improve operational coordination among team members.

The mission parameters 416 component may be configured to ensure that all mission-specific requirements are met, including payload integration, orbital insertion parameters, and specific customer demands. The mission parameters 416 component may also aggregate and analyze data related to the mission's objectives, such as payload configuration, intended orbit, and secondary payload accommodations. In some embodiments, the mission parameters 416 component may be configured to adjust the launch trajectory in real-time (e.g., based on updated weather conditions, orbital traffic, etc.).

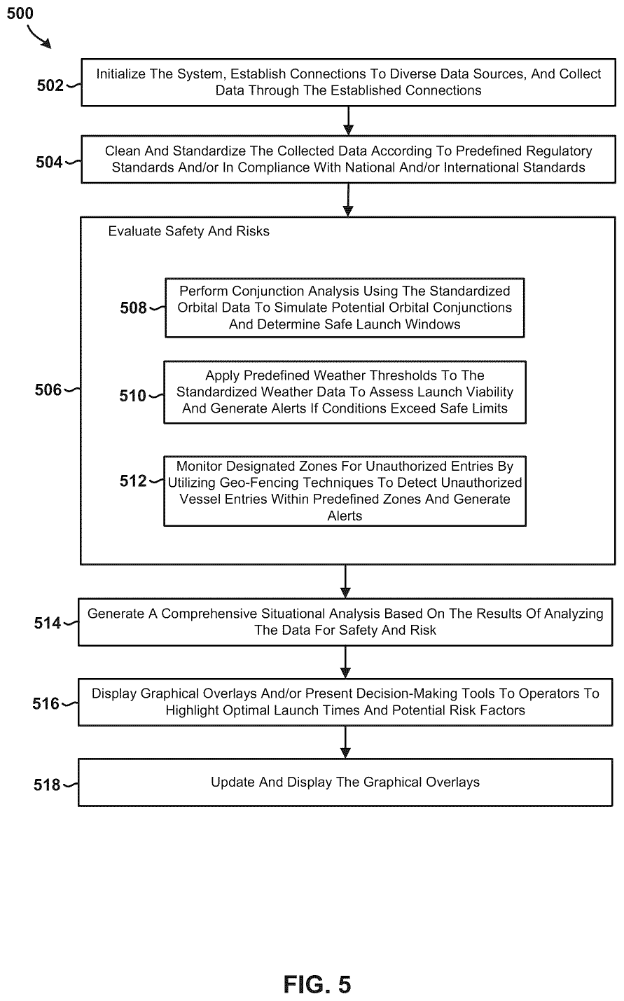

FIG. 5 is a process flow diagram illustrating a method 500 of using artificial intelligence to improve launch operations in accordance with some embodiments. Method 500 may be performed in a computing device (e.g., LOD computing system 204) by a processing system that includes one or more processors (e.g., 110, 112, 114, 116, 118, 121, 122, etc.), components (e.g., 207-272, 402-420, etc.) or subsystems discussed in this application. Means for performing the functions of the operations in method 500 may include these processors, components, and subsystems. One or more processors within the processing system may be configured with software or firmware to perform some or all of the operations of method 500.

In block 502, the processing system may initialize the system by loading system configurations (including access credentials and initial parameters for data sources and services), establish connections to diverse data sources (e.g., a flight and marine traffic data source, a weather data source, an orbital data source, etc.), and collect data through the established connections. The collected data may include, for example, real-time location data of marine and flight vessels, current and forecasted weather conditions from the weather data source, and orbital positions and predicted paths from the orbital data source.

In block 504, the processing system may standardize and normalize, the collected data according to predefined regulatory standards and/or in compliance with national and/or international standards. Standardization may include aligning data formats with predefined FAA regulations. Normalization may include transforming data values into consistent numerical ranges. The system may apply a pre-trained AI/ML model to cleanse the data, resolve inconsistencies, and predict missing values using embeddings from a vector database. For example, a convolutional neural network (CNN) trained on historical flight and maritime datasets may detect anomalies, while natural language processing (NLP) techniques may convert weather data into standardized formats. The AI/ML model may normalize numerical data, such as converting temperatures from Fahrenheit to Celsius and wind speeds from knots to meters per second. The final standardized dataset may be structured for integration into subsequent processing stages. For a non-limiting example, the AI model may be a LLAMA AI model with OpenAI embeddings and Pinecone vector database to assist with normalization based on correct data formats.

In block 504, the processing system may receive data related to the four phases of the flight segment: Launch Phase (liftoff to max Q), Ascent Phase (max Q to stage separation), Orbital Insertion Phase (stage separation to orbit), and On-Orbit Operations Phase (orbit to reentry or mission completion). Each phase may have its own trajectory and limits of useful mission. The processing system may segment the entire flight into these four distinct phases, applying individual trajectory models and mission constraints specific to each phase. The system may monitor and adjust each phase's trajectory in real time based on environmental and operational data, ensuring the mission remains within its predefined operational limits.

In block 506, the processing system may perform a comprehensive safety and risk evaluation. For example, in block 508, the processing system may conduct conjunction analysis using standardized orbital data to simulate potential orbital conjunctions and determine safe launch windows. The system may use predictive algorithms to calculate the future trajectories of known orbital objects and the planned launch vehicle. If a predicted conjunction falls within a predefined proximity threshold, such as one kilometer from the launch trajectory, the system may generate a collision risk alert. Safe launch windows may be identified by selecting time slots that minimize orbital congestion.

As another example, in block 510, the processing system may apply predefined weather thresholds to the standardized weather data to assess launch viability and generate alerts in response to determining that the conditions exceed safety thresholds. That is, the system may analyze standardized weather data against predefined launch criteria. If real-time or forecasted conditions exceed operational safety thresholds, such as wind speeds exceeding 20 meters per second or lightning activity detected within a 10-kilometer radius, the system may issue an alert and adjust launch timing accordingly.

As yet another example, in block 512, the processing system may monitor designated zones for unauthorized entries by utilizing geo-fencing techniques to detect unauthorized vessel entries within predefined zones. For example, the system may instantly detect a vessel or aircraft that enters a critical area (e.g., the launch pad and nearby airspace, etc.) by using GPS tracking and RFID technologies that establish virtual boundaries. In some embodiments, the processing system may generate alerts and initiate automatic responses in response to detecting unauthorized entries.

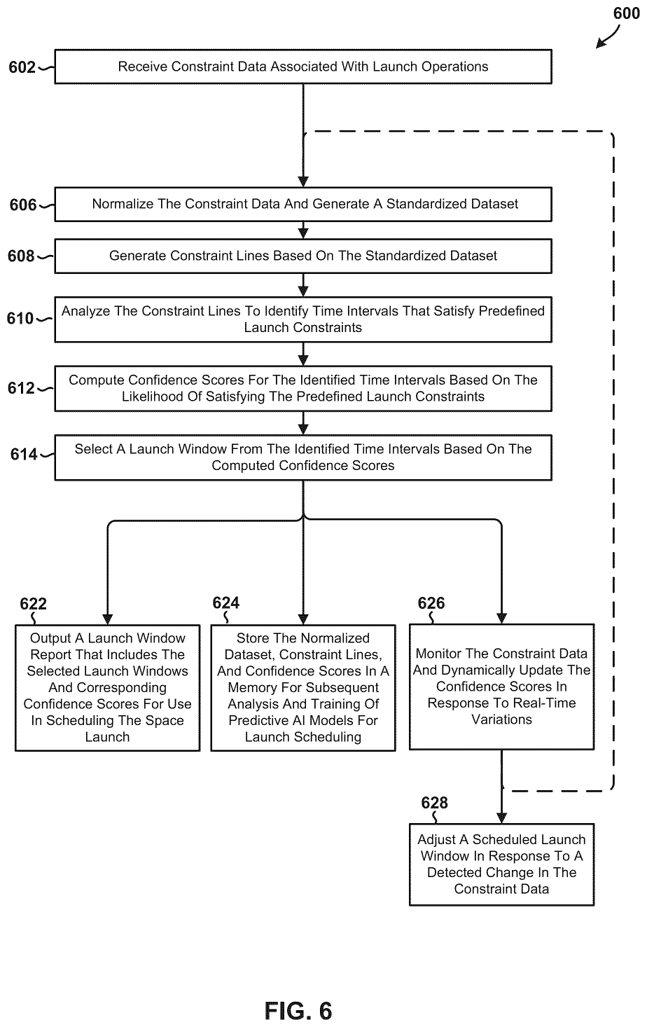

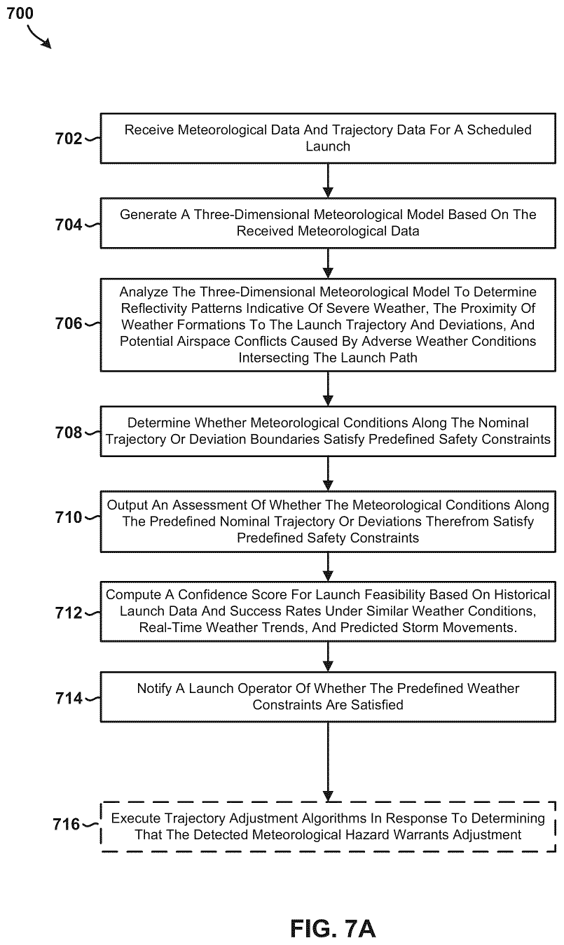

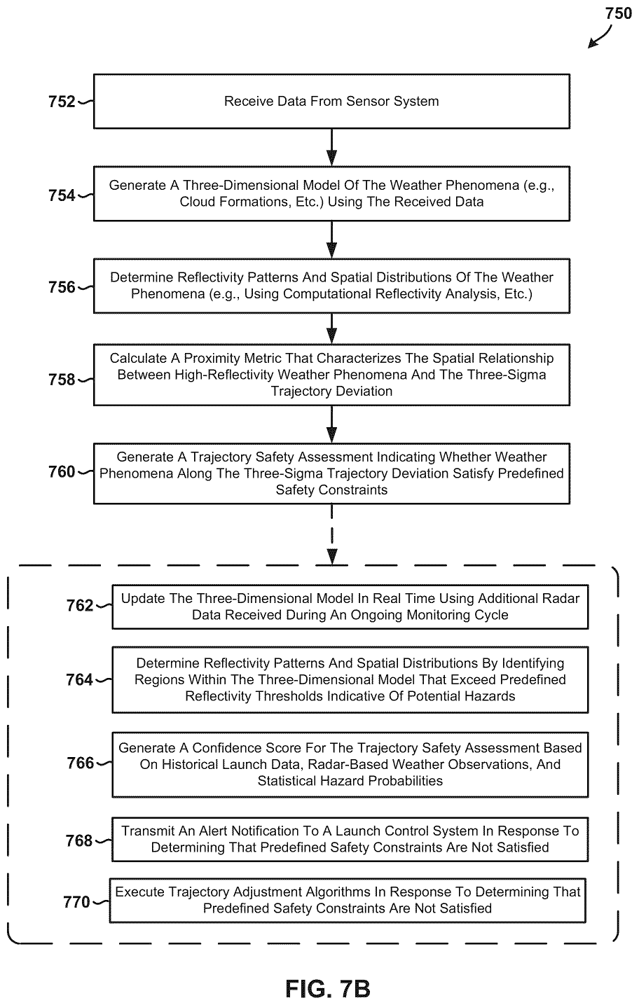

In some embodiments, the processing system may perform all or portions of method 600 (illustrated in FIG. 6) in block 506 to refine launch window selection as part of risk evaluation. For example, in some embodiments, the processing system may perform the operations of blocks 602-610 (illustrated in FIG. 6) in block 506. In some embodiments, the processing system may perform the operations of blocks 702-710 (illustrated in FIG. 7) in block 510 for weather hazard detection.

In block 514, the processing system may generate a comprehensive situational analysis based on the results of analyzing the data for safety and risk. The processing system may integrate the outputs of the data analysis to provide a comprehensive situational analysis and support decision-making. For example, the processing system may aggregate data from weather forecasts, orbital trajectories, air and marine traffic updates, and real-time telemetry from the launch vehicle. The integrated dataset may be displayed through a dynamic dashboard with real-time updates. The system may use AI-based risk analysis models to evaluate launch feasibility under varying conditions and estimate the optimal launch time with the lowest associated risks.

In block 516, the processing system may update graphical overlays on the user interface, displaying marine and airborne vessel positions, dynamic weather patterns, and updated orbital trajectories. The system may also generate structured reports that summarize launch conditions, influencing factors, and system status. These reports, along with logged system activities, may be archived for post-launch analysis and auditing.

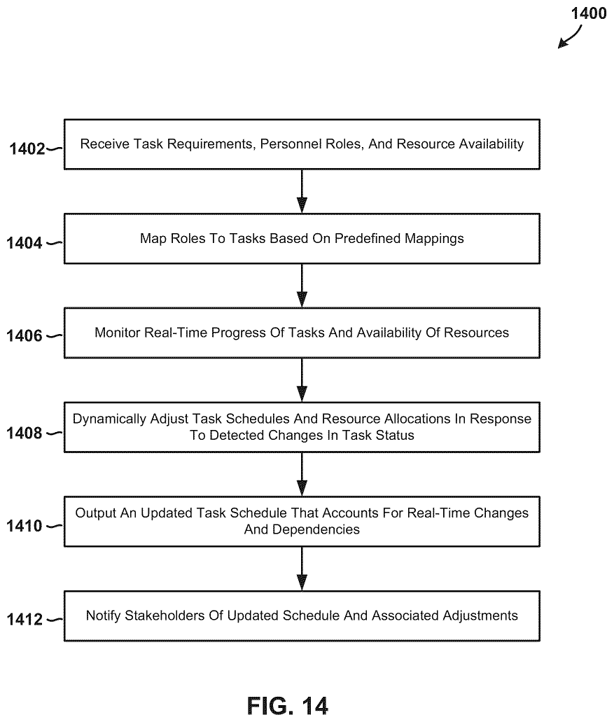

In some embodiments, the processing system may perform all or portions of method 1400 (illustrated in FIG. 14) in block 516 to resolve scheduling conflicts identified in the situational analysis stage before updating the graphical overlays.

FIG. 6 is a process flow diagram illustrating a method 600 of identifying launch windows to improve launch operations in accordance with some embodiments. Method 600 may be performed in a computing device (e.g., LOD computing system 204) by a processing system that includes one or more processors (e.g., 110, 112, 114, 116, 118, 121, 122, etc.), components (e.g., 207-272, 402-420, etc.) or subsystems discussed in this application. Means for performing the functions of the operations in method 600 may include these processors, components, and subsystems. One or more processors within the processing system may be configured with software or firmware to perform some or all of the operations of method 600.

It should be understood that method 600 (and all the other methods discussed herein) may incorporate elements of method 300 and/or 500, including receiving constraint data, performing data processing operations, and identifying launch windows based on historical and real-time information. Thus, it should be understood that method 600 may include all or portions of methods 300 and/or 500 discussed with reference to FIGS. 3 and 5, and vice versa.

With reference to FIG. 6, in block 602, the processing system may receive constraint data related to launch operations. The constraint data may include terrestrial object data, orbital object data, weather data, upper atmospheric data, and/or launch vehicle data. The constraint data may originate from real-time monitoring systems, historical records, aviation agencies, maritime agencies, and/or space agencies. In some embodiments, the processing system may retrieve constraint data from the LOD computing system 204 (e.g., the data ingestion component 212 and the AI integration platform 418) and may store the constraint data in the data storage component 224. In some embodiments, the real-time data may be collected using sensors 225, machines 227, assets 229, and cameras 231 connected through edge device 205 at launch site 203.

In some embodiments, the processing system may receive terrestrial object data related to airspace and maritime traffic, including historical, scheduled, and real-time travel paths, vessel positions, travel durations, and regulatory constraints. Sources for terrestrial object data may include the International Civil Aviation Organization (ICAO), FlightAware, MarineTraffic, and the Federal Aviation Administration (FAA). The processing system may receive orbital object data from the National Aeronautics and Space Administration (NASA), the European Space Agency (ESA), the United States Space Force, Space Exploration Technologies Corporation (SpaceX), Blue Origin, Rocket Lab, Airbus Defense and Space, and The Boeing Company. Weather and upper atmospheric data may be obtained from the National Oceanic and Atmospheric Administration (NOAA), the Next Generation Weather Radar (NEXRAD), the Global Hydrometeorology Resource Center (GHRC), the National Lightning Detection Network (NLDN), the Geostationary Lightning Mapper (GLM), and the International Center for Lightning Research and Testing (ICLRT). The processing system may obtain launch vehicle data from NASA, ESA, the United States Space Force, the FAA, SpaceX, Blue Origin, Rocket Lab, Airbus Defense and Space, and The Boeing Company.

Orbital object data may include historical, scheduled, and real-time trajectories, object characteristics, ephemerides, and covariance data. Weather data may include wind speeds, atmospheric pressure, cloud coverage, lightning activity, and humidity levels. Upper atmospheric data may include wind vectors, temperature, pressure gradients, and vapor content. Launch vehicle data may include historical, scheduled, and real-time trajectories, travel durations, deviations, scrubs, vehicle characteristics, payload characteristics, mission-specific constraints, and operational timelines.

As an example, in block 602, the processing system may receive airspace constraint data indicating restricted flight zones, scheduled air traffic, and clearance windows, maritime constraint data indicating restricted maritime zones, vessel positions, and scheduled departures, weather constraint data indicating wind thresholds, lightning activity, and cloud formations, and orbital constraint data indicating tracked orbital objects, predicted conjunctions, and orbital clearances.

The processing system may receive historical and real-time constraint data from memory, external storage, tracking systems, and data providers. Historical data may be stored in local databases, cloud-based repositories, or memory components. The processing system may retrieve historical constraint data as needed for launch analysis and risk assessment.

The processing system may receive real-time data from recording devices such as sensors, machines, assets, and cameras. The processing system may also receive real-time data from external sources and aggregate data from public and private organizations across various jurisdictions.

The processing system may receive constraint data in real time, as historical records, or as a combination of both. Historical data may be stored in local or cloud-based databases, while real-time data may be streamed directly from sensors, tracking systems, and data providers. The processing system may use this data to assess launch constraints and refine launch window calculations.

It should be understood that, in various embodiments, the processing system may perform all or portions of methods 500 and 600 (illustrated in FIGS. 5 and 6) in block 602, as well as blocks 702, 752, 802, 852, 902, 952, 1002, 1052, etc., to receive and process data.

In block 606, the processing system may normalize the constraint data to generate a standardized dataset. For example, the processing system may transform raw or inconsistently formatted data into a structured format compatible with downstream processing. In some embodiments, the processing system may use AI-driven techniques to normalize data from disparate sources. For example, the processing system may query an LXM or apply AI models to normalize the constraint data to generate a standardized dataset. This process may involve cleaning data, resolving inconsistencies, and organizing it into numerical, categorical, or vectorized representations. For example, in some embodiments, the processing system may perform data cleansing operations, such as resolving inconsistencies, correcting errors, filling missing values, and aligning measurement units. As further examples, the processing system may convert time zone information to Coordinated Universal Time (UTC) and standardize measurement units for weather, altitude, velocity, and positional data.

In some embodiments, the processing system may overlay real-time constraint data with historical constraint data to assess conditions affecting launch operations, enhance situational awareness, and identify deviations from expected patterns. For example, the processor may align real-time flight and maritime traffic data with historical trajectory data to identify potential conflicts within a launch window.

In some embodiments, the processing system may use the overlay to enhance situational awareness for launch planning. For instance, the processor may generate mapped representations showing real-time position reports for aircraft, maritime vessels, and orbital objects to corresponding historical routes or expected paths, and deviations from established flight paths, traffic congestion, regulatory restrictions, and other factors that may impact launch feasibility.

In some embodiments, the processing system may generate a time-series representation of the standardized dataset. For example, the processor may encode temporal changes in weather conditions, orbital traffic, and constraint variations into indexed data structures. In some embodiments, the processing system may analyze the time-series representation to identify trends. For instance, the processor may forecast periods of reduced airspace availability based on historical travel patterns.

In some embodiments, the processing system may construct a constraint graph based on the time-series representation. The constraint graph may define relationships between constraints and dependencies among them. For example, the processor may represent constraints as nodes and interdependencies as edges to model how weather conditions influence airspace availability. In some embodiments, the processing system may analyze the constraint graph to identify cascading effects. For instance, the processor may determine how delays in maritime traffic impact orbital schedules.

In some embodiments, in block 606, the processing system may apply individual trajectory analyses to each of the four flight phases. The system may adjust each phase's trajectory dynamically, applying the appropriate mission-specific limits, including trajectory deviations and environmental constraints, to ensure safety and operational efficiency. The system may integrate real-time flight data and adjust the trajectory segments accordingly.

In some embodiments, the processing system may perform the operations of blocks 502 and 504 (illustrated in FIG. 5) in block 606 to integrate real-time launch risk assessments into launch window determination.

In block 608, the processing system may generate constraint lines based on the standardized dataset and/or constraint graph. Each constraint line may represent time intervals during which specific constraints affect launch feasibility. For example, the processing system may calculate time intervals reflecting airspace restrictions, maritime traffic, or adverse weather conditions. In some embodiments, the processing system may apply algorithms to define constraint thresholds. For instance, the processor may map intervals where lightning activity or orbital conjunctions present risks to the launch timeline.

In some embodiments, the processing system may generate representations of time intervals associated with constraints for launches. For example, the processing system may receive constraint data that defines operational constraints over time, analyze the constraint data to determine a set of time intervals during which one or more constraints affect the launch operation, generate constraint lines that each correspond to a respective constraint and are associated with at least one of the time intervals, assign constraint ratings to the constraint lines based on an evaluation of constraint impact on launch feasibility, and generate a composite timeline by aligning multiple constraint lines along a shared temporal axis to represent constraint favorability across time intervals.

In block 610, the processing system may analyze the constraint lines to identify time intervals satisfying predefined launch constraints. For example, the processing system may evaluate combinations of constraints to determine feasible intervals for launch. In some embodiments, the processing system may enhance this analysis by prioritizing intervals with minimal constraint overlaps. For instance, the processor may rank intervals where airspace availability and favorable weather conditions coincide.

In some embodiments, the processing system may perform all or portions of method 500 (illustrated in FIG. 5) in blocks 604-610 to integrate real-time launch risk assessments into the launch window determination.

In block 612, the processing system may compute confidence scores for the identified time intervals. The processing system may evaluate these intervals by considering the probability of satisfying constraints, factoring in historical success rates and real-time variability. For example, the processor may analyze weather patterns, orbital trajectories, and traffic data to assign scores that represent the likelihood of a successful launch. In some embodiments, the processing system may execute AI models trained to assess these probabilities, providing a data-driven approach to evaluate and refine confidence scores.

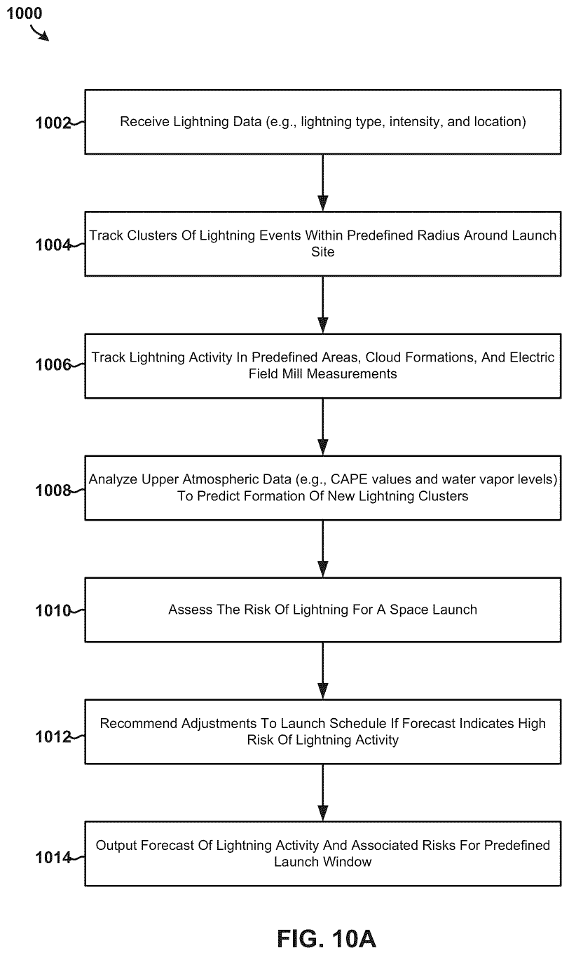

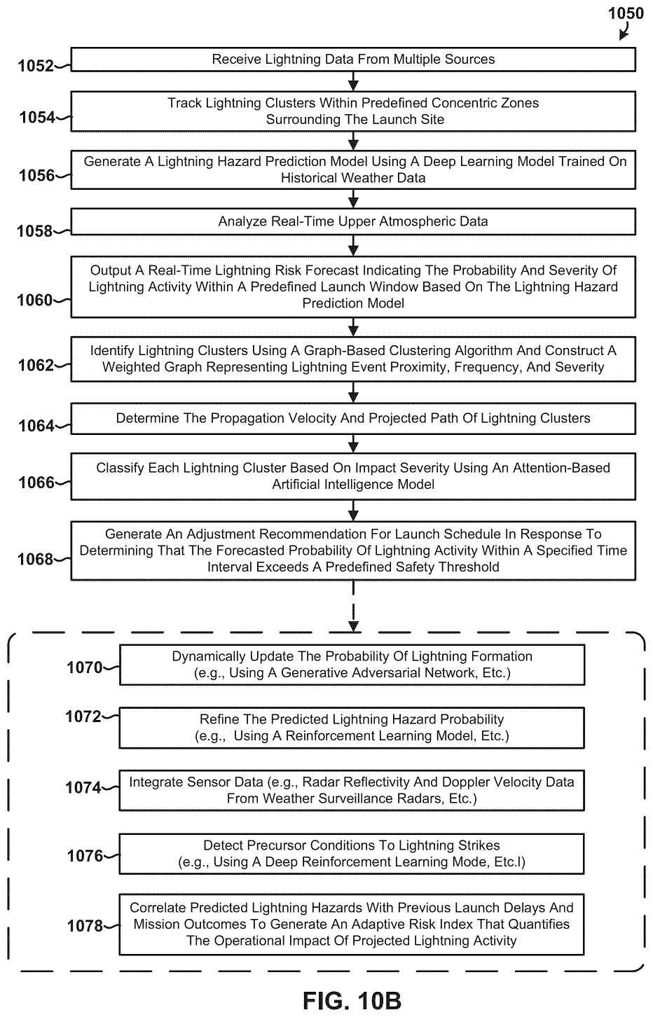

In some embodiments, the processing system may perform all or portions of method 1000 (illustrated in FIG. 10) in block 612 to refine launch constraints by assessing lightning risks.

In block 614, the processing system may select a launch window based on the computed confidence scores. The processing system may rank the identified time intervals according to their confidence scores and select the interval with the highest score as the optimal launch window. For example, the processor may use a ranking algorithm to prioritize intervals that best meet predefined launch criteria. In some embodiments, the processing system may overlay operational schedules of launch stakeholders to refine this selection. For instance, the processor may ensure that the selected launch window aligns with the availability of resources and the timelines of mission-critical tasks.

In some embodiments, the processing system may rank alternative launch windows based on their computed confidence scores. For example, the processor may identify backup intervals to serve as contingency options in case the optimal launch window becomes infeasible. The processing system may prioritize alternatives that require minimal adjustments to resources or schedules. For instance, the processor may favor intervals that align closely with pre-approved orbital trajectories to minimize disruption.

In some embodiments, the processing system may propose trajectory adjustments to maintain the feasibility of a selected launch window. For example, the processor may modify the nominal trajectory to avoid potential orbital conjunctions or other constraints. These adjustments may be calculated to mitigate risks while preserving overall mission objectives. In some cases, the processor may recommend changes to the trajectory that reduce resource consumption, such as conserving fuel or optimizing flight paths.

In some embodiments, the processing system may adapt the nominal launch trajectory to address conflicts and enhance feasibility. For example, the processor may calculate alternate trajectories that avoid restricted zones or weather disturbances. The processing system may prioritize trajectory options that maintain the accuracy of payload delivery while minimizing operational disruptions. For instance, the processor may recommend trajectory adjustments that balance risk mitigation and resource conservation.

In some embodiments, the processing system may execute an AI model to refine confidence score calculations. For example, the processor may retrain the model using updated datasets that include historical launch outcomes and real-time variations in constraints. This retraining process may enhance the model's ability to predict confidence scores with greater accuracy.

In some embodiments, the processing system may validate the refined AI model to ensure reliability. For example, the processor may compare predicted outcomes against actual launch conditions to assess the model's performance. By incorporating feedback from past launches, the processing system may iteratively improve the accuracy of confidence score predictions, thereby enhancing overall launch planning and decision-making.

In block 622, the processing system may output a launch window report. The report may include the identified optimal launch window, confidence scores, and supporting constraint data. For example, the processor may generate a Gantt chart visualizing launch schedules and constraints. In some embodiments, the processing system may distribute this report to stakeholders for planning purposes. For instance, the processor may provide real-time updates on scheduling adjustments and confidence metrics.

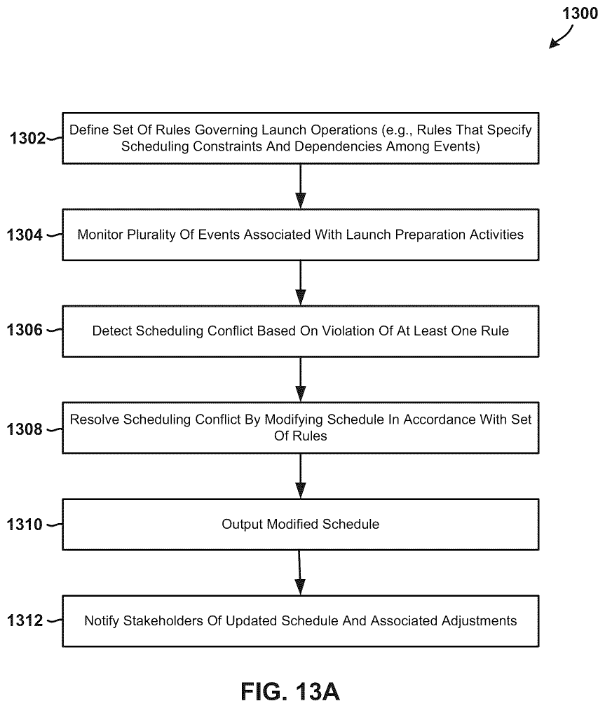

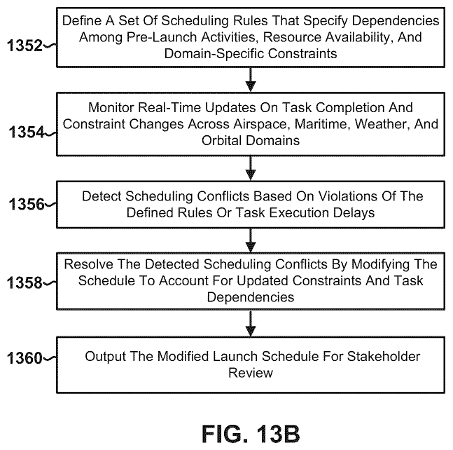

In some embodiments, the processing system may perform all or portions of method 1350 (illustrated in FIG. 13B) in block 622 to adaptively adjust launch schedules based on evolving launch window constraints.

In block 624, the processing system may store the standardized dataset, constraint lines, and confidence scores in memory. For example, the processor may archive the data for future analysis and model training. In some embodiments, the processing system may organize stored data for efficient retrieval. For instance, the processor may index datasets by constraint type, launch site, or temporal parameters to support ongoing optimization efforts.

In block 626, the processing system may continuously monitor constraint data and dynamically update confidence scores in response to real-time variations. For example, the processor may incorporate updates from sensors, regulatory alerts, or environmental data. In some embodiments, the processing system may refine scheduling dynamically. For instance, the processor may detect a developing storm and adjust confidence scores or selected windows accordingly.

In block 628, the processing system may adjust a scheduled launch window in response to changes in constraint data. For example, the processor may select a backup window if the confidence score for the current window drops below a threshold.

Method 600 improves the performance and functioning of the Space Launch Service Platform (SLSP) computing system by, for example, transforming large-scale, multi-source constraint data into structured, real-time launch window determinations, enhancing the system's computational efficiency and decision-making accuracy. By integrating terrestrial, orbital, weather, and launch vehicle data into a standardized format, the method may reduce processing latency and minimize inconsistencies that could lead to erroneous launch scheduling. The constraint graph may dynamically model interdependencies between operational constraints, allowing the SLSP computing system to assess cascading effects, such as how maritime delays impact airspace availability and orbital conjunctions. The confidence score computation, driven by machine learning and historical launch data, allows the SLSP computing system to prioritize launch windows with the highest probability of mission success while reducing computational overhead by filtering infeasible intervals early in the processing pipeline. Real-time monitoring and adaptive adjustments allow the SLSP computing system to maintain operational flexibility and automatically recalibrate launch schedules in response to environmental changes, regulatory updates, or unexpected mission constraints. The reinforcement learning framework continuously refines the SLSP computing system's ability to predict and rank launch opportunities by incorporating feedback from past launches, improving long-term system performance. By automating and optimizing complex constraint analysis, the method enhances the SLSP computing system's ability to process, adapt, and execute high-stakes launch scheduling operations with greater precision, reliability, and resource efficiency.

Some embodiments may include methods of applying artificial intelligence (AI) to detect and mitigate weather hazards affecting launch operations, which may include receiving, by a processing system, meteorological data from one or more sources (in which the meteorological data includes real-time weather observations, radar reflectivity measurements, and forecasted atmospheric parameters), generating a three-dimensional meteorological model representing spatial and temporal distributions of weather parameters relevant to a launch trajectory (in which generating the model include normalizing meteorological measurements and interpolating data using AI-driven models to identify gradients in cloud density, wind vectors, and atmospheric pressure), analyzing the three-dimensional meteorological model to classify regions of high reflectivity, wind shear, or convective activity that intersect the nominal launch trajectory or deviations thereof, determining whether meteorological conditions along the nominal trajectory or its deviations satisfy predefined safety thresholds (in which the safety thresholds include reflectivity, wind velocity, temperature gradients, and pressure variations), and outputting a weather hazard assessment report that identifies high-risk weather zones, provides confidence scores for launch feasibility, and recommends adjustments to the launch trajectory or schedule based on AI-driven hazard predictions.

In some embodiments, the processing system may train the AI model using historical weather data, including cloud evolution patterns and wind shear trends, to enhance prediction accuracy. In some embodiments, generating the three-dimensional meteorological model may include applying a convolutional neural network (CNN) to detect turbulence regions. In some embodiments, the processing system may use Kalman filtering to dynamically update the model with real-time weather data. In some embodiments, determining whether meteorological conditions satisfy safety thresholds may include executing a probabilistic model to calculate lightning risk probabilities. In some embodiments, the processing system may transmit real-time notifications to launch operators in response to determining that safety thresholds are exceeded (in which the notifications include suggested mitigation measures). In some embodiments, the hazard assessment report may include a visual overlay mapping severe weather zones onto the nominal launch trajectory. In some embodiments, the processing system may adjust the ascent trajectory based on updated confidence scores for weather hazard mitigation. In some embodiments, the processing system may generate the confidence scores using a Bayesian network trained on historical launch outcomes and atmospheric conditions.

FIG. 7A is a process flow diagram illustrating a method 700 of applying artificial intelligence (e.g., by querying an LXM, etc.) to detect and mitigate weather hazards that could affect launch operations in accordance with some embodiments. Method 700 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 700 may include these processors, components, and subsystems. One or more processors within the processing system may be configured with software or firmware to perform some or all of the operations of method 700. For ease of reference, all or portions of FIG. 7A are discussed with reference to clouds. However, nothing in this application should be used to limit this method to clouds unless expressly recited as such in the claims.

In some embodiments, the processing system may receive meteorological data from multiple sources (e.g., satellite-based weather monitoring systems, atmospheric sensors, radar stations, weather prediction models, etc.), analyze this data using AI-driven pattern recognition techniques to identify precursor conditions (e.g., turbulence, lightning, wind shear, reflectivity patterns, pressure variations, etc.) indicative of adverse weather that may impact a scheduled launch, and perform predictive modeling techniques to determine the likelihood and severity of weather-related hazards (e.g., high winds, lightning activity, cloud cover, precipitation, temperature extremes, atmospheric pressure changes, etc.). The processing system may dynamically update and refine its hazard assessments by integrating real-time weather observations, forecast updates, and historical launch weather data. The system may apply constraint-based analysis to determine whether specific weather conditions meet predefined safety criteria for launch operations. Based on the AI-generated hazard analysis, the processing system may generate and transmit notifications to launch operators regarding potential weather risks and suggested adjustments to launch scheduling.

In some embodiments, the processing system may interface with the scheduling component 266 and the safety and forecasting component 272 of the SLSP 400 to incorporate weather risk assessments into broader launch decision-making processes. The AI-driven weather hazard identification method may enhance launch reliability by improving launch scheduling based on real-time and predictive weather assessments.

With reference to FIG. 7A, in block 702, the processing system may receive meteorological data from weather radar sources, such as NEXRAD, Geostationary Operational Environmental Satellites (GOES), the GHRC, and the NLDN. In some embodiments, the received meteorological data may include cloud-related meteorological data (e.g., reflectivity, altitude, position, density, and turbulence) and other broader meteorological factors such as wind speed, pressure, temperature thresholds, humidity, and storm movement trends. For example, the meteorological data may include reflectivity measurements, cloud altitude, latitude, longitude, timestamp information, wind speeds, temperature, pressure, and humidity levels. The processing system may receive historical meteorological data from a memory (e.g., via storage component 213, etc.) or external repositories (e.g., via external sources 208a-208d, etc.). Real-time meteorological data may be collected using environmental sensors (e.g., via sensors 225, etc.), optical or infrared cameras (e.g., via cameras 231, etc.), or remote monitoring assets (e.g., via assets 229, etc.), with data transmission and integration facilitated by an edge computing device (e.g., via edge device 205, etc.).

In some embodiments, the processing system may receive trajectory data for the scheduled launch. The trajectory data may include spatial coordinates, velocity vectors, time-stamped position updates, and environmental condition limits such as wind speed, pressure, temperature thresholds, and turbulence parameters. The processing system may receive nominal trajectory paths and predefined deviations (e.g., via scheduling component 266, etc.), while mission-specific constraints may be provided (e.g., via mission parameters component 254, etc.).

In block 704, the processing system may generate a three-dimensional meteorological model based on the received radar reflectivity, atmospheric parameters, and trajectory data. The system may map reflectivity values and meteorological conditions onto a spatial grid where each grid point corresponds to latitude, longitude, altitude, temperature, and pressure. The processing system may normalize meteorological measurements (e.g., via data standardization component 216, etc.) and structure the model to align with launch safety thresholds (e.g., via safety and forecasting component 272, etc.). In some embodiments, the processing system may apply deep learning-based interpolation models to enhance the three-dimensional meteorological representation (e.g., via AI/ML component 230, etc.). The AI model may estimate cloud density gradients based on radar intensity, predict turbulence regions based on vertical velocity differentials, and account for wind vector influences on cloud drift using weather data (e.g., via weather analysis component 408, etc.). The AI model may also incorporate atmospheric pressure fluctuations, temperature gradients, and convective activity to improve hazard predictions.

In block 706, the processing system may analyze the three-dimensional meteorological model to determine reflectivity patterns indicative of severe weather, the proximity of weather formations to the launch trajectory and deviations, and potential airspace conflicts caused by adverse weather conditions intersecting the launch path. The processing system may identify high-reflectivity regions, wind shear zones, or temperature inversion layers that exceed predefined weather safety thresholds (e.g., via launch commit criteria component 402, etc.) and segment them into hazard zones (e.g., via safety and forecasting component 272, etc.). The system may then calculate the spatial proximity of weather hazard regions to the nominal trajectory and deviations (e.g., via launch collision avoidance component 410, etc.). In some embodiments, the processing system may execute an AI model trained to classify meteorological hazards by severity level (e.g., via AI/ML component 230, etc.). The AI model may detect convective activity leading to turbulence or lightning, integrate upper atmospheric wind shear data to assess storm movement over time (e.g., via weather analysis component 408, etc.), and predict hazard regions that may form or dissipate within the launch window.

In some embodiments, the processing system may perform all or portions of method 750 (illustrated in FIG. 7B) in block 706 to incorporate trajectory deviation risks into weather hazard assessments.

In block 708, the processing system may determine whether meteorological conditions along the nominal trajectory or deviation boundaries satisfy predefined safety constraints. The system may compare reflectivity values, wind vectors, temperature, and cloud proximity data against launch criteria (e.g., via launch commit criteria component 402, etc.), apply predefined constraint thresholds to determine whether meteorological hazards exceed acceptable risk limits (e.g., via safety and forecasting component 272, etc.), and execute an AI-based model to determine the probability of hazard movement into the launch trajectory (e.g., via AI/ML component 230, etc.).

In block 710, the processing system may output an assessment of whether the meteorological conditions along the predefined nominal trajectory or deviations therefrom satisfy predefined safety constraints. A time interval for the space launch may be associated with an assessment of various locations along or near the nominal trajectory or within or near deviations for weather hazards. An AI model may be trained to evaluate the favorability of weather conditions for one or more time intervals based on meteorological data, including cloud reflectivity, wind shear, temperature gradients, pressure variations, and other relevant weather parameters. The model may generate ratings indicating the favorability of weather conditions for each location along the trajectory, with ratings indicating greater favorability based on the degree to which meteorological data compares favorably to the weather constraint thresholds. Conversely, ratings indicating unfavorable weather conditions may be based on the meteorological data failing to meet the favorability comparison with the predefined weather constraint thresholds. These outputs may assist human decision-makers in determining whether adjustments to the launch schedule are necessary based on real-time weather conditions. In some embodiments, the processing system may generate and output a weather constraint report summarizing the safety assessment for each time interval (e.g., via notifications component 268, etc.). The report may indicate high-risk weather windows based on reflectivity, wind shear, temperature gradients, cloud proximity, and other relevant meteorological conditions. It may suggest potential adjustments to the launch schedule (e.g., via scheduling component 266, etc.), and overlay hazard zones, including severe weather regions (e.g., high wind zones, lightning activity, temperature extremes, etc.) onto a real-time launch trajectory visualization (e.g., via communications component 414, etc.).

In some embodiments, the processing system may perform all or portions of method 1000 (illustrated in FIG. 10) in block 710 to integrate lightning risk analysis into the weather favorability assessment.

In block 712, the processing system may compute a confidence score for launch feasibility based on historical launch data and success rates under similar weather conditions (e.g., via data storage component 224, etc.), real-time weather trends, and predicted storm movements (e.g., via weather analysis component 408, etc.). AI-driven probability models may predict launch constraints based on a combination of cloud cover, wind conditions, temperature, and other atmospheric parameters (e.g., via AI/ML component 230, etc.). In some embodiments, the processing system may dynamically adjust confidence scores based on updated weather forecasts and radar reflectivity patterns (e.g., via safety and forecasting component 272, etc.). If hazard probabilities exceed predefined safety margins, the processing system may recommend alternative launch windows (e.g., via scheduling component 266, etc.) and trigger notifications to launch operators regarding changing weather risks (e.g., via notifications component 268, etc.). In some embodiments, the processing system may incorporate mission-specific constraints when computing confidence scores (e.g., via mission parameters component 254, etc.). Certain payloads may be more sensitive to wind shear, humidity, atmospheric turbulence, or pressure fluctuations, requiring weighted adjustments to launch feasibility evaluations based on these meteorological factors.

In some embodiments, the processing system may perform all or portions of method 600 (illustrated in FIG. 6) in block 712 to align weather assessments with launch window selection.

In block 714, the processing system may determine whether predefined weather constraints are satisfied and notify launch operators accordingly. For example, the processing system may generate real-time weather overlays for display, compute confidence scores for launch scheduling recommendations using a scheduling component, and send automated alerts regarding dynamic weather changes affecting launch feasibility using a notifications component. These notifications may include updates related to evolving wind shear, pressure fluctuations, or other meteorological hazards.

In some embodiments, the processing system may present time-interval data using an interactive dashboard or Gantt chart visualization. For example, the processing system may display historical weather trends and real-time projections for cloud evolution, wind patterns, temperature variations, and other atmospheric phenomena using a data visualization component. The processing system may overlay hazard zones, including high-risk weather areas, onto a three-dimensional launch trajectory visualization. The processing system may update confidence score fluctuations in real time to reflect the latest meteorological assessments.

In some embodiments, the processing system may store hazard analysis data in a structured format for post-launch review. For example, the processing system may archive weather-related risk assessments, meteorological event records, and confidence score trends using a data storage component. The processing system may iteratively train an artificial intelligence model using new weather patterns, including cloud development, wind variations, and temperature fluctuations, to refine future launch weather predictions.

In optional block 716, the processing system may determine whether a detected meteorological hazard warrants modification of the launch trajectory or scheduling adjustments. For example, the processing system may compare detected weather conditions against predefined threshold values using a launch collision avoidance component. If evolving weather conditions, such as cloud formations, wind shear, or temperature extremes, pose a risk to launch operations, the processing system may execute trajectory adjustments to cause the adjustments or recommend adjusting the ascent trajectory to avoid hazardous conditions. The processing system may also refine launch rescheduling recommendations based on updated confidence scores using a scheduling component.

Method 700 may improve the performance and functioning of a computing system by, for example, integrating artificial intelligence and real-time meteorological data analysis to dynamically detect and mitigate weather hazards that could impact launch operations. By leveraging advanced AI techniques, including machine learning models and deep learning-based interpolation, the method allows for the generation of high-resolution, three-dimensional meteorological models that map complex atmospheric conditions in real time. This reduces processing latency and enhances situational awareness by providing detailed and actionable insights into weather risks along a launch trajectory. The system's ability to normalize, analyze, and visualize diverse data sources, coupled with real-time updates and predictive modeling, significantly enhances computational efficiency, allowing the system to deliver accurate weather assessments and hazard mitigation strategies. These improvements enable informed decision-making and operational adjustments, thereby enhancing the reliability, precision, and safety of space launch activities.

Some embodiments may include methods for assessing and mitigating risks associated with three-sigma trajectory deviations for space launch safety, including receiving, by a processing system, radar-based weather data from one or more sensor systems (in which the weather data includes reflectivity values, Doppler velocity readings, vertical wind structure data, and spatial coordinates corresponding to predefined three-sigma trajectory deviations), generating a three-dimensional model of weather phenomena along the three-sigma trajectory deviations (in which generating the model comprises normalizing radar measurements, interpolating spatial data using volumetric interpolation techniques, and incorporating reflectivity values, cloud density, wind vectors, and atmospheric pressure variations), analyzing the three-dimensional model to identify reflectivity patterns, turbulence-prone regions, and severe weather zones that intersect the trajectory deviations, calculating a proximity metric characterizing the spatial relationship between the three-sigma trajectory deviations and identified high-risk weather phenomena, determining whether predefined safety thresholds for reflectivity, turbulence, wind velocity, or lightning probability are satisfied along the three-sigma trajectory deviations, outputting a trajectory safety assessment indicating whether the weather conditions along the trajectory deviations meet the predefined safety thresholds (in which the assessment includes severity rankings for identified hazards), and executing trajectory adjustment algorithms or scheduling modifications in response to determining that predefined safety thresholds are not satisfied (in which the adjustments include recalculating an alternate trajectory or revising launch schedules to mitigate weather-related risks).

In some embodiments, the processing system may generate the three-dimensional model by applying convolutional neural networks (CNNs) trained to classify turbulence-prone regions based on radar reflectivity patterns and Doppler velocity readings. In some embodiments, the volumetric interpolation techniques used to construct the three-dimensional model may include kriging or inverse distance weighting to enhance the resolution of atmospheric conditions. In some embodiments, the proximity metric may be calculated using geospatial algorithms, including Vincenty's formula, to measure the shortest distance between high-reflectivity weather phenomena and the trajectory deviation boundaries. In some embodiments, the processing system may dynamically update the three-dimensional model using additional real-time radar data during an ongoing monitoring cycle (in which the updates are performed using Kalman filtering or recursive Bayesian techniques). In some embodiments, the predefined safety thresholds may include a reflectivity threshold, a lightning risk indicator, and a turbulence probability score derived from historical weather data and AI-based predictions. In some embodiments, the processing system may generate a confidence score for the trajectory safety assessment by integrating radar-based weather observations, historical launch data, and probabilistic hazard models trained using Bayesian inference.

In some embodiments, the processing system may transmit an alert notification to a launch control system in response to determining that the predefined safety thresholds are not satisfied, wherein the alert includes a classification of potential hazards and recommended mitigation measures. In some embodiments, the trajectory adjustment algorithms may incorporate updated wind shear data, temperature readings, and predicted storm movements to calculate alternate ascent routes that avoid hazardous weather conditions. In some embodiments, the processing system may present the trajectory safety assessment and confidence scores using a visual dashboard or Gantt chart (in which the visualization overlays severe weather zones onto the three-sigma trajectory deviations and displays dynamically updated risk metrics).

FIG. 7B is a process flow diagram illustrating a method 750 of assessing and evaluating risks specifically along three-sigma trajectory deviations for launch safety in accordance with some embodiments. Method 750 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 750 may include these processors, components, and subsystems. One or more processors within the processing system may be configured with software or firmware to perform some or all of the operations of method 750.

In some embodiments, the processing system may perform all or portions of method 750 to evaluate launch trajectory deviations and assess potential hazards along three-sigma deviation boundaries. The processing system may receive radar-based weather data, including cloud reflectivity measurements, Doppler velocity readings, and vertical wind structure data, to model turbulence and lightning risks along predefined deviation boundaries. The processing system may generate a three-dimensional model of weather phenomena (e.g., cloud structures/formations, storm systems, wind shear, turbulence, etc.) along the three-sigma trajectory deviations to detect reflectivity patterns, classify turbulence-prone regions, and predict storm movement near the launch path. The processing system may analyze reflectivity data using AI-based pattern recognition models to identify severe weather conditions that could compromise launch vehicle stability.

In some embodiments, the processing system may execute method 750 to determine whether weather-based hazards along the three-sigma trajectory deviation satisfy predefined safety constraints. The system may compute a proximity metric that characterizes the spatial relationship between high-reflectivity weather phenomena and the trajectory deviation boundaries. The processing system may compare real-time radar observations against historical weather conditions to generate a confidence score quantifying the probability of safe launch conditions. Based on the trajectory safety assessment, the processing system may generate an alert notification to a launch control system if predefined safety constraints are not satisfied. The notification may classify potential hazards based on severity rankings and provide real-time trajectory adjustments to mitigate weather-related risks.

In block 752, the processing system may receive data from a sensor system, which may be a radar system in some embodiments. The data may include reflectivity values, altitude, latitude, and longitude of weather phenomena along a three-sigma trajectory deviation. For example, the radar system may collect reflectivity measurements at multiple altitudes to capture variations in cloud density, moisture content, and vertical wind structures along the trajectory. In some embodiments, the radar system may include Doppler radar capabilities to provide wind velocity data.

In block 754, the processing system may generate a three-dimensional model of the weather phenomena (e.g., cloud formations, etc.) using the received data. The model may include spatial coordinates representing latitude, longitude, and altitude. For example, the processing system may integrate multiple radar observations to construct a volumetric representation of atmospheric conditions (e.g., cloud structures, etc.) across different layers of the atmosphere. In some embodiments, the processing system may apply volumetric interpolation techniques, such as inverse distance weighting or kriging, to construct a high-resolution representation of weather phenomena.

In block 756, the processing system may determine reflectivity patterns and spatial distributions of the weather phenomena, such as by using a computational reflectivity analysis. The processing system may analyze and compare reflectivity values at different altitudes to detect high-density cloud regions associated with turbulence risk. For example, the processing system may classify stratified cloud layers as turbulence hazards using machine learning models trained on historical meteorological data. In some embodiments, the processing system may apply supervised or unsupervised learning techniques to refine turbulence risk assessments.

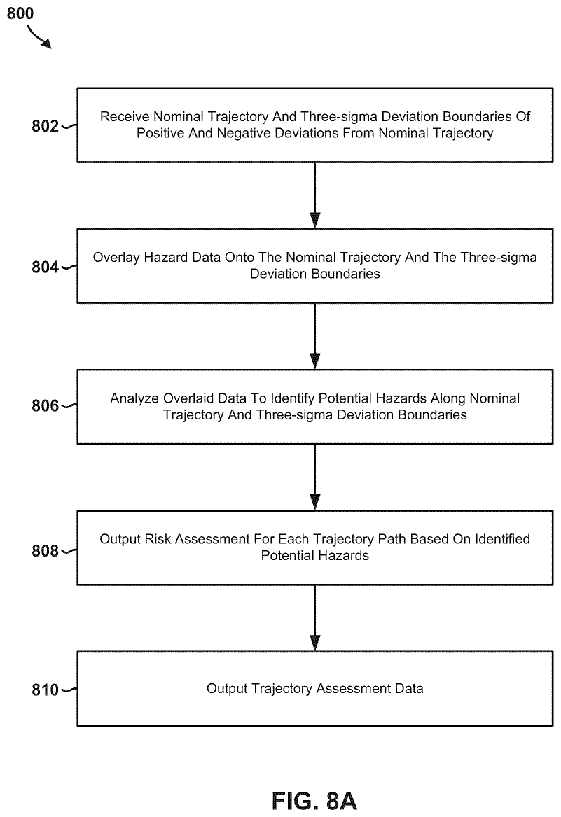

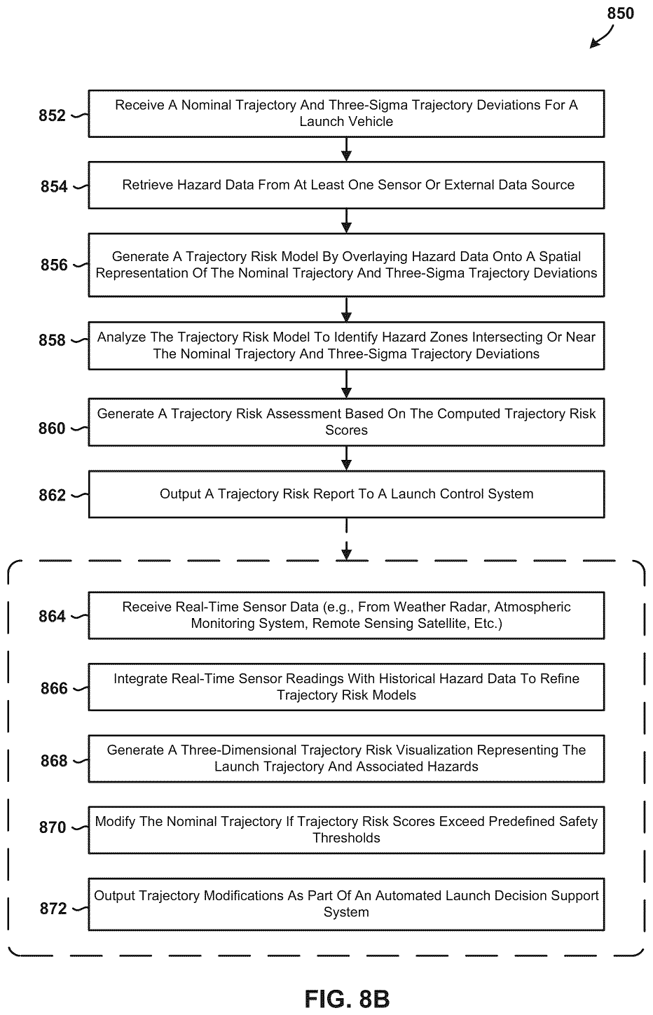

In some embodiments, the processing system may perform all or portions of method 800 (illustrated in FIG. 8) in block 756 to correlate identified weather turbulence with launch trajectory constraints.

In block 758, the processing system may calculate a proximity metric that characterizes the spatial relationship between high-reflectivity weather phenomena and the three-sigma trajectory deviation. The processing system may determine the shortest geodesic distance between the trajectory and high-reflectivity cloud regions. For example, the processing system may use Vincenty's formula or similar geospatial distance algorithms to measure whether weather phenomena intersect predefined safety margins.

In some embodiments, the processing system may perform all or portions of method 1000 (illustrated in FIG. 10) in block 758 to integrate lightning strike risk into trajectory risk assessments.

In block 760, the processing system may generate a trajectory safety assessment indicating whether weather phenomena along the three-sigma trajectory deviation satisfy predefined safety constraints. The assessment may include reflectivity thresholds, turbulence risk indicators, and other atmospheric parameters. For example, the processing system may compare observed reflectivity values to dynamically adjustable thresholds based on real-time weather conditions and classify regions exceeding those thresholds as potential hazards. The processing system may incorporate wind shear probabilities and convective energy calculations to refine the assessment.

In block 762, the processing system may update the three-dimensional model in real time using additional radar data received during an ongoing monitoring cycle. The processing system may apply temporal data fusion techniques, such as Kalman filtering or recursive Bayesian updates, to improve the accuracy of evolving weather phenomena. The processing system may integrate updated reflectivity measurements to track rapid changes in weather phenomena (e.g., cloud structures, etc.) over the launch area and adjust the trajectory safety assessment dynamically.

In some embodiments, the processing system may perform all or portions of method 850 (illustrated in FIG. 8B) in block 762 to refine launch trajectory adjustments based on predicted hazards.

In some embodiments, predefined safety constraints may include a reflectivity threshold, where weather phenomena exceeding this threshold are classified as turbulence hazards. The processing system may associate high-reflectivity regions with turbulence risk levels using predictive turbulence modeling. The processing system may analyze storm motion vectors to determine whether convective structures are moving toward the trajectory. If the processing system detects a convective cloud formation intersecting the trajectory, it may suggest an alternate launch window to mitigate turbulence risks.

In some embodiments, predefined safety constraints may include a lightning risk indicator, where the processing system associates high-reflectivity regions with a probability of lightning activity based on historical weather patterns. The processing system may analyze reflectivity data against archived storm data and upper-air instability metrics to estimate lightning probability. The processing system may assess electric field mill readings and cloud-to-ground lightning history to refine predictions. If the processing system detects weather phenomena characteristics (e.g., cloud reflectivity characteristics, etc.) consistent with past lightning events, it may generate an alert recommending an adjustment to the launch schedule.

In block 764, the processing system may determine reflectivity patterns and spatial distributions by identifying regions within the three-dimensional model that exceed predefined reflectivity thresholds indicative of potential hazards. The processing system may calculate a proximity metric defining the distance between high-reflectivity regions and the three-sigma trajectory deviation. The processing system may classify identified regions based on severity rankings derived from turbulence probability estimates and historical launch weather data. If multiple high-reflectivity regions are identified, the processing system may highlight the most severe risks to enable mission planners to focus on the most immediate threats.

In block 766, the processing system may generate a confidence score for the trajectory safety assessment based on historical launch data, radar-based weather observations, and statistical hazard probabilities. The confidence score may quantify the reliability of the safety assessment by integrating probabilistic analysis methods such as Bayesian inference or time-series neural network models. The processing system may compare current radar observations with past launch conditions and determine a probability estimate indicating the likelihood of safe launch conditions. If the processing system generates a high-confidence assessment indicating favorable weather conditions, mission control may proceed with launch operations. If the processing system generates a low-confidence score, it may trigger additional monitoring before finalizing the launch decision.

In block 768, the processing system may transmit an alert notification to a launch control system in response to determining that predefined safety constraints are not satisfied. The alert may include a detailed hazard classification and severity ranking. The processing system may generate a notification specifying whether the trajectory is affected by turbulence risk, lightning probability, or excessive cloud density. The processing system may prioritize alerts based on the probability of impact on the launch vehicle's stability. If the processing system classifies a weather phenomenon as a severe turbulence risk, mission control may delay launch operations until conditions improve.

In block 770, the processing system may execute trajectory adjustment algorithms in response to determining that predefined safety constraints are not satisfied. For example, the processing system may recalculate an alternate ascent route to reduce exposure to turbulence or lightning. The processing system may incorporate updated wind shear data, temperature readings, and predicted storm movement when adjusting path angles and velocity thresholds. In addition, the processing system may propose revised scheduling based on mission parameters to address weather-related delays. The processing system may present these adjustments to mission planners for confirmation or perform various operations to implement them.

Method 750 may enhance the performance and functioning of a computing system by, for example, providing a systematic approach to assess and mitigate risks associated with three-sigma trajectory deviations in space launch operations. By incorporating advanced geospatial algorithms, AI-driven reflectivity analysis, and probabilistic modeling, the method enables the system to evaluate complex weather conditions and predict potential hazards with high accuracy. The generation of three-dimensional weather models and the dynamic updating of these models using real-time radar data significantly improve the system's ability to monitor evolving conditions. Additionally, the computation of proximity metrics and trajectory safety assessments ensures that the system can prioritize and address the most critical risks, optimizing resource allocation and decision-making. These capabilities collectively enhance the system's operational efficiency and reliability by providing timely trajectory adjustments and risk assessments, thereby improving overall launch safety and mission success.

Some embodiments may include methods for enhancing launch trajectory safety through artificial intelligence, which may include receiving, by a processing system, trajectory data comprising spatial coordinates, velocity vectors, time-stamped position data, and predefined trajectory constraints associated with a launch vehicle, overlaying hazard data onto the trajectory data (in which the hazard data includes airspace restrictions, weather conditions, and maritime or orbital debris) (in which the overlaying aligns hazard data within a unified coordinate framework), analyzing the overlaid trajectory and hazard data using an artificial intelligence model to identify potential hazards along or near the trajectory (in which the analysis includes calculating hazard proximity metrics and comparing them to predefined safety thresholds), generating a risk assessment for the trajectory based on the identified potential hazards and the predefined safety thresholds (in which the risk assessment includes a favorability rating for each segment of the trajectory), and outputting trajectory assessment data that includes the risk assessment and recommendations for trajectory adjustments if required to avoid hazards.

In some embodiments, the trajectory data may include three-sigma deviation boundaries, and the hazard data may include time-series representations of dynamic weather phenomena, upper-atmosphere turbulence, or lightning risks. In some embodiments, the method may include applying a machine learning model trained on historical launch scenarios to predict movements of hazards relative to the trajectory, and dynamically updating the hazard data and risk assessment based on real-time hazard monitoring. In some embodiments, the artificial intelligence model may include a CNN trained to classify hazard severity levels based on proximity metrics and historical hazard data. In some embodiments, the method may include determining whether the trajectory risk assessment exceeds predefined safety thresholds and outputting recommendations for trajectory adjustments, including adjustments to altitude, latitude, or longitude, to avoid identified hazards. In some embodiments, the processing system may transform hazard data from external sources into a unified Earth-centered inertial (ECI) coordinate system and align it with the trajectory data. In some embodiments, the method may include generating a graphical user interface that displays the trajectory, hazard overlays, and risk assessment results to assist mission planners in decision-making.

FIG. 8A is a process flow diagram illustrating a method 800 of using artificial intelligence to correlate trajectory data with hazard information and improve launch operations in accordance with some embodiments. Method 800 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 800 may include these processors, components, and subsystems. One or more processors within the processing system may be configured with software or firmware to perform some or all of the operations of method 800.

In some embodiments, the processing system may execute method 800 to track potential hazards around the nominal and three-sigma trajectories, generate real-time or near-real-time recommendations, and support mission planners in refining trajectory or scheduling decisions.

In block 802, the processing system may receive trajectory data for a launch. The trajectory data may include spatial coordinates such as latitude, longitude, altitude, velocity vectors, and time-stamped position data. In some embodiments, the trajectory data may also reflect factors that affect a trajectory, such as hazard regions (e.g., NOTAMS, NOTMARS, or custom hazard regions) or environmental condition limits (e.g., wind speed, pressure, temperature) along the flight path. The trajectory data may specify predefined trajectory constraints or deviations, including nominal trajectories or three-sigma boundaries. In addition, the processing system may receive real-time telemetry data for an active launch vehicle launch.

The processing system may retrieve the trajectory data from a launch client that has scheduled a future launch. The data may be historical or real-time. Historical data may reference prior launches of a similar launch vehicle and may come from the launch client or from storage 213. Real-time data may arrive just before or during the launch from devices such as sensors 225, machines 227, assets 229, cameras 231, or external sources 208a-208d. The processing system may receive the data continually, periodically, or as needed.

In block 804, the processing system may layer or overlay hazard data onto the trajectory data. In some embodiments, the processing system may execute a spatial mapping algorithm to overlay hazard data onto the nominal trajectory and the three-sigma deviation boundaries. The processing system may retrieve hazard data from multiple sources, including airspace restrictions, maritime traffic, orbital debris, weather conditions, and ground-based obstacles. The processing system may transform all relevant datasets into a unified reference frame, such as an Earth-centered inertial (ECI) or Earth-centered Earth-fixed (ECEF) coordinate system, and interpolate or resample hazard data to match the resolution of the trajectory representation. The processing system may then apply geometric intersection algorithms, such as bounding volume hierarchies, spatial hash maps, or Voronoi diagrams, to determine where hazards intersect or approach the nominal trajectory or its deviation boundaries. The processing system may store hazard coordinates in a structured framework for subsequent risk evaluation. The processing system may associate hazard data with nominal trajectories and three-sigma deviation boundaries in both spatial and temporal dimensions. The hazard data may be derived from prior constraint assessments related to launch operations and may reflect meteorological factors such as lightning, wind conditions, or upper-atmosphere turbulence. The processing system may execute transformation functions to align hazard coordinates with nominal trajectories or deviations in a three-dimensional framework, where each hazard position is mapped relative to the trajectory at a given time. The processing system may generate time-series representations of hazard zones to account for hazard movement or expansion, dynamically adjusting the framework as updated hazard data becomes available. The processing system may assign spatial attributes such as latitude, longitude, and altitude to each hazard data point. The processing system may execute projection functions to overlay these hazard attributes onto nominal trajectories and three-sigma deviation boundaries. This projection may support visual and analytical comparisons by enabling the processing system to identify regions where the nominal trajectory or deviation boundaries intersect or approach hazard zones. The processing system may further generate trajectory overlays to facilitate risk analysis, allowing subsequent processing stages to compute safety assessments based on the proximity of hazards to expected flight paths. The processing system may execute an AI model trained to refine the integration of hazard data with trajectory data. The AI model may reference historical launch scenarios and environmental conditions to predict how hazards may evolve over time. The processing system may incorporate temporal data, such as radar reflectivity and wind shear measurements, to estimate changes in weather hazards leading up to a launch event. The processing system may apply machine learning-based alignment methods to improve accuracy when correlating hazard data with trajectory data, compensating for measurement variations across different data sources. These operations may allow for real-time, adaptive safety evaluations that continuously refine risk assessments as new hazard data becomes available.

In some embodiments, the processing system may perform all or portions of method 850 (illustrated in FIG. 8B) in block 804 to refine risk classifications by dynamically adjusting hazard prioritization.

In block 806, the processing system may analyze the hazard data overlaid on the trajectory data to identify potential hazards along or near the nominal trajectory or within or nearly within the three-sigma deviation boundaries. In some embodiments, the processing system may execute a spatial mapping algorithm to analyze hazard data overlaid on trajectory data and identify potential hazards along or near the nominal trajectory or within or nearly within the three-sigma deviation boundaries. In some embodiments, the processing system may execute an AI model trained to evaluate trajectory constraints during individual time intervals based on the overlaid hazard data. The AI model may analyze trajectory data in conjunction with hazard proximity metrics to infer the likelihood of satisfying trajectory constraints at different points along the nominal trajectory or within deviation boundaries. The processing system may map each trajectory segment to corresponding hazard proximity data within a structured spatial framework to allow the AI model to assess whether hazard regions exceed predefined safety thresholds. The AI model may compare hazard proximity data against constraint limits, such as minimum separation distances between the trajectory path and hazardous regions. If real-time trajectory telemetry data of a launched launch vehicle becomes available, the AI model may apply the same analysis to infer whether the trajectory remains within acceptable constraint limits based on continuously updated hazard proximity metrics. In some embodiments, the processing system may further execute an AI model trained to project movements of the launch vehicle during a launch and predict the effects of hazard data on the launch vehicle's trajectory. The AI model may incorporate real-time environmental data, such as wind shear or lightning risk, to simulate unplanned trajectory deviations due to atmospheric disturbances. The processing system may apply predictive modeling techniques, such as Kalman filtering or Gaussian mixture models, to estimate how external forces may affect the trajectory. The AI model may generate predicted trajectory adjustments and evaluate whether these predicted movements remain within acceptable safety margins relative to hazard zones. The processing system may output trajectory predictions and inferred constraint satisfaction or failure based on the computed proximity of predicted movements to hazard regions. By continuously updating hazard assessments and trajectory projections, the processing system may allow for real-time trajectory adjustments and risk mitigation strategies during launch operations.

In block 808, the processing system may output a risk assessment for each trajectory path based on identified potential hazards. A time interval for the launch may be associated with an assessment of the various locations along or near the nominal trajectory or within or near deviations for hazard regions. An AI model may be trained to rate the favorability of a launch trajectory avoiding being impeded by the hazard regions for the one or more time intervals for the launch. The launch trajectory may include the nominal trajectory, deviations, predicted movements, or actual trajectory from telemetry data. The rating may be based on the assessment of favorability of the launch trajectory for at least one and up to all the various trajectory or deviation locations. Ratings indicating greater favorability may be based on a degree by which the proximity data for the hazard regions compares favorably to trajectory constraint thresholds and ratings indicating unfavorable weather conditions may be based on the proximity data failing a favorability comparison with the trajectory thresholds. Individual launch missions may have additional factors to consider for risk assessment. For example, individual launch missions may be more or less sensitive to particular weather constraints than generally considered for risk assessment. In executing risk assessment, the processing system may weight aspects of the assessment based on sensitivity to the particular weather constraints. For example, the risk assessment may be weighted based on a payload sensitivity or mission-critical factor sensitivity to the particular weather constraints. Examples of the particular weather constraints may include levels of upper air limit conditions, such as wind direction, humidity, temperature, etc. limits, etc. Constraints and risk assessments may be calculated for one or more time intervals over various time ranges. For example, constraints and risk assessments for one or more time intervals may be calculated during approximately a week before the one or more time intervals. For another example, constraints and risk assessments may also be calculated during approximately a week following the one or more time intervals. Constraints and risk assessments may be calculated for the one or more time intervals at various intervals in the ranges. The intervals may be consistent or dynamic within the ranges. For example, the intervals may dynamically become more frequent based on time relative to the one or more time intervals. Initially the intervals may be daily intervals and may be reduced to intervals of one or more hours, minutes, or seconds as time for the one or more time intervals draws nearer.

In some embodiments, the processing system may perform all or portions of method 750 (illustrated in FIG. 7B) in block 808 to adjust trajectory assessments based on updated risk correlations.

In block 810, the processing system may output trajectory assessment data. In some embodiments, the trajectory assessment data may include trajectory adjustments if risk assessment exceeds predefined trajectory threshold. The trajectory assessment data may include recommendations for adjustments to the nominal trajectory or deviations, recommendations to scrub the launch, the ratings of the proximity to the trajectory, deviations, or predicted movements, the hazard data, the launch telemetry data, etc. The trajectory assessment data may be configured to be displayed on a device in a visual format, such as textually, graphicly, or a combination thereof. For example, the trajectory assessment data may be configured to be displayed via the launch service platform (SLSP).

The processing system may determine that the risk assessment for the nominal trajectory, deviations, predicted movements, or actual trajectory may exceed trajectory constraint limits for the launch vehicle. In response, the processing system may identify one or more adjustments to the nominal trajectory or deviations to avoid potential intersection with a hazard identified as exceeding the trajectory constraint limits. The processing system may analyze alternative trajectory options by considering spatial constraints, safety thresholds, and mission objectives. The adjustments may include adjustments to altitude, latitude, or longitude to navigate avoiding hazardous regions while maintaining alignment with mission goals. In some embodiments, trajectory adjustments may not be feasible, and the processing system may output a recommendation to scrub the launch.

In some embodiments, the processing system may execute an AI model trained to determine that the risk assessment for the nominal trajectory, deviations, or predicted movements may exceed threshold constraint limits and generate one or more adjustments to the nominal trajectory or deviations. In some embodiments, the processing system may execute the AI model to refine or dynamically update the adjustments. The AI model may be trained on historical launch data and risk scenarios and may be trained to predict the adjustments with greatest viability based on current hazard region conditions. For example, the AI models may be trained to simulate various trajectory options and evaluate their risk levels against predefined safety criteria for weather conditions, airspace traffic, maritime traffic, orbital traffic, etc. In some embodiments, the AI models may also be trained to integrate real-time hazard data and probabilistic forecasts to account for changing conditions. Various configuration of the AI models may further refine the recommendations by prioritizing adjustments that minimize fuel consumption or ensure compliance with regulatory constraints. The processing system executing the AI model may generate adaptive and precise recommendations, enhancing safety and efficiency during mission planning and execution.

The output trajectory assessment data may also include the ratings for the proximity of the nominal trajectory, deviations, or predicted movements to the hazard regions. The ratings may be configured to be interpreted to display information of a likelihood of the hazard regions impeding the launch. For example, the ratings may indicate that the nominal trajectory, deviations, or predicted movements are likely to head into lightning or threshold based wind conditions. For another example, the rating may indicate distances between flight and maritime vessels and the nominal trajectory, deviations, or predicted movements. Similarly, the hazard data associated with the ratings may be output and configured to be interpreted to display the hazard data.

The telemetry data may be configured to be interpreted to display information of the path of the launch. In some embodiments, the telemetry data may be configured to show real-time progression of the launch. In some embodiments, the telemetry data may be configured to indicate deviations of the trajectory from the nominal trajectory or the deviation boundaries.

In some embodiments, the trajectory assessment data may be output in a format to be stored as part of a data set configured for training the AI models used for trajectory assessment. The trajectory assessment data may be output to a memory of or accessible by the processing system.

In some embodiments, the processing system may be configured to identify hazard to launches based on analysis of flight and maritime vessel data within a dedicated distance from a launch site. For example, the processing system may be configured to perform methods for predicting vessel and aircraft movement near a launch site, which may include receiving historical and real-time navigational data (e.g., flight paths, vessel routes, origin-destination pairs, timestamps, durations, etc.), generating a library of frequently used paths that are categorized by temporal factors including time of day and season, comparing real-time navigational data to the generated library to identify deviations from historical patterns, estimating the proximity of identified vessels and aircraft to the launch site during a defined launch window, and outputting a proximity prediction report for the identified vessels and aircraft.

In some embodiments, the proximity prediction report may include probabilities of vessel or aircraft presence within a predefined hazard zone around the launch site. In some embodiments, the methods may include generating alerts in response to determining that a predicted proximity exceeds a predefined threshold. In some embodiments, the navigational data may be sourced from ICAO, MarineTraffic, and/or FlightAware.

Method 800 may improve the performance and functioning of the computing system by, for example, leveraging artificial intelligence models and advanced data integration techniques to process, analyze, and overlay hazard data onto trajectory data in real time. By incorporating machine learning algorithms trained on historical and real-time data, the computing system dynamically identifies and evaluates potential hazards along or near the nominal trajectory and three-sigma deviation boundaries. The method optimizes computational efficiency through the use of spatial mapping algorithms and unified coordinate frameworks, enabling seamless alignment of diverse hazard datasets with trajectory representations. In addition, the system enhances decision-making accuracy by generating risk assessments and trajectory adjustment recommendations tailored to mission-specific constraints and evolving environmental conditions. These advancements allow the computing system to provide adaptive, real-time safety evaluations that reduce latency, mitigate risks, and ensure robust support for launch operations, ultimately extending the system's utility and reliability in dynamic and high-risk environments.

Some embodiments may include methods for producing adaptive launch decisions by integrating trajectory data and hazard analyses, which may include receiving trajectory data for a launch vehicle, the trajectory data comprising a nominal trajectory and three-sigma trajectory deviations (in which the three-sigma trajectory deviations define upper and lower variations relative to the nominal trajectory, and the trajectory data further includes spatial coordinates, velocity vectors, and time-stamped position data), retrieve weather hazard data from at least one sensor or external data source (the weather hazard data including atmospheric turbulence, lightning activity, cloud formations, and upper-atmosphere conditions), generating a trajectory risk model by overlaying the weather hazard data onto the trajectory data (in which the trajectory risk model aligns hazard data with the nominal trajectory and three-sigma deviations in a three-dimensional spatial framework), analyzing the trajectory risk model to identify weather hazard zones intersecting or near the nominal trajectory and three-sigma trajectory deviations, and classify hazard severity using predefined thresholds based on real-time electrical activity, wind shear gradients, and convective indices, generating a trajectory risk assessment based on identified hazard zones (in which the risk assessment includes trajectory risk scores computed from weighted evaluations of turbulence severity, lightning strike probability, and proximity metrics), and outputting a trajectory risk report to a launch control system, the report including the trajectory risk scores, identified hazard zones, and recommendations for trajectory adjustments or launch timing modifications.

In some embodiments, receiving the trajectory data may include retrieving precomputed three-sigma trajectory deviations generated using Monte Carlo simulations or covariance propagation to model atmospheric variability and thrust differentials. In some embodiments, retrieving weather hazard data may include ingesting multi-spectral satellite data, Doppler radar readings, radiosonde measurements, and storm prediction indices, and normalizing the data using geospatial interpolation techniques. In some embodiments, generating the trajectory risk model may include constructing a three-dimensional probabilistic representation incorporating ensemble forecasts from meteorological sources, including the Global Forecast System (GFS). In some embodiments, analyzing the trajectory risk model may include applying geodesic proximity metrics, computed using Vincenty's formula, to determine the intersection of hazard zones with three-sigma trajectory deviations. In some embodiments, generating the trajectory risk assessment further may include integrating historical mission performance data and applying machine learning-based anomaly detection to refine safety evaluations. In some embodiments, outputting the trajectory risk report further may include generating a color-coded geospatial visualization of trajectory segments with identified risk zones and predicted hazard severity levels. In some embodiments, the methods may further include receiving real-time atmospheric sensor data and updating the trajectory risk model using time-series anomaly detection and temporal data fusion techniques. In some embodiments, the methods may further include modifying the nominal trajectory if the trajectory risk score exceeds a predefined safety threshold, in which the modification may include adjusting spatial parameters such as altitude, latitude, or longitude to navigate around identified hazard zones. In some embodiments, the methods may further include computing optimized trajectory modifications using reinforcement learning models trained to minimize exposure to weather hazard zones and reduce fuel consumption.

FIG. 8B is a process flow diagram illustrating a method 850 of integrating trajectory data and hazard analyses to produce adaptive launch decisions in accordance with some embodiments. Method 850 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 850 may include these processors, components, and subsystems. One or more processors within the processing system may be configured with software or firmware to perform some or all of the operations of method 850.

In some embodiments, the processing system may execute method 850 to evaluate potential hazards along a predefined or dynamically adjusted launch trajectory.

In block 852, the processing system may receive a nominal trajectory and three-sigma trajectory deviations for a launch vehicle. The three-sigma trajectory deviations may define upper and lower variations relative to the nominal trajectory. The processing system may retrieve precomputed trajectory deviations from a flight dynamics model using Monte Carlo simulations or covariance propagation to model atmospheric variability and thrust differentials. The processing system may analyze these deviations to determine how external environmental factors influence trajectory shifts. The processing system may apply unscented Kalman filtering or Gaussian process regression to predict deviations caused by upper-atmospheric disturbances, including turbulence, wind shear, and pressure gradients.

In block 854, the processing system may retrieve weather hazard data from at least one sensor or external data source. The weather hazard data may include cloud formations, upper-atmospheric conditions, lightning activity, etc. The processing system may retrieve satellite-based weather monitoring data and ingest multi-spectral sensor data, including infrared and water vapor imagery, to characterize cloud density variations along the trajectory. In some embodiments, the processing system may integrate weather hazard data from multiple sources to improve situational awareness. These sources may include Doppler radar wind shear measurements, radiosonde upper-atmosphere soundings, and convective activity indices from storm prediction models. The processing system may apply geospatial interpolation techniques such as kriging or inverse distance weighting to normalize multi-source weather hazard data.

In some embodiments, the processing system may perform all or portions of method 1400 (illustrated in FIG. 14) in block 854 to resolve scheduling conflicts related to adaptive hazard assessment.

In block 856, the processing system may generate a trajectory risk model by overlaying weather hazard data onto a spatial representation of the nominal trajectory and three-sigma trajectory deviations. The processing system may generate geospatial mappings using satellite imagery and numerical weather models to align weather hazard data with trajectory parameters. The processing system may construct a three-dimensional probabilistic risk model incorporating ensemble forecasting from meteorological sources such as the Global Forecast System (GFS) and the European Centre for Medium-Range Weather Forecasts (ECMWF). The trajectory risk model may provide a predictive assessment of potential hazards, including turbulence onset, lightning probability, and thermal instability.

In block 858, the processing system may analyze the trajectory risk model to identify weather hazard zones intersecting or near the nominal trajectory and three-sigma trajectory deviations. The processing system may classify hazard severity using predefined thresholds based on real-time electrical activity, convective available potential energy (CAPE), and wind shear gradients. The processing system may compute geodesic proximity metrics to determine whether cloud formations encroach on three-sigma trajectory deviations, applying Vincenty's formula to improve measurement precision. The processing system may generate a trajectory risk score based on a weighted assessment of turbulence severity, lightning strike probability, and wind shear gradients. The processing system may compare identified weather hazard zones against historical mission performance data to refine launch safety assessments. The processing system may evaluate statistical trends from prior launches and apply machine learning-based anomaly detection to identify deviations from expected meteorological conditions.

In some embodiments, the processing system may perform all or portions of method 600 (illustrated in FIG. 6) in block 858 to align real-time hazard analysis with launch window determination.

In block 860, the processing system may generate a trajectory risk assessment based on the computed trajectory risk scores. The processing system may apply predefined evaluation criteria to determine an overall trajectory safety rating. The processing system may generate a color-coded geospatial risk visualization, indicating the severity of hazards along different segments of the launch trajectory. The processing system may integrate predictive analytics, using recurrent neural networks (RNNs) or Bayesian forecasting models, to project potential trajectory deviations due to emerging weather conditions.

In some embodiments, the processing system may perform all or portions of method 1300 (illustrated in FIG. 13A) in block 860 to integrate risk assessments into multi-stakeholder launch logistics planning.

In block 862, the processing system may output a trajectory risk report to a launch control system. The trajectory risk report may include trajectory risk scores, identified weather hazard zones, and a confidence measure derived from probabilistic ensemble forecasting. The processing system may transmit the trajectory risk report to mission planners in real time and provide automated recommendations for adjusting launch timing and modifying trajectory parameters based on evolving atmospheric risks.

In block 864, the processing system may receive real-time sensor data from at least one weather radar, atmospheric monitoring system, or remote sensing satellite. The processing system may ingest data from Doppler radar systems monitoring upper-atmospheric wind shear, ground-based lightning detection networks, and satellite-based cloud tracking systems.

In block 866, the processing system may integrate real-time sensor readings with historical weather hazard data to refine trajectory risk models. The processing system may apply time-series anomaly detection algorithms to detect meteorological conditions deviating from seasonal patterns.

In block 868, the processing system may generate a three-dimensional trajectory risk visualization, representing the launch trajectory and associated weather hazards. The visualization may depict trajectory deviations and hazard zones, incorporating interactive geospatial overlays. The processing system may provide an interactive visualization tool allowing mission planners to zoom into specific trajectory segments and analyze localized risk factors. The processing system may apply GPU-accelerated rendering techniques for real-time model updates.

In block 870, the processing system may modify the nominal trajectory if trajectory risk scores exceed predefined safety thresholds. The modifications may include identifying alternate launch windows by analyzing historical and forecasted weather conditions. The processing system may compute optimized trajectory modifications using reinforcement learning models trained to reduce exposure to high-severity weather hazard zones.

In block 872, the processing system may output trajectory modifications as part of an automated launch decision support system. The processing system may recommend minor lateral adjustments to maintain optimal flight corridors or trajectory modifications preserving mission objectives while minimizing exposure to severe weather conditions.

Method 850 may improve the performance and functioning of the computing system by, for example, enhancing its ability to dynamically analyze and adapt to complex, time-sensitive data associated with launch trajectory safety. By integrating trajectory data with weather hazard analyses in a three-dimensional spatial framework, the method allows the computing system to generate real-time risk models and trajectory assessments with high precision. These operations may use advanced algorithms, such as geospatial mapping, ensemble forecasting, and machine learning-based anomaly detection, to improve the system's ability to process multi-source, heterogeneous data into actionable insights. Further, by incorporating predictive analytics and real-time sensor updates, the method allows for adaptive decision-making, allowing the computing system to dynamically refine trajectory models and optimize launch decisions based on evolving environmental conditions. This results in improved computational efficiency, reduced latency in risk evaluations, and enhanced system reliability, supporting safer and more effective launch operations.

Some embodiments may include methods performed by a processing system in a computing device to integrate terrestrial object hazard data into launch operations, which may include receiving historical and real-time terrestrial navigational data from at least one external source, the navigational data including aviation flight paths, maritime vessel routes, timestamps, and restricted travel areas, generating a library of frequently used paths categorized by temporal factors, the temporal factors including time of day and seasonal variations, wherein the library is configured to organize paths based on frequency and relevance for a launch perimeter, comparing the received real-time terrestrial navigational data to the library to identify deviations of aircraft and maritime vessels from historical patterns, estimating a proximity of identified aircraft and maritime vessels to a launch site during a launch window based on the comparison, (in which the estimating includes calculating spatial distances and projecting trajectories relative to a launch perimeter), generating a proximity prediction report that includes the estimated proximity, identified deviations, and potential risks to launch operations, and transmitting the proximity prediction report to a launch control system in real time for operational decision-making.

In some embodiments, generating the library of frequently used paths may include aggregating historical navigational data from memory (the navigational data including timestamps, locations, and environmental conditions), categorizing the aggregated data using an AI model trained to identify correlations between paths and temporal factors, and storing the categorized paths in a structured repository for subsequent comparison. In some embodiments, estimating the proximity of aircraft and maritime vessels to the launch site may include applying a geospatial framework to project trajectories of aircraft and maritime vessels based on velocity, heading, and waypoint data, determining whether the projected trajectories intersect a predefined launch safety perimeter at one or more time intervals within the launch window, and classifying proximity risks based on the likelihood of intersection with the safety perimeter. In some embodiments, comparing the real-time terrestrial navigational data to the library may include applying an AI model trained to recognize emerging deviations by analyzing differences in spatial coordinates, velocities, and headings relative to historical patterns and distinguishing acceptable variances from abnormal deviations based on operational and environmental factors. In some embodiments, the proximity prediction report may include graphical representations of projected trajectories and hazard zones, textual summaries of potential risks categorized by severity, and recommendations for adjusting launch schedules or modifying trajectories to mitigate identified risks.

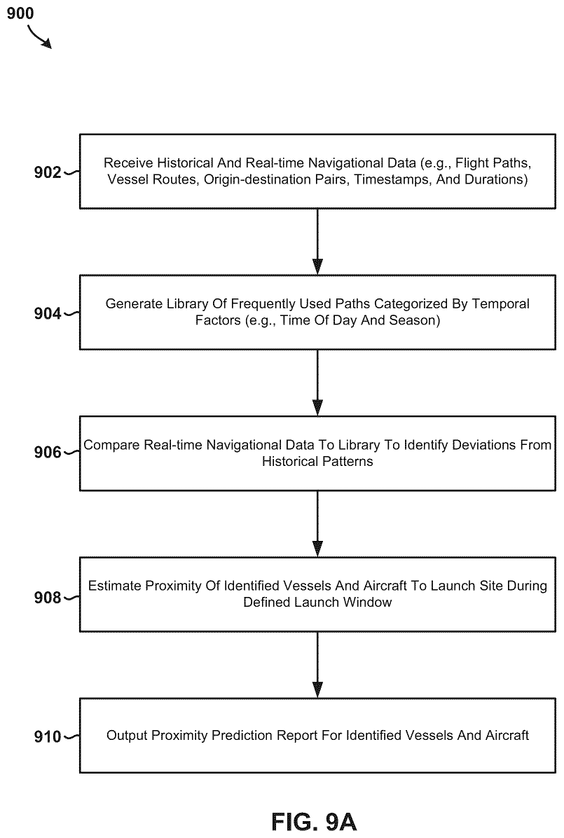

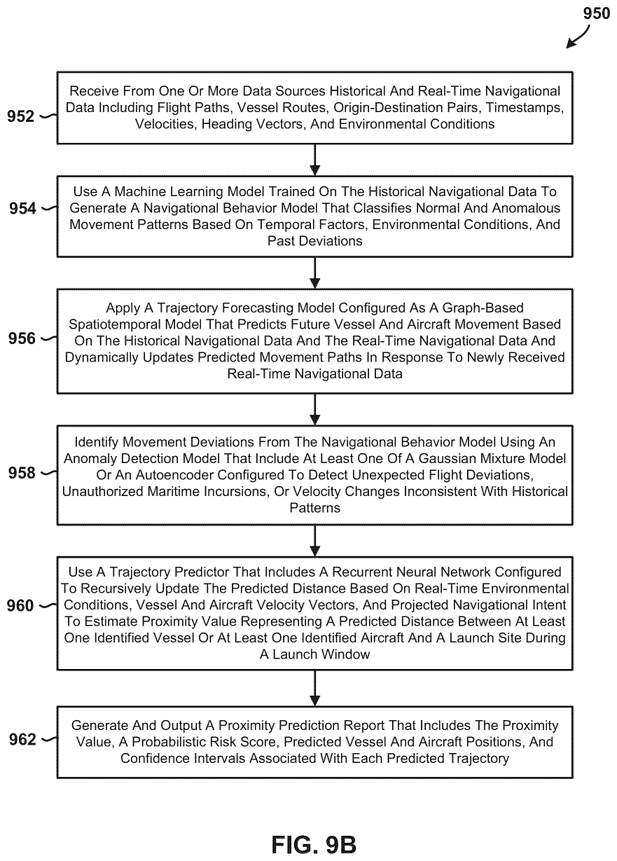

FIG. 9A is a process flow diagram illustrating a method 900 of using artificial intelligence to identify terrestrial object hazards to improve launch operations in accordance with some embodiments. Method 900 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 900 may include these processors, components, and subsystems. One or more processors within the processing system may be configured with software or firmware to perform some or all of the operations of method 900.

In block 902, the processing system may receive historical and real-time terrestrial navigational data. Terrestrial navigational data may include aviation flight paths, marine vessel routes, origin-destination pairs, timestamps, durations, restricted travel areas (e.g., NOTAM, NOTMAR, etc.), etc. In some embodiments, the terrestrial navigational data may include terrestrial navigational data within or near a perimeter around a launch site. The terrestrial navigational data may include historical data, real-time data, or a combination thereof. Historical terrestrial navigational data may include data recorded from previous time periods and stored in a memory (e.g., storage 213, external sources 208a, 208b, like ICAO, FlightAware, MarineTraffic, etc.) locally or remotely that the processing system may receive from the memory. Real-time terrestrial navigational data may include data recorded approximately contemporaneously to a current time, such as within a designated time frame prior to the current time or a designated time frame for recording or updating the real-time data. The real-time data may be received from real-time data recording devices (e.g., sensors 225, machines 227, assets 229, cameras 231), real-time data sources (e.g., external sources 208a, 208b, like ICAO, FlightAware, MarineTraffic, etc.), or a combination thereof.

It should be understood that, in some embodiments, the processing system may perform all or portions of methods 500 and 600 (illustrated in FIGS. 5 and 6) in block 902 to receive and process received data.

In block 904, the processing system may generate a library of frequently used paths categorized by temporal factors (e.g., time of day, season, etc.). The processing system may aggregate historical data, including flight routes, marine vessel paths, associated timestamps, etc. to identify patterns in the movement of vehicles within or near specified regions. For example, the specified region may include the perimeter around the launch site. Temporal factors such as time of day, day of the week, season, weather conditions, etc. may be used by the processing system to categorize these paths and to correlate between recurrent or divergent navigational plan or behaviors data and temporal event data. The processing system may gather correlated data in a library configured to organize paths based on frequency and relevance for specific factors, such as location, time, etc. The library may be a repository of traffic patterns that may enable strategic planning of launches at the launch site. In some embodiments, the processing system may execute an AI model trained to identify the correlations of the paths and temporal factors and output the correlations. In some embodiments, the processing system may execute the AI model trained to further classify and predict paths. The AI model, such as clustering algorithms, may identify recurring patterns in large datasets, may be trained to group paths into categories based on temporal and spatial characteristics. For example, the processing system may detect seasonal variations in maritime traffic or peak air traffic periods near launch sites. Additionally, the AI model may be trained to predict future traffic behaviors based on historical trends, enabling proactive planning for potential conflicts during launch windows. This library may be a resource for enabling evaluation of navigational risks, optimization of scheduling, and safe and efficient operations in airspace and maritime regions near launch sites.

In block 906, the processing system may compare real-time navigational data to the library to identify deviations of traffic in airspace and maritime space from historical patterns. The real-time navigational data, which may be included in the received real-time data, may include marine traffic and air traffic feeds detailing latitude, longitude, altitude, velocity, heading, waypoints or junctions, etc. of aircraft and maritime vessels.

The processing system may monitor the received real-time navigational data and map positions and movements of aircraft and maritime vessels to spatial coordinates. Expected routes may be identified from frequently used paths recorded in the library. The processing system may identify and compare the expected routes to the real-time navigational data. Deviations from the expected path by an aircraft or a maritime vessel may be identified from location data differing from the expected path. In some embodiments, a deviation may be based on location data outside of tolerance threshold for differentiation from the expected path. In some embodiments the processing system may execute an AI model trained to compare the real-time navigational data to the library to identify deviations of traffic in airspace and maritime space from historical patterns. The AI model may be trained on historical traffic behaviors and may be trained to recognize subtle or emerging deviations that could signal potential hazards or scheduling conflicts. The AI model may also be trained to account for dynamic factors, such as weather disruptions or operational delays, to distinguish acceptable variances from abnormal patterns. The processing system may further integrate these insights with real-time launch planning to assess how deviations may impact predefined safety constraints or scheduling requirements. Predictive AI modeling may enable adaptive risk management and allows for informed decision-making during critical operations.

In some embodiments, in block 906, the processing system may dynamically integrate maritime traffic data into risk contours and recalculate estimated casualty (EC) scores in real time based on the positions and trajectories of maritime vessels. As the system receives updates on maritime vessel positions, it may adjust the risk contours to reflect changes in vessel movement and their proximity to the launch trajectory. This recalculation ensures that casualty estimates remain continuously refined and aligned with current maritime activities.

In block 908, the processing system may estimate proximity of identified maritime vessels and aircraft to launch site during a launch window. The processing system may analyze the real-time navigational data and project the trajectories of maritime vessels and aircraft within a spatial framework in which a perimeter of launch site may be included. The distance between the projected trajectories and the perimeter of the launch site at various time intervals during the launch window may be calculated. The perimeter may be configured as one or more proximity constraint thresholds, which may vary by time relating to the launch window, may be applied to identify potential conflicts or hazards surrounding the launch site. In some embodiments, the processing system may execute an AI model trained to estimate proximity of the identified maritime vessels and aircraft to the launch site during a launch window. The AI model may be trained to predict future movements of maritime vessels and aircraft based on historical behavior and real-time navigational data. The AI model may be trained to incorporate factors such as speed variations, known schedules, and environmental conditions to estimate the likelihood of maritime vessels and aircraft entering restricted zones, such as the perimeter, during the launch window. The AI models may be trained to further classify proximity risks into categories, or ratings, such as low, medium, or high, to assist in prioritizing responses. Proximity identification may enable launch planners to anticipate potential safety risks, adjust schedules or trajectories, and minimize operational disruptions. Proximity of the identified maritime vessels and aircraft to the launch site during a launch window may be calculated for one or more time intervals over various time ranges. For example, proximity for one or more time intervals may be calculated during approximately a week before the one or more time intervals. For another example, proximity may also be calculated during approximately a week following the one or more time intervals. Proximity may be calculated for the one or more time intervals at various intervals in the ranges. The intervals may be consistent or dynamic within the ranges. For example, the intervals may dynamically become more frequent based on time relative to the one or more time intervals. Initially the intervals may be daily intervals and may be reduced to intervals of one or more hours, minutes, or seconds as time for the one or more time intervals draws nearer.

In some embodiments, in block 908, the processing system may use the heading and direction of maritime vessels to predict future EC values. By predicting the movement of these vessels over time, the system may estimate how their paths will interact with the hazard areas, adjusting the EC score to reflect the likely future positions of the vessels. This predictive capability may provide a more accurate understanding of the casualty risks posed by maritime traffic in the launch corridor.

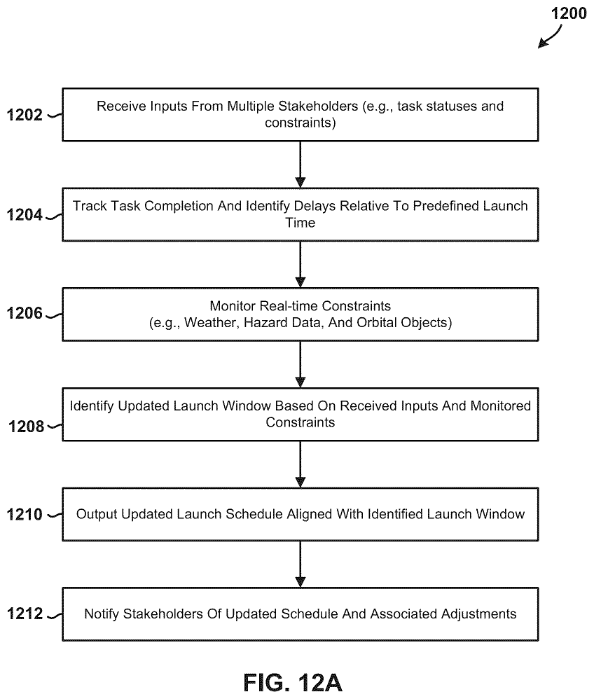

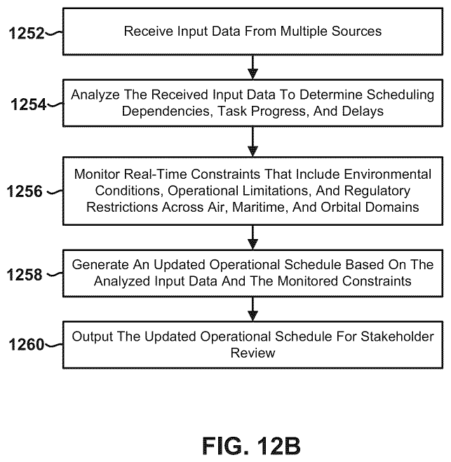

In some embodiments, the processing system may perform all or portions of method 1200 (illustrated in FIG. 12) in block 908 to integrate terrestrial object risk assessments into logistics coordination.

In block 910, the processing system may output a proximity prediction report for the identified maritime vessels and aircraft. The proximity prediction report may include real-time proximity measurements between the positions of the maritime vessels and aircraft and the launch site or the perimeter around the launch site. In some embodiments, the proximity prediction report may include predicted proximity measurements between the predicted trajectories of the maritime vessels and aircraft and the launch site or the perimeter around the launch site at various times. The proximity prediction report may also include identifies for the maritime vessels and aircraft, potential safety risks, suggest adjustments to schedules or launch trajectories, etc. The proximity prediction report may be formatted to enable a visual display, such as textually, graphicly, or a combination thereof, or analytical assessment of the information therein. For example, the proximity prediction report may be configured to be displayed via the launch service platform (SLSP).

In some embodiments, the processing system may perform all or portions of method 1350 (illustrated in FIG. 13B) in block 910 to adjust launch schedules in response to terrestrial object movement predictions.

In some embodiments, the proximity prediction report may include location, paths and expected time of movements along the paths, identification, risk of encroachment on a launch, etc. of one or more terrestrial vessels. For another example, the proximity prediction report may be configured to be graphically displayed in an organized manner for evaluation of the proximity prediction report. For example, the proximity prediction report may be organized in one or more Gantt charts to visualize how proximity constraints relate to a launch timeline. In some embodiments, the time interval data may be displayed as a constraint line showing a relationship between the time interval and the corresponding rating of associated proximity constraints.

In some embodiments, the proximity prediction report may be output in a format to be stored as part of a data set configured for training the AI models used for proximity assessment. The proximity prediction report may be output to a memory of or accessible by the processing system.

In some embodiments, the processing system may be configured to track and predict lightning hazard to launches based on analysis of lightning data and weather data within a dedicated distance from a launch site. For example, the processing system may be configured to perform methods for predicting hazardous weather conditions near a launch site, which may include receiving lightning data (e.g., lightning type, intensity, and location, etc.) from multiple sources, tracking clusters of lightning events within a predefined radius around the launch site, analyzing upper atmospheric data (including CAPE values and water vapor levels) to predict the formation of new lightning clusters, and outputting a forecast of lightning activity and associated risks for a predefined launch window.

In some embodiments, the predefined radius may include nautical mile zones around the launch site. In some embodiments, the methods may include identifying and tracking lightning clusters based on geographic proximity, timestamp similarity, and intensity. In some embodiments, the methods may include recommending adjustments to the launch schedule in response to determining that the forecast indicates a high risk of lightning activity.

Method 900 may improve the performance and functioning of the computing system by, for example, integrating historical and real-time terrestrial navigational data with advanced AI-based analysis to dynamically assess potential hazards near a launch site. By generating a library of frequently used paths categorized by temporal factors, the method allows the system to establish a baseline of expected traffic patterns. The comparison of real-time navigational data to this library allows the system to identify deviations indicative of emerging risks. The integration of real-time maritime and aviation traffic data with predictive models enhances the system's ability to calculate proximity risks and refine hazard estimates dynamically. This adaptive risk assessment capability optimizes decision-making by providing precise, time-sensitive proximity prediction reports, allowing adjustments to launch schedules or trajectories. As a result, the method enhances the system's ability to process and analyze large-scale, multi-source data streams efficiently, reduces the likelihood of operational disruptions, and ensures safer and more reliable launch operations.

Some embodiments may include methods for identifying terrestrial object hazards to improve launch operations, which may include receiving historical and real-time navigational data, the navigational data including flight paths, vessel routes, origin-destination pairs, timestamps, velocities, and environmental conditions, generating a navigational behavior model using a machine learning model trained on the historical navigational data (in which the navigational behavior model classifies normal and anomalous movement patterns based on temporal factors and environmental conditions), applying a trajectory forecasting model to predict future vessel and aircraft movement based on the historical navigational data and the real-time navigational data (the trajectory forecasting model dynamically updating predicted movement paths in response to newly received real-time navigational data), detecting movement deviations from the navigational behavior model using an anomaly detection model configured to identify unexpected deviations in flight or maritime routes, estimating a proximity value representing a predicted distance between at least one identified vessel or at least one identified aircraft and a launch site during a launch window (in which the estimation uses a trajectory predictor model incorporating real-time environmental conditions and velocity vectors), generating a proximity prediction report that includes the proximity value, a probabilistic risk score, and predicted vessel and aircraft positions, and outputting the proximity prediction report to a launch operations interface in which the proximity prediction report is used for launch scheduling and safety management.

In some embodiments, the methods may include retraining the navigational behavior model using historical trajectory datasets to refine movement deviation thresholds based on environmental conditions and dynamically adjusting risk classifications in response to real-time changes in navigational data. In some embodiments, generating the navigational behavior model may include applying clustering algorithms to segment historical navigational behaviors into distinct categories based on speed variations, heading changes, and deviations from established routes. In some embodiments, the trajectory forecasting model may represent air and maritime traffic networks as graph structures (in which nodes correspond to waypoints and edges represent movement paths). In some embodiments, the anomaly detection model may include at least one of a Gaussian mixture model or an autoencoder configured to detect deviations exceeding predefined statistical thresholds. In some embodiments, estimating the proximity value may include executing Monte Carlo simulations to quantify uncertainty in trajectory predictions and refine risk-adjusted proximity assessments. In some embodiments, the methods may include generating an alert in response to determining that the proximity value satisfies a predefined alert threshold, the alert including a hazard classification and a recommended mitigation strategy. In some embodiments, the proximity prediction report may include a graphical visualization depicting predicted movement paths, risk zones, and expected times of closest approach relative to the launch site. In some embodiments, the methods may include updating the trajectory forecasting model using transfer learning techniques to incorporate recent flight and vessel movement data. In some embodiments, the processing system may apply a federated learning framework to integrate decentralized data from multiple spaceports to refine risk assessments and anomaly detection thresholds.

FIG. 9B is a process flow diagram illustrating a method 950 of using artificial intelligence to identify terrestrial object hazards in accordance with some embodiments. Method 950 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 950 may include these processors, components, and subsystems. One or more processors within the processing system may be configured with software or firmware to perform some or all of the operations of method 950.

In block 952, the processing system may receive, from one or more data sources, historical and real-time navigational data including flight paths, vessel routes, origin-destination pairs, timestamps, velocities, heading vectors, and environmental conditions. For example, the processing system may receive the historical navigational data and the real-time navigational data from an aviation data source, a maritime data source, and/or an air traffic surveillance data source. The processing system may process received data by aligning timestamps, normalizing coordinate systems, and filtering duplicate or erroneous entries. The processing system may store processed navigational data in a structured format to support subsequent trajectory analysis, anomaly detection, and risk assessment.

In block 954, the processing system may use a machine learning model trained on the historical navigational data to generate a navigational behavior model that classifies normal and anomalous movement patterns based on temporal factors, environmental conditions, and past deviations. For example, the processing system may apply clustering techniques, such as Gaussian mixture models, to segment historical navigational behaviors into distinct movement categories. The processing system may evaluate movement data based on speed variations, heading changes, and deviations from established routes under different operational and environmental conditions. The machine learning model may classify movement patterns as normal when they align with historical trends and may classify them as anomalous when deviations exceed predefined statistical thresholds. In some embodiments, the processing system may refine the navigational behavior model by incorporating real-time data, adjusting classification thresholds, or integrating additional environmental variables, such as wind speed, wave height, or turbulence levels.

In block 956, the processing system may apply a trajectory forecasting model configured as a graph-based spatiotemporal model that predicts future vessel and aircraft movement based on the historical navigational data and the real-time navigational data and dynamically updates predicted movement paths in response to newly received real-time navigational data. For example, the processing system may represent air and maritime traffic networks as graph structures, where nodes correspond to waypoints and edges represent movement paths. The processing system may apply predictive modeling techniques, such as recurrent neural networks, to forecast movement paths based on historical trajectory sequences and real-time heading vectors.

The processing system may update predicted movement paths when new velocity or position data becomes available. In some embodiments, the processing system may incorporate external constraints, such as restricted airspace boundaries, active maritime exclusion zones, or evolving weather conditions, to refine trajectory forecasts and improve prediction accuracy.

In block 958, the processing system may identify movement deviations from the navigational behavior model using an anomaly detection model that include at least one of a Gaussian mixture model or an autoencoder configured to detect unexpected flight deviations, unauthorized maritime incursions, or velocity changes inconsistent with historical patterns. For example, the processing system may compare real-time movement data against the trained navigational behavior model to determine whether observed trajectories align with previously classified normal movement patterns. The processing system may assign probability scores to detected deviations and flag movement paths that exceed predefined anomaly thresholds. The processing system may further categorize detected anomalies based on severity, duration, or potential operational impact. In some embodiments, the processing system may incorporate feedback mechanisms to refine anomaly detection parameters, reducing false positives and improving classification precision as additional movement data becomes available.

In block 960, the processing system may use a trajectory predictor that includes a recurrent neural network configured to recursively update the predicted distance based on real-time environmental conditions, vessel and aircraft velocity vectors, and projected navigational intent to estimate proximity value representing a predicted distance between at least one identified vessel or at least one identified aircraft and a launch site during a launch window. For example, the processing system may process velocity and heading data to generate continuous trajectory estimates and compute dynamic proximity values relative to the launch site. The processing system may update proximity predictions as new environmental data, such as wind speed, turbulence, or maritime current direction, is received. The processing system may also incorporate real-time tracking data from air traffic control systems or maritime monitoring networks to refine proximity estimations. In some embodiments, the processing system may execute Monte Carlo simulations or confidence interval computations to quantify uncertainty in trajectory predictions and provide risk-adjusted proximity assessments.

In block 962, the processing system may generate and output a proximity prediction report that includes the proximity value, a probabilistic risk score, predicted vessel and aircraft positions, and confidence intervals associated with each predicted trajectory. For example, the processing system may aggregate trajectory forecasting results and anomaly detection outputs to compile a consolidated risk assessment. The processing system may generate graphical visualizations depicting predicted movement paths, risk zones, and expected times of closest approach relative to the launch site. The processing system may output the proximity prediction report in a structured format suitable for integration with launch operations dashboards or automated decision-support systems. In some embodiments, the processing system may update the report continuously as new navigational data becomes available, providing real-time risk assessments for launch scheduling and safety management.

In some embodiments, the processing system may be configured to use a reinforcement learning-based risk assessment model trained to evaluate trajectory intersection points, altitude or depth deviations, and proximity to restricted zones to generate and assign risk level values to the identified vessels and identified aircraft.

In some embodiments, the processing system may be configured to calculate a confidence score for the probabilistic risk score by, for example, using a Bayesian inference model trained on historical launch interference data.

In some embodiments, the processing system may be configured to generate the proximity prediction report to include a probability distribution for at least one identified vessel and at least one identified aircraft within a hazard zone defined around the launch site, a classification for each identified vessel and each identified aircraft based on an assigned risk level, and/or a confidence score for the probabilistic risk score.

In some embodiments, the processing system may be configured to generate an alert in response to determining that the proximity value satisfies a predefined alert threshold and transmit the alert to a launch operations interface.

In some embodiments, the processing system may be configured to generate the alert to include a hazard classification and a recommended mitigation strategy. In some embodiments, the processing system may be configured to generate the alert so that it prioritizes identified hazards based on at least one of vessel classification, aircraft classification, velocity, or predicted impact on a launch trajectory.

In some embodiments, the processing system may be configured to retrain the navigational behavior model using historical trajectory datasets (e.g., obtained from ICAO, MarineTraffic, or FlightAware, etc.), dynamically refine a movement deviation threshold based on environmental conditions, and adjust risk classifications in response to real-time changes in the historical navigational data or real-time navigational data. In some embodiments, the retraining operations may include labeling past anomalies and launch interference events. In some embodiments, the processing system may apply adversarial reinforcement learning to weather-conditioned pathing models and update the movement deviation threshold based on the results generated by applying adversarial reinforcement learning to weather-conditioned pathing models. In some embodiments, the processing system may be configured to update the risk classifications by using a federated learning framework that integrates decentralized data from multiple spaceports.

In some embodiments, the processing system may be configured to autonomously update a predictive model for vessel and aircraft movement by using transfer learning techniques to retrain the trajectory forecasting model to incorporate recent flight and vessel movement data from at least one previous launch event, adapt real-time alerting sensitivity based on seasonal maritime congestion trends and dynamic no-fly zones, and/or apply a Monte Carlo sampling method to stochastic movement models to generate a refined probability score for trajectory intersections.

Method 950 may improve the performance and functioning of the computing system by, for example, leveraging artificial intelligence models and advanced data processing techniques to dynamically identify, classify, and mitigate terrestrial object hazards during launch operations. By integrating historical and real-time navigational data, the method allows the computing system to detect anomalies in movement patterns, predict vessel and aircraft trajectories, and assess proximity risks in near real time. These capabilities may enhance situational awareness and allow the system to adapt to evolving conditions by continuously updating risk assessments and trajectory forecasts. The use of machine learning for behavior modeling and anomaly detection may optimize data analysis, reduce false positives, and improve decision accuracy, allowing the computing system to provide actionable insights and recommendations for launch scheduling and safety. This adaptive, data-driven approach may allow for more efficient resource utilization, enhance computational precision, and reduce the risk of launch disruptions, thereby improving the overall reliability and functionality of the computing system.

Some embodiments may include methods for assessing lightning hazards to improve launch operations, which may include receiving lightning data including lightning type, intensity, location, and atmospheric data such as Convective Available Potential Energy (CAPE) values, water vapor levels, and wind speeds from historical and real-time data sources, identifying clusters of lightning events within a predefined radius around a launch site by analyzing geographic coordinates, timestamps, and intensity data of the lightning events, tracking movement patterns of the identified lightning clusters using atmospheric data including wind shear and pressure gradients, predicting, by the computing system using an artificial intelligence (AI) model trained on historical lightning data, future propagation paths and growth patterns of the lightning clusters relative to a launch trajectory, generating a probabilistic lightning risk assessment for a launch window based on predicted lightning cluster proximity, intensity, and atmospheric conditions, recommending adjustments to the launch schedule in response to the probabilistic lightning risk assessment exceeding a predefined threshold, and outputting a forecast of lightning activity and associated risks for display on a launch operations interface.

In some embodiments, receiving lightning data may include collecting electric field mill readings and reflectivity data from ground-based sensors and normalizing data from multiple sources into a unified format for analysis. In some embodiments, tracking lightning clusters may include classifying lightning events based on cloud-to-ground and cloud-to-cloud discharges, analyzing temporal clustering of electrical discharges to determine propagation speed and direction, and evaluating the likelihood of continued lightning activity using CAPE thresholds and water vapor content. In some embodiments, the AI model may be configured to simulate lightning cluster dynamics under varying atmospheric conditions, incorporate real-time cloud formation data into propagation predictions, and refine predictions based on feedback from observed lightning cluster behaviors during prior launch operations. In some embodiments, generating a probabilistic lightning risk assessment may include computing risk scores based on predicted distances between lightning clusters and the launch site, applying Monte Carlo simulations to estimate risk variability across different launch time intervals, and generating confidence intervals for each risk score to quantify uncertainty.

In some embodiments, recommending adjustments to the launch schedule may include identifying alternative launch windows by comparing risk assessments for multiple time intervals, simulating weather impacts for the alternative launch windows, and prioritizing recommendations based on minimizing operational delays while maintaining safety.

In some embodiments, outputting a forecast further includes generating graphical visualizations of lightning risk zones and trajectories, presenting risk scores and associated confidence levels for display on a user interface, and updating the forecast in real time as new lightning data is received. In some embodiments, the computing system may be configured to integrate lightning hazard assessments with orbital collision avoidance recommendations by analyzing trajectory overlaps between lightning risk zones and orbital debris paths, generating combined risk scores for lightning and collision hazards, and providing integrated scheduling recommendations for mitigating both hazards. In some embodiments, the AI model may employ transfer learning to incorporate new lightning event data into its training set, refine lightning cluster growth predictions based on recent atmospheric observations, and adapt risk thresholds dynamically based on evolving weather patterns. In some embodiments, the forecast of lightning activity is formatted as a Gantt chart displaying risk levels across a launch timeline, a three-dimensional map of lightning cluster propagation relative to the launch trajectory, and a summary report highlighting critical time intervals with high risk of lightning impact.

FIG. 10A is a process flow diagram illustrating a method 1000 of using artificial intelligence to identify lightning hazards to improve launch operations in accordance with some embodiments. Method 1000 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 1000 may include these processors, components, and subsystems. One or more processors within the processing system may be configured with software or firmware to perform some or all of the operations of method 1000.

In block 1002, the processing system may receive lightning data. Lightning may include information relating to lightning type (e.g., cloud-to-cloud, ground-to-cloud, etc.), intensity, and location. In some embodiments, lightning data may include additional information, such as upper atmospheric data, including Convective Available Potential Energy (CAPE) values, water vapor levels, temperature, humidity, wind speed, cloud reflectivity, electric field mill readings for surface electric fields, etc. The lightning data may include historical data, real-time data, or a combination thereof. Historical lightning data may include data recorded from previous time periods and stored in a memory (e.g., storage 213, external sources 208d, like NLDN, Geostationary Lightning Mapper (GLM), International Center for Lightning Research and Testing (ICLRT), etc.) locally or remotely that the processing system may receive from the memory. Real-time lightning data may include data recorded approximately contemporaneously to a current time, such as within a designated time frame prior to the current time or a designated time frame for recording or updating the real-time data. The real-time data may be received from real-time data recording devices (e.g., sensors 225, machines 227, assets 229, cameras 231), real-time data sources (e.g., external sources 208d, like NLDN, ICLRT, etc.), or a combination thereof. In some embodiments, the lightning data may be received as described herein for block 502 of the method 500 with reference to FIG. 5. In some embodiments, the lightning data may be data received as described for block 602 of the method 600 with reference to FIG. 6. The processing system may receive the trajectory data continuously, periodically, or episodically.

In block 1004, the processing system may track clusters of lightning events within a radius around a launch site. The radius around the launch site may be a radius within or near which a cluster of lightning events may affect a launch, such as 20, 50, 80, etc. nautical miles. The processing system may identify lightning events by geographic coordinates (e.g., latitude, longitude, and altitude) and timestamps, and may group nearby lightning events occurring within a defined time window to form lightning clusters. In some embodiments, lightning events may be additionally identified and grouped by intensity. A spatial analysis may be performed by the processing system to relate the proximity of the lightning clusters to the launch site or launch trajectory. Further, for each lightning cluster, the processing system may evaluate the intensity of lightning activity based on lightning data such as peak current and flash rate. Using predefined safety thresholds for distance and intensity, the processing system may analyze potential risks of the lightning clusters affecting the launch.

In block 1006, the processing system may track lightning activity in predefined areas, cloud formations, and electric field mill measurements. The processing system may monitor lightning activity by analyzing reflectivity, intensity, and electrical discharge events within predefined zones. The processing system may classify lightning events based on their characteristics, such as cloud-to-ground discharges, cloud-to-cloud discharges, and associated reflectivity and intensity measurements.

The processing system may analyze spatial and temporal clustering of lightning activity to track movement patterns of electrical discharges. The processing system may identify whether a cluster of lightning events remains stationary or propagates toward a launch site. Using data indicative of water vapor content, wind shear, and pressure gradients, the processing system may determine whether atmospheric conditions support continued lightning activity. The processing system may compare observed lightning movement against historical data to generate probabilistic models for predicting future lightning propagation.

In some embodiments, the processing system may execute an AI model trained to refine lightning event predictions based on historical weather conditions. The AI model may be trained to analyze past instances of lightning occurrence relative to launch sites and predict a likelihood of electrical discharge activity within a designated time window.

The processing system may also track cloud formations based on data indicative of atmospheric instability, vertical cloud development, and convective storm evolution. The processing system may use CAPE values, CIn values, precipitable water PW measurements, and cloud top height data to assess storm formation potential. The processing system may determine whether a cloud formation meets predefined instability thresholds based on CAPE and CIN values.

Tracked changes in dew point pressure profiles may be used by the processing system to determine cloud base height variations. The processing system may identify a relationship between cloud top height, cloud base height, and water vapor content to predict whether a cloud formation is expanding, dissipating, or migrating toward a launch trajectory. Wind speed and direction data at multiple altitude levels may be analyzed by the processing system to determine cloud displacement trends.

In some embodiments, the processing system may execute an AI model trained on historical cloud movement data to predict future cloud formation trajectories. The processing system may compare real-time cloud observations with historical patterns and determine whether a cloud system presents a potential constraint for launch scheduling. The processing system may output cloud movement predictions, classification of atmospheric constraints, and recommendations for scheduling adjustments based on projected weather evolution.

Some embodiments may include integration of real-time electric field measurements with cloud formation tracking. Electric field data may be from at or near a launch site. The processing system may analyze fluctuations in electric field strength to determine whether atmospheric conditions support lightning initiation. The processing system may integrate electric field data with cloud formation tracking to refine the classification of convective storm severity.

In block 1008, the processing system may analyze upper atmospheric data to predict formation of new lightning clusters. The processing system may execute AI models to track and predict lightning clusters. The AI model may be trained on historical lightning and atmospheric data and may be trained to identify patterns in lightning activity, predict the growth or dissipation of clusters, and estimate movement of lightning clusters relative to the launch site. The AI model may be trained to further simulate how changing upper air conditions, such as wind shear or temperature gradients, may influence the dynamics of lightning clusters. The processing system may execute the AI model trained to analyze potential risks of the predicted lightning clusters affecting the launch. The processing system executing the AI model may provide real-time insights and adaptive recommendations to mitigate risks during launch operations.

Accuracy of lightning risk assessment may be enhanced by the processing system incorporating upper air condition data, such as the CAPE values and the water vapor levels, or precipitable water levels. CAPE values may represent buoyant energy in the atmosphere for convection, where the capacity of the atmosphere is measured to support upward air movement that can lead to cloud formation and storms. In response to atmospheric conditions (thresholds) being met (e.g., warm, moist air in an atmosphere that cools rapidly with height), this may indicate sustained upward air movement that stimulates the formation of cumulus or cumulonimbus clouds (thunderstorm clouds). Radiosonde data, such as temperature, dew point, and pressure profiles may be used to calculate CAPE values.

Precipitable water levels may measure a total amount of water vapor in a vertical column of the atmosphere, which may be captured by radiosonde, and may be used in calculating a depth of water where water vapor in the column is to be condensed. Precipitable water levels may be measured in millimeters or inches. convective inhibition (CIn) may calculate energy that prevents an air parcel from rising from the surface to an altitude where free convection is seen. In other words, CIn may be the altitude at which air parcels stop ascending due to cooler surrounding air. Data used in measuring CIn may include radiosonde captured temperature, dew point, and pressure profile data.

High CIn levels, exceeding a CIn threshold may indicate that the atmosphere is stable, making it harder for air parcels to rise, thus indicating lower chances of thunderstorms, and vice versa. High precipitable water levels, exceeding a precipitable water threshold, may indicate heavy rainfall. Coupled with instability in the atmosphere indicated by CIn, the high precipitable water levels may indicate a potential thunderstorm, thus leading to a higher probability of lightning.

CAPE values exceeding safety thresholds may indicate a greater likelihood of severe convective activity, and water vapor levels exceeding safety thresholds may indicate an environment of greater conductivity to lightning formation. The processing system may correlate the atmospheric data with the lightning clusters to increase accuracy of understanding of evolving weather conditions and potential impacts on the launch. In some embodiments, the processing system may execute an AI model trained to track lightning clusters.

In block 1010, the processing system may assess the risk of lightning for a launch. The processing system executing an AI model may determine whether predicted weather conditions, lightning and cloud formation and movement, align with lightning constraints and may select launch intervals based on probabilistic risk assessments, or ratings of the lightning constraints. For example, the processing system may classify one or more time intervals, associated with a ratings that indicate an acceptable likelihood that the lightning constraints will not impede that launch, as acceptable launch windows. The processing system may output the risk assessments and association with the time intervals. For example, the lightning constraints may be based on a likelihood of an amount of lightning within a radius around a launch site.

Lightning risk assessment during a launch window may be calculated for one or more time intervals over various time ranges. For example, the lightning risk assessment for one or more time intervals may be calculated during approximately a week before the one or more time intervals. For another example, lightning risk assessment may also be calculated during approximately a week following the one or more time intervals. Lightning risk assessment may be calculated for the one or more time intervals at various intervals in the ranges. The intervals may be consistent or dynamic within the ranges. For example, the intervals may dynamically become more frequent based on time relative to the one or more time intervals. Initially the intervals may be daily intervals and may be reduced to intervals of one or more hours, minutes, or seconds as time for the one or more time intervals draws nearer.

In block 1012, the processing system may recommend adjustments to a launch schedule if a forecast indicates high risk of lightning activity. The processing system may identify whether the lightning clusters, measured or predicted, pose a potential risk exceeding a risk threshold, or lightning constraint. To recommend schedule adjustments, the processing system may evaluate alternative launch windows by making risk assessments for the alternative launch windows based on similar analyses and information as used to determine the risk assessment for the launch window for which the risk exceed the risk threshold. Alternative launch windows for which the risk assessment does not exceed the risk threshold may be identified by the processing system and suggested.

In some embodiments, the processing system may execute an AI model trained to recommend the adjustments to the launch schedule enhance. The AI model may be trained to identify and predict the lightning clusters and to determine the potential risk based on at least proximity of the lightning clusters to the launch site or launch trajectory. The AI model may be trained to simulate various scenarios, considering factors such as the movement and intensity of lightning clusters and the influence of changing atmospheric conditions. Alternative time slots for which the risk assessment does not indicate risk beyond the risk threshold may be identified as alternative launch windows. By providing probabilistic assessments of risk for each potential time slot, the processing system may deliver data-driven recommendations, enabling launch operators to make informed adjustments that minimize disruptions and prioritize safety.

In block 1014, the processing device may output a forecast of lightning activity and associated risks for predefined launch window. The output by the processing system may include details regarding existing or predicted lightning clusters, such as location, size, intensity, movement direction, etc. The output may also include an assessment of the risk that a launch may be affected by the lightning clusters, such as a rating of a lightning constraint, and alternative launch windows when identified in response to the risk assessment exceeding the risk thresholds. For example, the output may include the rating of the lightning constraint configured to indicate the severity of the risk, or likelihood that the launch may be affected without modification to the plans for the launch. The output may be formatted to enable a visual display, such as textually, graphicly, or a combination thereof or analytical assessment of the information therein. For example, the forecast of lightning activity may be configured to be displayed via the launch service platform (SLSP).

For example, the forecast of lightning activity data may include location, characteristics, risk of encroachment on a launch, etc. of one or more lightning events or lightning producing clouds. For another example, the forecast of lightning activity data may be configured to be graphically displayed in an organized manner for evaluation of the forecast of lightning activity data. For example, the forecast of lightning activity data may be organized in one or more Gantt charts to visualize how lightning constraints relate to a launch timeline. In some embodiments, the time interval data may be displayed as a constraint line showing a relationship between the time interval and the corresponding rating of associated lightning constraints.

In some embodiments, the forecast of lightning activity data may be output in a format to be stored as part of a data set configured for training the AI models used for lightning assessment. The forecast of lightning activity data report may be output to a memory of or accessible by the processing system.

In some embodiments, the processing system may be configured to track and predict collision hazard in orbital space to launches based on analysis of orbital object data within a dedicated distance from a launch trajectory. For example, the processing system may be configured to perform methods of avoiding collisions with orbital objects during a launch, which may include receiving orbital object data (including trajectories, velocities, and size of orbital objects), analyzing the received data to calculate collision probabilities along a predefined launch trajectory (or calculating collision probabilities at predefined trajectory points based on the received orbital object data), and outputting a collision avoidance recommendation based on the calculated probabilities.

In some embodiments, the method may include identifying trajectory segments with high collision probabilities based on a predefined risk threshold, generating the collision avoidance recommendation based on the identified trajectory segments to include trajectory adjustments or rescheduling. In some embodiments, the method may include dynamically updating collision probabilities using real-time orbital debris data ingested hourly on launch day. In some embodiments, generating the collision avoidance recommendation may include generating visual representations of high-risk trajectory segments and alternative paths. In some embodiments, the collision avoidance recommendation may include adjustments to the launch trajectory or rescheduling of the launch window. In some embodiments, the method may include generating a visual representation of orbital objects and their proximity to the predefined trajectory. In some embodiments, the orbital object data may be sourced from space agencies and commercial providers. In some embodiments, the method may include updating the orbital object data at a daily frequency during a pre-launch phase and an hourly frequency on the day of launch.

Method 1000 may improve the performance and functioning of the computing system by, for example, leveraging artificial intelligence and advanced data integration techniques to identify and mitigate lightning hazards during launch operations. By systematically collecting and processing lightning data-including real-time and historical data on lightning types, intensity, location, and associated atmospheric conditions-method 1000 enhances the system's situational awareness. The use of AI models trained on historical weather and lightning patterns allows for accurate predictions of lightning cluster formation, movement, and potential impacts on the launch site or trajectory. This predictive capability allows the system to dynamically assess risks and recommend actionable adjustments to the launch schedule or trajectory in real time. In addition, the method integrates diverse data sources, such as upper atmospheric measurements, electric field data, and cloud dynamics, to refine the accuracy of lightning risk assessments. These operations collectively reduce operational uncertainty, optimize launch planning, and improve safety and efficiency by ensuring informed decision-making based on adaptive, data-driven insights.

Some embodiments may include method that include receiving, from multiple data sources, lightning data and upper atmospheric data (in which the lightning data includes at least lightning type, intensity, geospatial location, and timestamp, and the upper atmospheric data includes Convective Available Potential Energy (CAPE), wind shear, water vapor density, and electric field mill measurements), tracking lightning clusters by identifying lightning events within a predefined radius surrounding a launch site based on the geospatial location and timestamp of each event, grouping lightning events into clusters using density-based clustering techniques, and classifying each cluster based on intensity, persistence, and spatial distribution, generating, by a deep learning model trained on historical weather data, a lightning hazard prediction model that outputs probabilities of new lightning cluster formation based on historical storm patterns and real-time upper atmospheric data, analyzing real-time atmospheric instability conditions by querying an LXM or applying a transformer-based neural network to refine lightning risk probabilities dynamically, and adjusting risk probabilities using real-time sensor data indicative of atmospheric instability, including CAPE and water vapor measurements, determining, by an LXM or a recurrent neural network trained on historical storm trajectories and wind shear data, the propagation velocity and projected path of each identified lightning cluster, generating, based on the lightning hazard prediction model and propagation paths, a real-time lightning risk forecast comprising risk probabilities and severity rankings for predefined zones surrounding the launch site, and recommending, in response to determining that a forecasted probability of lightning activity exceeds a predefined threshold, an adjustment to the launch schedule, the adjustment including at least one of delaying the launch or modifying the launch trajectory to avoid lightning-affected zones.

In some embodiments, the lightning data may be received from at least one of satellite-based weather monitoring systems, ground-based lightning detection networks, or radar installations. In some embodiments, the predefined radius surrounding the launch site may be dynamically adjusted based on storm movement patterns using an unsupervised clustering algorithm. In some embodiments, the deep learning model may include a generative adversarial network (GAN) trained to generate synthetic storm scenarios that simulate lightning-producing atmospheric conditions. In some embodiments, the atmospheric instability conditions may be analyzed using a reinforcement learning model that adjusts risk probabilities based on observed storm behavior and historical prediction accuracy. In some embodiments, the recommendation to adjust the launch schedule may be generated using a probabilistic graphical model that evaluates competing storm trajectory scenarios and selects the scenario with the highest forecast confidence.

Some embodiments may include generating a visual representation of the lightning risk forecast that includes color-coded zones indicating risk severity within the predefined radius, projected paths of lightning clusters, and timestamps associated with forecasted risk intervals. In some embodiments, the transformer-based neural network incorporates time-series anomaly detection to identify deviations from expected atmospheric trends. In some embodiments, the method my further include refining the lightning hazard prediction model by integrating Bayesian inference to adjust risk probabilities based on uncertainties in real-time meteorological inputs. In some embodiments, the recommendation to adjust the launch schedule may include an adaptive risk index quantifying the operational impact of projected lightning activity on launch operations.

FIG. 10B is a process flow diagram illustrating a method 1050 of predicting hazardous weather conditions near a launch site in accordance with some embodiments. Method 1050 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 1050 may include these processors, components, and subsystems. One or more processors within the processing system may be configured with software or firmware to perform some or all of the operations of method 1050.

In block 1052, the processing system may receive lightning data from multiple sources. The lightning data may include lightning type, intensity, timestamp, and geospatial location relative to the launch site. For example, the processing system may retrieve lightning strike information from satellite-based weather monitoring systems, ground-based lightning detection networks, and radar installations to provide comprehensive coverage of storm activity near the launch site.

In some embodiments, the processing system may apply a federated learning model to aggregate lightning data from multiple independent weather monitoring agencies. The processing system may train a distributed deep learning model on local datasets stored within separate meteorological organizations without requiring direct data exchange. For example, the processing system may synchronize model updates between commercial satellite providers, government weather bureaus, and private lightning detection networks to improve global lightning tracking accuracy.

In block 1054, the processing system may track lightning clusters within predefined concentric zones surrounding the launch site. For example, the processing system may extract geospatial coordinates, timestamps, strike intensity levels, and polarity classifications from received data, normalize these data points to maintain consistency across multiple sources, segment the monitored region into predefined concentric zones at X, Y, and Z nautical miles (e.g., 20, 50, and 80 nautical miles) from the launch site, execute a geospatial mapping algorithm to associate detected lightning strikes with specific zones, apply density-based clustering techniques to identify strike groupings within each region, and analyze cluster characteristics (e.g., strike frequency, persistence, spatial distribution, etc.) to determine the severity of lightning activity within each zone. Said another way, the processing system may classify each lightning cluster based on intensity, duration, and recurrence patterns, divide the monitoring area into zones at X, Y, and Z nautical miles from the launch site, and categorize lightning activity based on frequency and severity of strikes occurring in each zone.

In some embodiments, the processing system may integrate an unsupervised clustering algorithm to dynamically adjust the predefined monitoring zones. The processing system may evaluate real-time strike distributions and create adaptive hazard zones that adjust based on observed storm movement patterns. For example, the processing system may shift zone boundaries outward if lightning clusters consistently propagate beyond the predefined distances, refining hazard detection accuracy.

In block 1056, the processing system may generate a lightning hazard prediction model using a deep learning model trained on historical weather data. The deep learning model may predict the probability of new lightning clusters forming based on atmospheric conditions and historical storm patterns. For example, the processing system may analyze past launch site weather records, including convective storm formation data, to identify trends in lightning activity correlated with specific meteorological conditions.

In some embodiments, the processing system may apply a generative adversarial network (GAN) to generate synthetic storm scenarios that simulate the formation of lightning-producing atmospheric conditions. The processing system may train the GAN using historical meteorological data and observed storm developments. For example, the processing system may create synthetic convective storm events and compare them against real-time sensor readings to enhance predictive accuracy in scenarios where limited observational data exists.

In block 1058, the processing system may analyze real-time upper atmospheric data. The upper atmospheric data may include Convective Available Potential Energy (CAPE), wind shear, and water vapor density. The processing system may apply a transformer-based neural network configured to refine lightning risk probabilities dynamically. For example, the processing system may adjust the predicted risk of lightning activity by incorporating real-time data from meteorological sensors detecting rapid shifts in atmospheric instability.

In some embodiments, the processing system may integrate a reinforcement learning model to refine trajectory-based lightning risk predictions. The reinforcement learning model may continuously update its risk assessment strategy based on observed storm evolutions and past prediction accuracy. For example, the processing system may adjust weight factors applied to CAPE and wind shear data based on their correlation with past lightning events, improving real-time hazard forecasting.

In block 1060, the processing system may output a real-time lightning risk forecast indicating the probability and severity of lightning activity within a predefined launch window based on the lightning hazard prediction model. The processing system may generate a structured forecast including probability metrics and severity rankings for each monitored zone. For example, the processing system may provide a color-coded risk assessment detailing expected lightning activity within each predefined concentric zone surrounding the launch site.

In some embodiments, the processing system may apply a time-series anomaly detection algorithm to identify deviations from expected storm behaviors within the monitored region. The processing system may compare real-time atmospheric trends with historical weather patterns and assess whether current storm conditions align with or deviate from past lightning-producing systems. For example, the processing system may issue a confidence-adjusted warning if observed storm activity exhibits characteristics inconsistent with past lightning-producing systems but remains within a threshold of potential hazard.

In block 1062, the processing system may identify lightning clusters using a graph-based clustering algorithm. The processing system may construct a weighted graph representing lightning event proximity, frequency, and severity. For example, the processing system may analyze lightning strike locations over time and classify clusters based on their movement trends and recurrence probability.

In some embodiments, the processing system may integrate a self-organizing map (SOM) neural network to detect nonlinear patterns in lightning cluster movement. The self-organizing map may analyze multidimensional storm attributes, including humidity, CAPE, and cloud temperature, to classify lightning clusters into evolving risk categories. For example, the processing system may use the SOM neural network to separate transient storm cells from long-duration convective systems affecting launch schedules.

In block 1064, the processing system may determine the propagation velocity and projected path of lightning clusters using a recurrent neural network (RNN) trained on historical storm trajectories, upper-atmosphere wind shear data, and convective weather indices. For example, the processing system may forecast whether an existing lightning cluster is likely to drift into the predefined launch zones by analyzing past storm movement patterns.

In some embodiments, the processing system may apply an attention-based long short-term memory (LSTM) model to enhance lightning cluster movement predictions. The LSTM model may focus on recent high-impact storm movement trends and assign greater importance to the most relevant atmospheric parameters contributing to cluster propagation. For example, the processing system may weigh the influence of increasing wind shear more heavily than decreasing CAPE when forecasting the trajectory of a developing storm system.

In block 1066, the processing system may classify each lightning cluster based on impact severity using an attention-based artificial intelligence model. The attention-based artificial intelligence model may prioritize lightning events near high-risk areas, including launch pad infrastructure and vehicle assembly buildings. For example, the processing system may assign higher risk scores to lightning clusters detected near critical launch site components to ensure mission safety considerations.

In some embodiments, the processing system may integrate a convolutional graph neural network (GNN) to refine the classification of lightning cluster severity. The convolutional GNN may process spatial relationships between multiple storm cells and classify interdependent risk factors influencing launch safety. For example, the processing system may classify simultaneous lightning clusters occurring at multiple altitude layers as a higher-risk event than an isolated surface-level cluster.

In block 1068, the processing system may recommend an adjustment to the launch schedule in response to determining that the forecasted probability of lightning activity within a specified time interval exceeds a predefined safety threshold. The processing system may generate launch schedule recommendations considering real-time weather forecasts and historical storm patterns. For example, the processing system may suggest delaying a launch by a predetermined duration to allow a passing storm cell to clear the launch site.

In some embodiments, the processing system may integrate a probabilistic graphical model to optimize dynamic launch schedule adjustments. The processing system may apply Bayesian inference techniques to evaluate competing storm trajectory models and select the most probable forecast scenario influencing launch timing decisions. For example, the processing system may weigh alternative weather models predicting different lightning risk levels and recommend a delay only when confidence in an adverse forecast exceeds a predetermined threshold.

In block 1070, the processing system may dynamically update the probability of lightning formation using a GAN trained on seasonal weather patterns. The processing system may apply the GAN to generate simulated weather conditions when real-time data is incomplete. For example, the processing system may generate synthetic atmospheric conditions matching previously observed lightning-producing weather systems to estimate the likelihood of future lightning strikes.

In some embodiments, the processing system may apply a Bayesian inference model to refine the GAN-generated probability estimates. The Bayesian inference model may analyze uncertainties in real-time meteorological inputs and adjust the generated probability distribution based on available sensor readings. For example, the processing system may apply probabilistic weighting to competing forecast models and prioritize the highest-confidence scenario when estimating the likelihood of lightning formation.

In block 1072, the processing system may refine the predicted lightning hazard probability using a reinforcement learning model. The reinforcement learning model may optimize launch window selection based on prior lightning risk assessments and observed storm behavior. For example, the processing system may prioritize launch windows with historically low lightning probabilities based on previous mission data.

In some embodiments, the processing system may apply an actor-critic reinforcement learning architecture to balance short-term and long-term decision-making in launch scheduling. The processing system may train an agent to evaluate multiple launch windows and assign reward values based on minimized risk exposure. For example, the processing system may select a launch window that balances operational constraints with predicted lightning hazard reductions, ensuring optimal scheduling under dynamic atmospheric conditions.

In block 1074, the processing system may integrate radar reflectivity and Doppler velocity data from weather surveillance radars. The processing system may apply a CNN trained on radar imaging data to classify storm structures associated with lightning formation. For example, the processing system may identify supercell thunderstorms by analyzing radar reflectivity patterns and wind velocities.

In some embodiments, the processing system may apply a hybrid CNN and RNN model to classify storm progression over time. The processing system may combine spatial feature extraction from radar data with sequential storm movement analysis to enhance classification accuracy. For example, the processing system may predict whether an evolving convective cell will escalate into a severe thunderstorm by correlating its growth trajectory with archived storm evolution patterns.

In block 1076, the processing system may detect precursor conditions to lightning strikes using a deep reinforcement learning model. The deep reinforcement learning model may process electric field mill data, thermodynamic profiles, and storm evolution metrics to identify atmospheric instability leading to lightning formation. For example, the processing system may compare real-time electric field readings with historical pre-lightning storm patterns to generate early warnings.

In some embodiments, the processing system may apply a self-supervised learning framework to detect anomalies in precursor lightning conditions. The processing system may train a predictive model on labeled datasets of pre-lightning events and apply contrastive learning techniques to distinguish between normal atmospheric fluctuations and storm conditions preceding lightning formation. For example, the processing system may compare rapid shifts in thermodynamic instability against known lightning initiation sequences to refine strike probability estimates.

In block 1078, the processing system may correlate predicted lightning hazards with previous launch delays and mission outcomes to generate an adaptive risk index. The adaptive risk index may quantify the operational impact of projected lightning activity. For example, the processing system may adjust the launch window risk assessment dynamically based on historical mission interruptions caused by lightning activity.

In some embodiments, the processing system may apply a causal inference model to distinguish between direct and indirect effects of lightning activity on mission delays. The processing system may train a counterfactual reasoning model to analyze how alternative weather conditions might have influenced past mission outcomes. For example, the processing system may compare launch scenarios where lightning events occurred versus hypothetical cases in which similar meteorological conditions did not result in disruptions to refine the adaptive risk index.

These methods may improve the performance and functioning of the computing system by, for example, integrating real-time meteorological data, machine learning models, and predictive analytics to enhance lightning hazard forecasting near a launch site. The method processes lightning data from multiple sources, normalizes it into structured datasets, and applies AI-driven clustering techniques to track lightning clusters dynamically. By leveraging deep learning models trained on historical weather patterns, the system may generate probabilistic forecasts of new lightning formation and refine these predictions using real-time atmospheric data, such as CAPE, wind shear, and electric field mill measurements. These methods may further enhance computational efficiency by employing LXMs or transformer-based neural networks to adjust risk probabilities in real time, reducing unnecessary processing and focusing computational resources on high-risk scenarios. In addition, recurrent neural networks improve the accuracy of storm propagation forecasting, allowing mission planners to make data-driven adjustments to launch schedules based on reliable risk assessments. By automating these complex analyses and integrating reinforcement learning for continuous model refinement, the system may significantly enhance its ability to predict hazardous weather conditions, reducing false alerts and improving launch decision-making. The adaptive risk framework allows for real-time visualization of lightning hazards so that the computing system functions with greater efficiency, responsiveness, and predictive accuracy in launch operations.

Some embodiments may include methods for identifying orbital object hazards and generating collision avoidance recommendations for a launch trajectory, which may include receiving orbital object data from one or more data sources (in which the orbital object data includes object trajectories, velocities, object sizes, timestamps, and covariance matrices), analyzing the received orbital object data to compute collision probabilities along a predefined launch trajectory by applying a hybrid artificial intelligence model, the hybrid artificial intelligence model incorporating Bayesian inference for uncertainty quantification, a graph neural network for trajectory intersection assessment, and Monte Carlo simulations for modeling trajectory variations due to space weather effects, identifying high-risk trajectory segments by comparing computed collision probabilities against a predefined risk threshold (in which high-risk trajectory segments include trajectory points exceeding an operational safety limit), generating a collision avoidance recommendation based on the identified high-risk trajectory segments, the collision avoidance recommendation including at least one trajectory modification selected using a reinforcement learning model trained to evaluate multiple avoidance strategies, and an evolutionary algorithm that iteratively refines trajectory modifications through real-time simulations, generating a three-dimensional visualization of orbital objects and their proximity to the predefined launch trajectory, the visualization including dynamically updated risk zones, and outputting the collision avoidance recommendation to a mission control system that implements the trajectory modification by transmitting trajectory adjustment commands to an onboard guidance system.

In some embodiments, the orbital object data may be received from a plurality of sources, the plurality of sources including government-operated space surveillance networks, commercial satellite tracking systems, radar installations, optical tracking systems, and onboard satellite telemetry systems. In some embodiments, analyzing the received orbital object data may include applying extended Kalman filtering to refine positional estimates of orbital objects, and propagating covariance matrices to account for uncertainty in orbital predictions. In some embodiments, the Monte Carlo simulations may incorporate space weather conditions, including atmospheric drag, solar radiation pressure, and magnetic field disturbances. In some embodiments, the identifying of high-risk trajectory segments includes classifying trajectory points into risk categories based on computed collision probabilities, the risk categories including low-risk, medium-risk, and high-risk segments. In some embodiments, the reinforcement learning model may enhance trajectory modifications by balancing fuel efficiency constraints with collision risk reduction and selecting an avoidance strategy that reduces exposure to high-risk orbital object regions.

In some embodiments, the three-dimensional visualization may include a dynamically updated orbital debris map, color-coded collision probability zones, and interactive trajectory adjustment simulations. In some embodiments, the mission control system may transmit trajectory adjustment commands based on real-time updates from space surveillance telemetry, orbital debris tracking sensors, and space weather monitoring stations. In some embodiments, analyzing the received orbital object data may include executing an anomaly detection model trained on historical conjunction data to classify trajectory segments as high-risk if they intersect predicted paths of debris objects moving at high relative velocities. In some embodiments, the generating of the collision avoidance recommendation may include applying deterministic and probabilistic decision frameworks to adapt trajectory adjustments based on real-time space environment conditions.

In some embodiments, the reinforcement learning model may continuously refine trajectory modifications by incorporating historical launch data into training datasets, adjusting decision thresholds based on past avoidance effectiveness, and retraining avoidance models using adversarial reinforcement learning techniques. In some embodiments, the mission control system may store risk assessments and executed trajectory modifications for post-mission analysis and use stored data to improve AI-driven risk identification for future launch operations. In some embodiments, the method may further include overlaying debris contours onto a hazard surveillance module, the debris contours dynamically updating to reflect real-time space debris movements. In some embodiments, the method may further include integrating a predictive analytics engine to forecast orbital conjunction events beyond real-time tracking constraints. In some embodiments, the method may further include retraining AI models periodically using updated orbital object datasets from space agencies, private operators, and onboard telemetry systems.

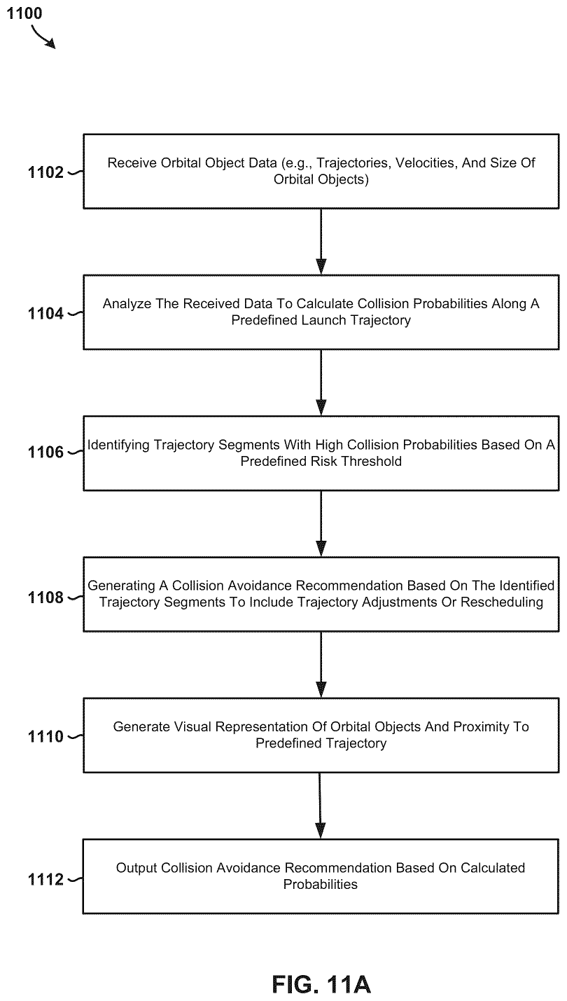

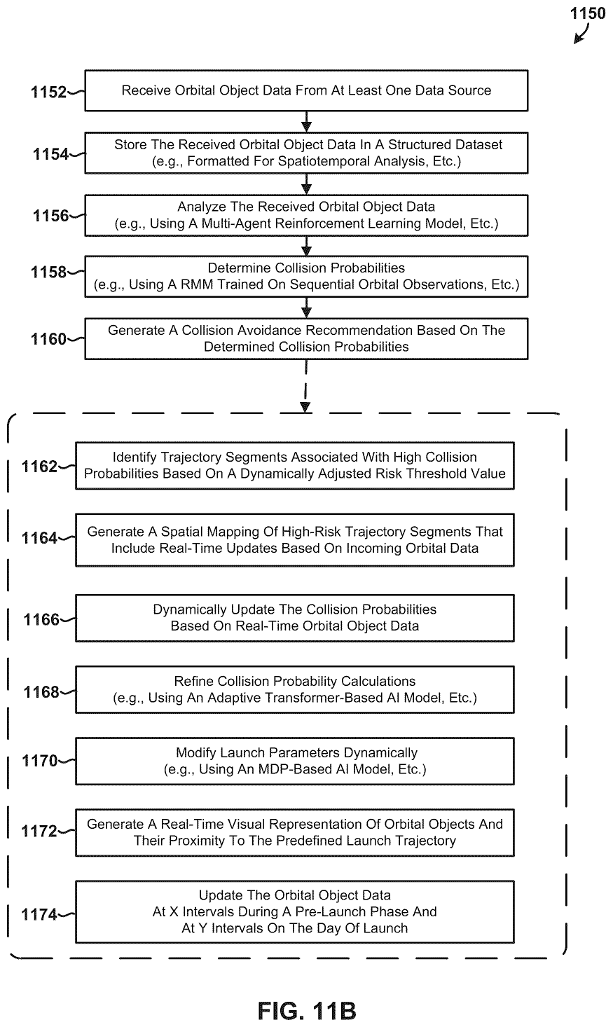

FIG. 11A is a process flow diagram illustrating a method 1100 of using artificial intelligence to identify orbital object hazards in accordance with some embodiments. Method 1100 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 1100 may include these processors, components, and subsystems. One or more processors within the processing system may be configured with software or firmware to perform some or all of the operations of method 1100.

In block 1102, the processing system may receive orbital object data, including trajectories, velocities, object sizes, and covariance information. The processing system may collect this data from multiple sources, such as government-operated space surveillance networks and commercial satellite tracking systems. For example, the processing system may access real-time telemetry from the U.S. Space Surveillance Network (SSN) and commercial providers. In some embodiments, the processing system may incorporate update frequency variations and latency correction mechanisms to maintain synchronization across sources.

In some embodiments, the processing system may aggregate data from multiple sources, including radar installations, optical tracking systems, and satellite sensors, to allow for comprehensive coverage of orbital object activities. For example, the processing system may fuse data streams from ground-based radar, satellite telemetry feeds, and infrared sensors to create a unified dataset. The dataset may include covariance matrices to quantify positional uncertainties in orbital predictions. The processing system may apply filtering techniques, such as extended Kalman filtering, to propagate and refine uncertainty estimates.

The processing system may receive orbital object data by directly integrating with onboard satellite systems equipped with advanced radar and telemetry sensors. The processing system may extract data from CubeSats or other satellite constellations that provide near-real-time updates on orbital debris and object trajectories. The processing system may integrate predictive modeling techniques to account for potential delays in telemetry updates.

In some embodiments, the processing system may receive historical and real-time orbital object data. Orbital object data may include trajectories, timestamps, velocities, sizes, ephemerides with covariance information, and other relevant parameters for satellites, the International Space Station (ISS), analyst objects, and orbital debris. The processing system may retrieve historical data from stored databases, such as the United States Space Command (USSPACECOM) General Catalog of Space Objects, the NASA Orbital Debris Program Office Database, the ESA DISCOS database, and commercial sources. The processing system may also incorporate real-time data from government and commercial sources, applying interpolation techniques to address inconsistencies in update frequencies.

In block 1104, the processing system may analyze the received orbital object data to calculate collision probabilities along a predefined launch trajectory. For example, the processing system may execute a hybrid AI model incorporating Bayesian inference for uncertainty quantification and a graph neural network for trajectory intersection assessment. The processing system may apply covariance propagation techniques to improve positional accuracy in long-term predictions. To enhance real-time collision probability assessment, the processing system may integrate a Monte Carlo simulation framework that models trajectory variations under space weather conditions, including atmospheric drag and solar radiation effects, using standard models such as JB2008.

In some embodiments, in block 1104, the processing system may overlay debris contours onto the Hazard Surveillance module. By mapping potential debris fields and integrating real-time tracking data, the system may dynamically adjust the contours to reflect the current state of space debris. These contours may be superimposed onto the hazard areas, ensuring that mission control is aware of potential collision zones caused by space debris during launch operations.

The processing system may segment the launch trajectory into risk levels using a clustering algorithm. For example, the processing system may classify trajectory points into low-risk, medium-risk, and high-risk zones based on computed collision probabilities. The processing system may execute an anomaly detection model trained on historical conjunction data to classify trajectory segments as high-risk if they intersect the predicted paths of debris objects moving at high relative velocities. The processing system may update classification thresholds dynamically based on real-time telemetry.

In block 1106, the processing system may identify trajectory segments with high collision probabilities based on a predefined risk threshold. For example, the processing system may compare the computed collision probabilities for each segment against a risk threshold defined by operational safety standards. Segments exceeding the threshold may be flagged as high-risk, triggering further analysis or mitigation actions. The processing system may prioritize high-risk segments for closer inspection, such as adjusting the launch window or altering the trajectory to avoid collision with detected orbital objects. The system may also assess the potential impact of environmental factors, such as space weather, on collision risk, adjusting the trajectory accordingly to maintain safe operational conditions.

In block 1108, the processing system may generate a collision avoidance recommendation based on the identified high-risk trajectory segments. The processing system may execute a reinforcement learning model that evaluates multiple avoidance strategies and selects a trajectory modification that optimizes mission parameters, such as fuel efficiency and launch timing constraints. The processing system may refine trajectory adjustments using an evolutionary algorithm that iteratively evaluates modification effectiveness through real-time simulations. The processing system may incorporate deterministic and probabilistic decision frameworks to ensure adaptability to uncertain space environment conditions.

In block 1110, the processing system may generate a visual representation of orbital objects and their proximity to the predefined trajectory. The processing system may create a three-dimensional trajectory map that overlays real-time orbital object positions and collision probabilities. The visualization may include dynamically updated color-coded risk zones, allowing mission planners to assess risks in real time. The processing system may enhance the visualization with interactive features, such as real-time trajectory simulations that allow planners to modify trajectory parameters and immediately observe updated risk assessments. The visualization may integrate predictive analytics to forecast potential trajectory conflicts beyond real-time constraints.

In block 1112, the processing system may output the collision avoidance recommendation through a decision-support interface. The processing system may integrate the recommendation directly into mission control systems for automated execution, transmitting trajectory adjustment commands to onboard guidance and navigation systems. The processing system may ensure trajectory adjustments maintain compliance with operational constraints by continuously monitoring execution parameters and updating risk assessments dynamically.

FIG. 11B is a process flow diagram illustrating a method 1150 avoiding collisions with orbital objects during a launch in accordance with some embodiments. Method 1150 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 1150 may include these processors, components, and subsystems. One or more processors within the processing system may be configured with software or firmware to perform some or all of the operations of method 1150.

In block 1152, the processing system may receive orbital object data from at least one data source. The orbital object data may include trajectory information, velocity parameters, positional uncertainties, ephemerides, covariance matrices, and object classifications. For example, the processing system may retrieve real-time orbital tracking data from government-operated space surveillance networks, commercial space tracking providers, or onboard satellite telemetry systems. The processing system may integrate observations from multiple sources, including the SSN, the ESA Space Debris Office, and private sector orbital tracking services.

In some embodiments, the processing system may receive the orbital object data using a distributed sensor fusion model that integrates observations from multiple ground-based and space-based tracking stations. For example, the processing system may process time-synchronized data from ground-based phased-array radar stations, space-based optical telescopes, and inter-satellite tracking relays. The processing system may execute Kalman filtering and Bayesian state estimation techniques to reduce observational noise and refine positional estimates.

In block 1154, the processing system may store the received orbital object data in a structured dataset formatted for spatiotemporal analysis. The processing system may organize the structured dataset into a multi-dimensional vector to allow for efficient orbital conjunction calculations and risk quantification. For example, the processing system may apply vectorized indexing and time-series partitioning techniques to structure the dataset for rapid retrieval of trajectory history and future projections.

In some embodiments, the processing system may store the orbital object data in a knowledge graph representation in which each orbital object is a node connected to other nodes representing previous observations, predicted trajectories, and orbital event probabilities. For example, the processing system may use a graph database configured for spatiotemporal queries to rapidly infer relationships between objects that exhibit correlated movement patterns or trajectory anomalies.

In block 1156, the processing system may analyze the received orbital object data using a multi-agent reinforcement learning model trained to predict orbital conjunction risks. The multi-agent model may simulate object trajectories under variable space weather conditions and dynamic force perturbations. For example, the processing system may model the effects of gravitational perturbations, atmospheric drag fluctuations, solar radiation pressure, and third-body influences to refine risk predictions.

In some embodiments, the processing system may analyze orbital conjunction risks using a probabilistic graphical model trained on historical conjunction events. For example, the processing system may construct a Bayesian network where nodes represent potential conjunction events, and edges encode probabilistic dependencies between orbital parameters, allowing for real-time inference of collision likelihoods.

In block 1158, the processing system may determine collision probabilities along a predefined launch trajectory using a hybrid artificial intelligence model. The hybrid model may include a Bayesian inference model configured to estimate uncertainty in orbital predictions and a graph neural network (GNN) trained on historical conjunction data to detect high-risk trajectory intersections. For example, the processing system may use the Bayesian inference model to quantify trajectory uncertainty due to limited observational data and the graph neural network to detect spatial-temporal patterns in prior conjunction events.

In some embodiments, the processing system may determine collision probabilities using a long short-term memory (LSTM) recurrent neural network trained on sequential orbital observations. For example, the processing system may apply time-series modeling techniques to predict object motion based on prior trajectory deviations and dynamic orbital adjustments.

In block 1160, the processing system may generate a collision avoidance recommendation based on the determined collision probabilities. The recommendation may include trajectory modifications, launch rescheduling options, or dynamic maneuver planning. For example, the processing system may adjust launch azimuth parameters or pre-launch trajectory refinement models to reduce proximity to high-risk conjunction zones.

In some embodiments, the processing system may generate a collision avoidance recommendation using a deep reinforcement learning model trained to evaluate multiple avoidance strategies. For example, the processing system may simulate potential trajectory modifications and apply a reward-based optimization function to select the trajectory adjustment that minimizes conjunction risk while maintaining launch constraints.

In block 1162, the processing system may identify trajectory segments associated with high collision probabilities based on a dynamically adjusted risk threshold. The risk threshold may be modified by an anomaly detection model trained on historical conjunction events. For example, the processing system may classify high-risk segments by detecting deviations in predicted orbital paths compared to expected motion patterns.

In some embodiments, the processing system may identify high-risk trajectory segments using a density-based clustering algorithm trained on historical orbital conjunction data. For example, the processing system may apply a DBSCAN (Density-Based Spatial Clustering of Applications with Noise) algorithm to locate orbital regions where conjunction probability exceeds predefined safety margins.

In block 1164, the processing system may generate a three-dimensional spatial mapping of high-risk trajectory segments. The mapping may include real-time updates based on incoming orbital data. For example, the processing system may visualize trajectory intersections using a dynamic risk heatmap where color intensity corresponds to estimated conjunction probability.

In some embodiments, the processing system may generate a multi-layered visualization where orbital trajectories are represented as nodes in a graph, and conjunction risks are encoded as edge weights. For example, the processing system may use force-directed graph rendering techniques to dynamically adjust the visual representation as new orbital data becomes available.

In block 1166, the processing system may update collision probabilities dynamically using real-time orbital object data ingested from space surveillance networks, commercial tracking providers, and ground-based radar stations. For example, the processing system may integrate continuous orbital state updates to refine collision probability assessments throughout the pre-launch phase.

In some embodiments, the processing system may update collision probabilities using an unsupervised learning model that continuously adapts to newly observed orbital behaviors. For example, the processing system may train a self-organizing map (SOM) model to detect emerging movement patterns and adjust conjunction risk calculations.

In block 1168, the processing system may refine collision probability calculations using an adaptive transformer-based artificial intelligence model. The transformer model may process historical trajectory deviations and predict object movement based on time-series data. For example, the processing system may use self-attention mechanisms to assess the influence of past deviations on future conjunction events.

In some embodiments, the processing system may refine collision probability calculations using a convolutional neural network (CNN) trained to extract spatial features from orbital trajectory sequences. For example, the processing system may apply a one-dimensional convolutional network to detect patterns indicative of high-risk conjunctions.

In block 1170, the processing system may modify launch parameters dynamically using a Markov decision process (MDP)-based artificial intelligence model. The MDP model may evaluate multiple launch windows and trajectory configurations to reduce conjunction risks. For example, the processing system may apply a decision-theoretic framework to iteratively select the launch configuration that maximizes safe transit through orbital space.

In block 1172, the processing system may generate a real-time visual representation of orbital objects and their proximity to the predefined launch trajectory. The processing system may overlay predicted conjunction paths onto an interactive three-dimensional spatial mapping of the launch trajectory, supporting real-time decision-making for launch operations.

FIG. 12A is a process flow diagram illustrating a method 1200 of managing logistics markers of multiple stakeholders to improve launch operations in accordance with some embodiments. Method 1200 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 1200 may include these processors, components, and subsystems. One or more processors within the processing system may be configured with software or firmware to perform some or all of the operations of method 1200.

In block 1202, the processing system may receive inputs from multiple stakeholders, including task statuses and constraints. The processing system may collect structured and unstructured data from human operators, automated task management systems, and real-time telemetry feeds. For example, the processing system may extract completion percentages from operational logs, correlate extracted data with live progress indicators from remote tracking sensors, and process real-time personnel status reports from spaceport ground operations teams.

In some embodiments, the processing system may collect stakeholder inputs using a natural language processing (NLP) model or a large-scale transformer model (LXM) trained to interpret textual and verbal reports from mission operators. The processing system may apply a knowledge extraction model to identify important dependencies, unresolved tasks, and operational constraints. For example, the processing system may analyze crew communications and compare reported progress with recorded task completion data to detect scheduling discrepancies. The processing system may also extract high-priority operational bottlenecks from structured reports submitted by launch vehicle integration teams.

In block 1204, the processing system may track task completion and identify delays relative to a predefined TO launch time. The processing system may query an XLM or apply a predictive AI model trained on historical launch data to anticipate delays before they occur. The predictive AI model may execute a sequence-based transformer neural network that detects deviations in task execution patterns. For example, the processing system may predict a fueling operation delay based on prior deviations in fuel delivery schedules and generate an alert for mission control to initiate contingency planning.

In some embodiments, the processing system may implement a federated learning framework that aggregates real-time progress data from distributed teams while preserving data privacy. The processing system may infer potential bottlenecks by comparing current completion rates with historical execution curves under similar conditions. For example, the processing system may detect a deviation in ground support equipment readiness timelines compared to historical launch operations and notify mission planners of potential delays affecting payload integration and vehicle rollout schedules.

In block 1206, the processing system may monitor real-time constraints, including weather conditions, hazard data, and orbital objects. The processing system may query an XLM or apply a multi-modal AI model that fuses meteorological forecasts, maritime vessel tracking, and space object monitoring. The processing system may query an XLM or execute a generative adversarial network (GAN) to simulate worst-case launch-day scenarios based on real-time weather data and historical launch disruptions. For example, the processing system may analyze high-risk atmospheric conditions, compare them with prior launch anomalies, and assess the likelihood of a weather-related delay.

In some embodiments, the processing system may use a Bayesian deep learning model that quantifies uncertainty in environmental constraints and dynamically adjusts constraint weighting in launch scheduling models. The processing system may integrate probabilistic orbital conjunction forecasting with reinforcement learning to recommend real-time launch schedule adaptations. For example, the processing system may analyze historical orbital conjunction trends and real-time tracking data from space surveillance networks to determine that a recently detected satellite maneuver has introduced a higher-than-expected conjunction risk along the planned ascent trajectory. Based on this assessment, the processing system may increase the constraint weighting for orbital conjunction risks and recommend adjusting the launch window to avoid potential conflicts with the updated satellite position. As another example, the processing system may analyze historical correlations between upper-level wind shear and launch vehicle stability and determine that forecasted wind conditions exceed safe operating thresholds. Based on this assessment, the processing system may adjust the constraint weighting for wind shear within the launch scheduling model and recommend delaying the launch to a later window when wind conditions are projected to stabilize.

In block 1208, the processing system may identify an updated launch window based on received inputs and monitored constraints. The processing system may execute a reinforcement learning-based AI model that refines launch scheduling predictions based on past mission outcomes and evolving constraints. The processing system may analyze patterns in historical launch successes and select an optimized launch window. For example, the processing system may recommend a launch window that aligns with historical mission success under similar airspace congestion and meteorological conditions.

In some embodiments, the processing system may may query an XLM or implement an attention-based AI model that ranks available launch windows based on mission priority, airspace restrictions, and weather confidence intervals. The processing system may apply an inverse reinforcement learning technique that learns optimal scheduling decisions by analyzing expert decision-making patterns. For example, the processing system may prioritize a launch window that reduces regulatory conflicts and increases the probability of mission success by avoiding high-density aviation corridors.

In block 1210, the processing system may output an updated launch schedule that aligns with the identified launch window. The processing system may generate a confidence-weighted launch schedule that incorporates AI-derived risk assessments and scheduling flexibility constraints. The processing system may present a probabilistic decision matrix ranking different launch windows based on operational risk factors. For example, the processing system may classify launch windows based on expected airspace availability, predicted weather stability, and real-time marine traffic conditions.

In some embodiments, the processing system may generate an interactive scheduling dashboard that visualizes the interdependences among pre-launch activities, constraints, and alternative launch windows. The processing system may provide real-time what-if analysis capabilities, allowing mission planners to evaluate the impact of delaying or accelerating specific tasks. For example, the processing system may present an adaptive risk map that highlights the trade-offs between different launch windows based on evolving meteorological models and air traffic congestion data.

In block 1212, the processing system may notify stakeholders of the updated schedule and associated adjustments. The processing system may generate structured reports and real-time alerts for distribution to mission planners, ground control teams, and regulatory agencies. For example, the processing system may send automated notifications to air traffic control and maritime authorities, updating them on projected launch windows and any necessary airspace or sea-lane restrictions.

FIG. 12B is a process flow diagram illustrating a method 1250 of dynamically adjusting an operational schedule in accordance with some embodiments. Method 1250 may be performed in a computing device (e.g., LOD computing system 204, LODSS 250, etc.) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 1250 may include these processors, components, and subsystems. One or more processors within the processing system may be configured with software or firmware to perform some or all of the operations of method 1250.

In block 1252, the processing system may receive input data from multiple sources. For example, the processing system may collect task statuses, operational constraints, and real-time telemetry feeds from sensors, automated task management systems, and regulatory platforms. The processing system may retrieve mission-critical operational updates from distributed databases that aggregate historical and real-time data streams. For example, the processing system may synchronize air traffic clearance logs, maritime vessel traffic updates, and orbital object tracking data to generate a comprehensive dataset for schedule analysis. In some embodiments, receiving input data from multiple sources in block 1252 may include collecting environmental data, launch pad activity metrics, regulatory notices, and real-time mission control directives.

In block 1254, the processing system may analyze the received input data to determine scheduling dependencies, task progress, and delays. For example, the processing system may query an LXM or apply a sequence-based machine learning model trained on historical launch task completion records to identify dependencies between sequential and parallel operations. The processing system may detect scheduling risks by correlating real-time launch preparations with expected completion timelines. In some embodiments, the processing system may query an LXM-based AI model or execute a probabilistic scheduling risk model to forecast disruptions in pre-launch activities. For example, the processing system may predict a delay in launch vehicle rollout to the pad based on deviations in fuel system checkout timelines or anomalies in ground support equipment deployment logs.

In block 1256, the processing system may monitor real-time constraints, including environmental conditions, operational limitations, and regulatory restrictions across air, maritime, and orbital domains. The processing system may integrate air traffic management alerts, space situational awareness reports, and maritime hazard notices into a unified constraint-monitoring system. For example, the processing system may analyze restricted airspace notices from the FAA, marine vessel proximity warnings from AIS feeds, and orbital conjunction risk reports from the SSN to assess potential conflicts with scheduled launch operations. In some embodiments, the processing system may query an LXM or execute an AI-driven decision-support model to assess how evolving multi-domain constraints affect the operational schedule. For example, the processing system may detect a newly launched satellite drifting toward the planned ascent corridor and recommend schedule adjustments to reduce potential risk exposure.

In block 1258, the processing system may generate an updated operational schedule based on the analyzed input data and monitored constraints. The processing system may modify task sequences, reallocate personnel assignments, and adjust resource distribution to mitigate scheduling conflicts. For example, the processing system may reschedule pre-launch hazard area activation, optimize pad crew rotations, and adjust fueling sequences in response to real-time operational constraints. In some embodiments, the processing system may execute a constraint-based scheduling optimization model that prioritizes launch-critical operations and reduces mission delays. For example, the processing system may determine an optimal sequencing strategy for fuel loading, avionics system checks, and launch pad evacuation based on available airspace clearance windows and identified orbital conjunction risks.

In some embodiments, generating the updated operational schedule in block 1258 may include applying an optimization algorithm that evaluates alternative scheduling scenarios based on predefined performance metrics and regulatory constraints. The processing system may simulate multiple operational adjustments and select the most effective configuration for maintaining launch readiness. For example, the processing system may compare alternative task sequencing strategies for payload integration, telemetry system validation, and flight termination system activation to reduce pre-launch time compression risks. In some embodiments, generating the updated operational schedule may include multi-domain trajectory analysis, in which the processing system optimizes scheduling decisions based on projected orbital conjunction risks, restricted airspace notices, and maritime navigation advisories. For example, the processing system may compare projected spacecraft ascent paths with updated NOTAMs and maritime hazard zones to recommend a launch window that avoids potential conflicts with ongoing flight operations or sea-based recovery efforts.

In block 1260, the processing system may output the updated operational schedule for stakeholder review. The processing system may generate structured reports detailing the revised task timeline, identified constraints, and potential risks. In some embodiments, the processing system may present the updated schedule through an interactive visualization platform that allows stakeholders to review projected timelines and conflict resolution strategies. For example, the processing system may generate a mission control dashboard displaying real-time task dependencies, regulatory constraints, and alternative launch window options. In some embodiments, outputting the updated operational schedule in block 1260 may include transmitting schedule updates to stakeholders through a secure communication platform that delivers role-specific notifications and operational briefings.

In some embodiments, the processing system may generate customized alerts based on stakeholder roles and operational priorities. For example, the processing system may notify mission controllers about high-priority schedule modifications, while providing engineers with detailed adjustments to task dependencies. The processing system may generate real-time alerts for air traffic control authorities and maritime coordination centers so that updated launch clearance windows align with external regulatory approvals.

FIG. 13A is a process flow diagram illustrating a method 1300 of managing logistics markers of multiple stakeholders to improve launch operations in accordance with some embodiments. Method 1300 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 1300 may include these processors, components, and subsystems. One or more processors within the processing system may be configured with software or firmware to perform some or all of the operations of method 1300.

In block 1302, the processing system may define a set of rules governing launch operations. These rules may specify scheduling constraints and dependencies among critical events, including airspace clearance, maritime zone restrictions, orbital conjunction assessments, and environmental conditions. For example, the processing system may define a rule requiring real-time verification of no-fly zones, maritime exclusion areas, and active orbital debris alerts before launch vehicle rollout. The processing system may cross-reference regulatory restrictions from the FAA, the U.S. Coast Guard (USCG), and space surveillance agencies to ensure compliance with mission safety protocols. In some embodiments, the processing system may query an LXM or use an AI-powered constraint-satisfaction model trained on historical launch operations. For example, the processing system may dynamically refine dependency rules based on past launch cases in which fueling operations or launch pad readiness was delayed due to evolving air traffic congestion or unplanned space object conjunctions. These refinements may allow the processing system to adapt regulatory and operational rules in real time to mitigate delays while maintaining compliance with mission safety criteria.

In block 1304, the processing system may monitor a plurality of events associated with launch preparation activities. The processing system may integrate real-time data feeds, including orbital object tracking, air traffic positions, maritime vessel navigation, and environmental monitoring. For example, the processing system may monitor nearby aircraft approaching the launch zone, compare their trajectories with planned airspace closures, and issue alerts if potential conflicts are detected. In some embodiments, the processing system may query an LXM or use a multi-modal AI model that fuses data from radar tracking systems, AIS maritime feeds, and space object surveillance networks. For example, the processing system may detect anomalies in maritime vessel positions near restricted zones and recommend expanding maritime exclusion areas to reduce risk exposure during scheduled launch operations.

In block 1306, the processing system may detect scheduling conflicts based on violations of the defined rules. The processing system may compare real-time operational updates with scheduling constraints, including regulatory windows for orbital object avoidance, fueling safety margins, and airspace clearance protocols. For example, the processing system may detect a scheduling conflict if an identified orbital conjunction overlaps with a planned launch window, requiring a launch sequence modification to prevent collision risks during ascent. In some embodiments, the processing system may query an LXM or use a predictive anomaly detection model trained on historical mission data. For example, the processing system may detect an anomaly in which an unplanned air traffic reroute near the launch corridor delays final airspace clearance, requiring immediate schedule adjustments to prevent launch hold violations.

In block 1308, the processing system may resolve detected scheduling conflicts by modifying the operational schedule in accordance with the defined rules. The processing system may adjust task dependencies, reallocate resources, and refine mission timing to maintain launch readiness. For example, the processing system may adjust the launch sequence to accommodate a trajectory modification that avoids a high-risk orbital conjunction identified during pre-launch assessments. In some embodiments, the processing system may query an LXM or execute a reinforcement learning-based optimization model to generate alternative scheduling strategies. For example, the processing system may simulate multiple launch timing adjustments and select the option that reduces mission delays while ensuring compliance with flight safety constraints.

In block 1310, the processing system may output the modified launch schedule for stakeholder review. The processing system may generate a comprehensive visualization of schedule updates that incorporates changes to airspace, maritime, and orbital constraints. For example, the processing system may present a detailed mission timeline that includes modifications to fueling operations, payload integration sequencing, and vehicle roll-out schedules, annotated with justifications for each adjustment. In some embodiments, the processing system may generate probabilistic risk assessments alongside the modified schedule. For example, the processing system may indicate the likelihood of success for each adjusted launch window based on airspace congestion, maritime traffic constraints, and predicted orbital conjunction risks.

In block 1312, the processing system may notify stakeholders of the updated schedule and associated adjustments. The processing system may deliver notifications through an integrated mission management dashboard that provides real-time updates, scheduling insights, and decision-support tools. For example, the processing system may issue a “Go/No-Go” recommendation for the adjusted launch window, incorporating live risk assessments from weather monitoring systems, air traffic coordination centers, and space surveillance networks.

In some embodiments, the processing system may use an LXM-based AI model to generate customized briefings for different stakeholder groups. For example, the processing system may deliver a technical report to engineering teams outlining the impact of schedule changes on vehicle system checkouts, while providing a high-level executive summary for senior leadership detailing cost and mission timeline implications.

FIG. 13B is a process flow diagram illustrating a method 1350 of dynamically adjusting a launch schedule in accordance with some embodiments. Method 1350 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 1350 may include these processors, components, and subsystems. One or more processors within the processing system may be configured with software or firmware to perform some or all of the operations of method 1350.

In block 1352, the processing system may define a set of scheduling rules that specify dependencies among pre-launch activities, resource availability, and operational constraints. These rules may account for airspace clearance windows, maritime exclusion zones, orbital conjunction assessments, fueling operations, payload integration timelines, and crew readiness. For example, the processing system may query an LXM or apply a constraint satisfaction model trained on historical launch data to generate an optimal configuration of scheduling rules that aligns with mission safety requirements and operational efficiency goals.

In some embodiments, the processing system may query an LXM or use a Bayesian optimization framework to dynamically adjust scheduling constraints based on evolving operational parameters. For example, the processing system may modify fueling sequence dependencies by analyzing historical fueling durations, environmental conditions, and associated operational bottlenecks. If fueling system performance fluctuates due to weather-related temperature variations, the processing system may adjust the allowable fueling duration buffer to prevent downstream delays in the launch sequence.

In block 1354, the processing system may monitor real-time updates on task completion and constraint changes across airspace, maritime, weather, and orbital domains. The processing system may integrate live telemetry from launch control systems, airspace traffic monitoring platforms, maritime vessel tracking systems, and environmental hazard sensors. For example, the processing system may collect and process orbital debris tracking data to identify new conjunction risks that may impact the planned launch window.

In some embodiments, the processing system may query an LXM or execute a hybrid AI model that integrates real-time deep learning inference with graph-based dependency modeling. For example, the processing system may analyze interdependencies among fueling, payload integration, and crew readiness operations to identify cascading delays that could affect the launch schedule. The processing system may detect that unexpected delays in air traffic clearance may impact launch vehicle rollout sequencing, prompting a recalibration of pre-launch task prioritization.

In block 1356, the processing system may detect scheduling conflicts based on violations of the defined rules or delays in task completion. The processing system may compare real-time operational updates with predefined scheduling constraints and identify potential conflicts affecting launch readiness. For example, the processing system may may query an LXM or execute a temporal anomaly detection model trained on historical launch event data to flag deviations from expected task execution timelines.

In some embodiments, the processing system may compare command issuance patterns to historical execution timelines to detect scheduling irregularities. For example, the processing system may identify an uncharacteristic delay in final launch clearance approvals from regulatory agencies, classify it as a high-priority scheduling conflict, and recommend immediate coordination with air traffic controllers to resolve clearance bottlenecks.

In block 1358, the processing system may resolve the detected conflicts by modifying the schedule to account for updated constraints and task dependencies. The processing system may adjust task sequencing, reallocate resources, and reconfigure operational buffers to maintain mission readiness. For example, the processing system may execute an evolutionary scheduling algorithm that iteratively searches for optimized launch sequences while minimizing cumulative schedule drift.

In some embodiments, the processing system may apply reinforcement learning to dynamically adjust launch sequences. For example, the processing system may reallocate personnel to expedite pre-launch system checks in response to an extended fueling period so that all mission requirements remain satisfied without impacting the scheduled launch window. If pre-launch hazard area activation is delayed due to maritime navigation constraints, the processing system may reprioritize airspace coordination tasks to prevent scheduling gaps in mission sequencing.

In block 1360, the processing system may output the modified launch schedule for stakeholder review. The processing system may generate a visualization that presents the revised schedule along with predictive impact assessments. The visualization may include interactive timeline updates, task dependency annotations, and constraint-adjusted projections.

In some embodiments, the processing system may provide an interactive schedule simulation tool that allows stakeholders to assess the effects of different scheduling adjustments in real time. For example, the processing system may display dependency graphs illustrating how a shift in fueling time affects subsequent launch preparations and mission-critical safety verifications. The processing system may allow mission planners to simulate alternative scheduling strategies and select the most efficient launch sequence while maintaining compliance with airspace, maritime, and orbital traffic constraints.

FIG. 14 is a process flow diagram illustrating a method 1400 of resolving scheduling conflicts in accordance with some embodiments. Method 1400 may be performed in a computing device (e.g., LOD computing system 204) by a processing system that includes one or more processors (e.g., 110, 112, 114, 116, 118, 121, 122, etc.), components (e.g., 207-272, 402-420, etc.), or subsystems discussed in this application. Means for performing the functions of the operations in method 1400 may include these processors, components, and subsystems. One or more processors within the processing system may be configured with software or firmware to perform some or all of the operations of method 1400.

In block 1402, the processing system may receive task requirements, personnel roles, and resource availability. The processing system may integrate structured and real-time data from workforce management systems, operational tracking platforms, and telemetry-enabled resource monitoring networks. For example, the processing system may correlate launch pad crew readiness, fueling system availability, and payload integration status with real-time personnel and asset tracking data. In some embodiments, the processing system may ingest structured data regarding pre-launch activities, such as fueling sequences, avionics validation procedures, and weather hold contingencies, and align this data with the availability of specialized personnel, mission-critical equipment, and launch infrastructure resources. In some embodiments, the processing system may perform these operations to build a comprehensive task dependency model for real-time scheduling analysis. In some embodiments, the processing system may integrate real-time telemetry from distributed monitoring systems to refine resource availability assessments. For example, the processing system may combine RFID-based ground support equipment tracking, automated personnel check-in systems, and infrastructure readiness reports to dynamically update the status of tools, vehicles, and crew members assigned to launch operations.

In block 1404, the processing system may map roles to tasks based on predefined competency criteria. The processing system may allocate personnel and automated systems to mission-critical operations based on historical performance data, technical proficiency metrics, and task complexity. For example, the processing system may recommend assigning a senior avionics technician to oversee final flight computer checks so that the task is performed by an individual with extensive experience in avionics validation for prior launches. In some embodiments, the processing system may use a reinforcement learning model to dynamically adjust task assignments/recommendations in response to changing operational conditions. For example, the processing system may recommend reassigning ground support personnel to a higher-priority fueling operation when unexpected delays in spacecraft payload integration are detected so that the pre-launch sequencing is not disrupted.

In block 1406, the processing system may monitor real-time progress of tasks and the availability of resources. The processing system may execute predictive analytics models on telemetry feeds from launch infrastructure, ground support systems, and real-time workforce status reports to detect potential scheduling risks. For example, the processing system may analyze sensor data from fueling pumps to detect anomalies in flow rates that may impact the completion timeline for cryogenic propellant loading. In some embodiments, the processing system may query an LXM or apply a digital twin model to simulate task execution in real time. For example, the processing system may mirror ongoing vehicle roll-out operations within a virtual environment, allowing it to predict delays due to unexpected transport vehicle maintenance issues and automatically recommend corrective scheduling actions.

In block 1408, the processing system may dynamically adjust task schedules and resource allocations in response to detected changes in task status. The processing system may prioritize mission-critical tasks over secondary operations to maintain launch readiness. For example, the processing system may override a scheduled non-essential maintenance activity when ground telemetry detects a more urgent need for a spacecraft communications system check. In some embodiments, the processing system may query an LXM or apply an AI model to identify and resolve scheduling conflicts by combining rule-based logic with predictive analytics. For example, the processing system may reschedule final crew ingress procedures to accommodate delays in payload bay door sealing while remaining in compliance with safety-critical launch procedures.

In block 1410, the processing system may output an updated task schedule that accounts for real-time changes and operational dependencies. The processing system may generate a dynamic schedule visualization that highlights task sequence adjustments, personnel reassignments, and constraint-driven modifications. For example, the processing system may display a mission control dashboard indicating the revised completion timeline for fueling, final vehicle checks, and airspace clearance approvals, ensuring that all stakeholders are aware of real-time adjustments. In some embodiments, the processing system may generate confidence-weighted recommendations alongside the updated schedule. For example, the processing system may evaluate multiple scheduling alternatives, rank them based on predicted risk impact, and provide stakeholders with an optimized sequencing strategy for maintaining mission readiness.

In block 1412, the processing system may notify stakeholders of the updated schedule and associated adjustments. The processing system may deliver automated notifications through mission coordination platforms, interactive scheduling dashboards, and mobile communication tools. For example, the processing system may issue real-time alerts to launch operations personnel detailing changes in airspace clearance status and new regulatory approval timelines. In some embodiments, the processing system may integrate natural language generation capabilities to enhance stakeholder communication. For example, the processing system may generate detailed textual summaries explaining schedule modifications and their impact on overall mission objectives to allow executives, engineers, and regulatory personnel to quickly interpret critical adjustments without requiring in-depth schedule analysis.

Some embodiments may include a computer-implemented method for identifying constraints in a launch management system, the method including receiving, by a computing device via one or more communication interfaces, real-time airspace data, maritime data, weather data, and orbital data, each having a predefined data structure, processing the real-time airspace data, using a rules-based algorithm executed by the computing device, to identify no-fly zones and dynamic flight path updates based on predefined geospatial parameters, processing the real-time maritime data, using a vessel tracking algorithm executed by the computing device, to identify restricted maritime zones and vessel positions based on automated detection of vessel coordinates and headings, classifying weather conditions into severity categories by applying a machine-learning model trained on historical and simulated weather data, in which the model generates output classifications for wind speed, lightning activity, and turbulence, evaluating orbital data, using a conjunction analysis algorithm executed by the computing device, to identify collision risks and trajectory overlaps based on ephemeris data and predicted orbital paths, and generating, by the computing device, a set of constraint intervals for each of the received data types, in which the constraint intervals indicate the time periods during which respective constraints satisfy predefined operational thresholds.

In some embodiments, the method may further include analyzing historical constraint intervals and operational outcomes to identify recurring patterns, outliers, and anomalies, and adjusting the generated constraint intervals using a statistical model to account for forecasted changes in environmental and operational conditions. In some embodiments the severity categories for weather data include classifications generated by an ensemble of machine-learning models trained to detect correlations between meteorological variables and predefined safety thresholds. In some embodiments evaluating orbital data includes analyzing satellite and space debris proximity using a predictive model trained to simulate potential conjunction scenarios, and calculating a risk score for each detected proximity event based on distance, relative velocity, and orbital geometry. In some embodiments, the method may further include integrating the outputs from processing airspace, maritime, weather, and orbital data by combining the constraint intervals for all data types into a unified constraint timeline, evaluating overlapping and cascading constraints across data types, and generating a composite constraint analysis indicating feasibility scores for potential launch windows based on weighted prioritization of constraints. In some embodiments, the composite constraint analysis may include a confidence score assigned to each launch window based on a probabilistic analysis of constraint stability and visualization of constraint intervals and feasibility scores on a graphical interface for real-time operator decision-making.

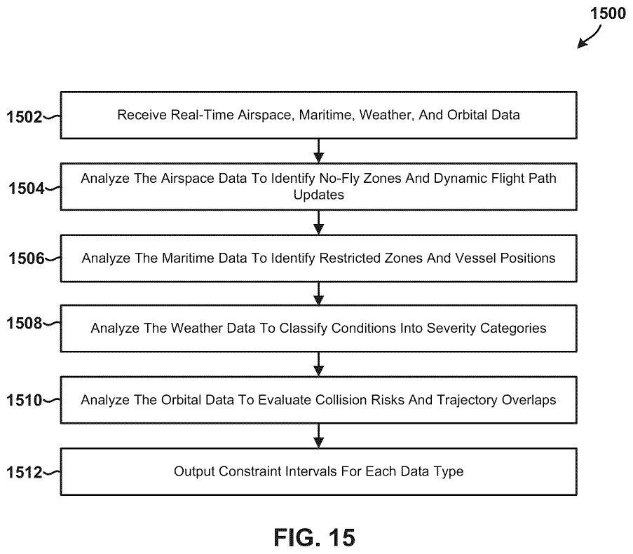

FIG. 15 is a process flow diagram illustrating a method 1500 for identifying constraints in accordance with some embodiments. Method 1500 may be performed in a computing device (e.g., LOD computing system 204) by a processing system that includes one or more processors (e.g., 110, 112, 115, 116, 118, 121, 122, etc.), components (e.g., 207-272, 402-420, etc.), or subsystems discussed in this application. Means for performing the functions of the operations in method 1500 may include these processors, components, and subsystems. One or more processors within the processing system may be configured with software or firmware to perform some or all of the operations of method 1500.

In block 1502, the processing system may receive real-time airspace, maritime, weather, and orbital data, as described. In block 1504, the processing system may analyze the received airspace data to identify no-fly zones and dynamic flight path updates. The processing system may compare regulatory airspace restrictions, NOTAMs, scheduled flights, and real-time aircraft tracking data against the planned launch trajectory. The processing system may update flight paths dynamically by incorporating real-time changes in air traffic. If an active flight path conflicts with the launch trajectory, the processing system may generate an updated clearance window for a revised launch opportunity.

In block 1506, the processing system may analyze maritime data to identify restricted zones and vessel positions. The processing system may analyze maritime advisories, NOTMARs, and real-time vessel tracking data to determine whether marine traffic intersects with the launch hazard area during the planned launch window. The processing system may predict vessel positions based on historical traffic patterns and estimated travel speeds. If a vessel is expected to enter the launch hazard area, the processing system may compute adjusted launch times to avoid conflicts.

In block 1508, the processing system may analyze weather data to classify conditions into severity categories. The processing system may evaluate wind speed, lightning activity, turbulence, cloud cover, and precipitation based on predefined thresholds for launch safety. If the weather classification exceeds operational limits, the processing system may designate the current conditions as unsuitable for launch.

In block 1510, the processing system may analyze orbital data to evaluate collision risks and trajectory overlaps. The processing system may analyze satellite ephemerides, debris tracking data, and predicted conjunctions between the launch vehicle and existing space objects. The processing system may compute proximity risks and determine whether a planned trajectory intersects with hazardous orbital regions. If the risk exceeds predefined safety margins, the processing system may adjust the launch schedule or modify the trajectory.

In block 1512, the processing system may output constraint intervals for each data type, indicating the time periods when airspace, maritime, weather, and orbital conditions align with launch criteria. The processing system may generate a composite schedule of constraint-based launch opportunities and present this information to launch operators.

Some embodiments may include methods for dynamically adjusting a launch schedule in response to real-time events, which may include receiving a predefined set of rules governing launch operations (in which each rule specifies scheduling constraints, event dependencies, and priority levels), continuously monitoring a plurality of events associated with launch preparation activities (in which the monitoring includes receiving real-time data from sensors, automated systems, and user inputs), analyzing the monitored events using a rule-based scheduling engine executed by the computing device to detect scheduling conflicts based on violations of one or more rules in the predefined set, resolving the detected scheduling conflict by applying a conflict-resolution algorithm executed by the computing device (in which the algorithm modifies the schedule in accordance with the predefined set of rules by adjusting event sequences, allocating resources, or updating dependencies to meet operational constraints), and outputting, via a graphical user interface or a machine-readable format, the modified schedule for use by stakeholders and downstream systems.

In some embodiments, the predefined set of rules governing launch operations may include constraints on event timing defined by specific time windows or relative temporal dependencies, resource allocation constraints for facilities, equipment, and personnel, and priority-based dependencies that determine sequencing of events based on the mission-criticality of associated tasks.

In some embodiments, continuously monitoring the plurality of events may include receiving real-time data streams from environmental sensors, telemetry systems, and operational control interfaces, processing the received data to detect anomalies or deviations from expected operational parameters, and generating event-status updates based on the processed data for use in the scheduling engine.

In some embodiments, the method may further include generating, via the computing device, automated notifications of the modified schedule (in which the notifications include visual, textual, or graphical representations of schedule changes), transmitting the notifications to stakeholders via predefined communication channels, including email, mobile alerts, or integrated operational dashboards, and storing a record of the modified schedule and associated notifications in a secure data repository for future reference and compliance verification.

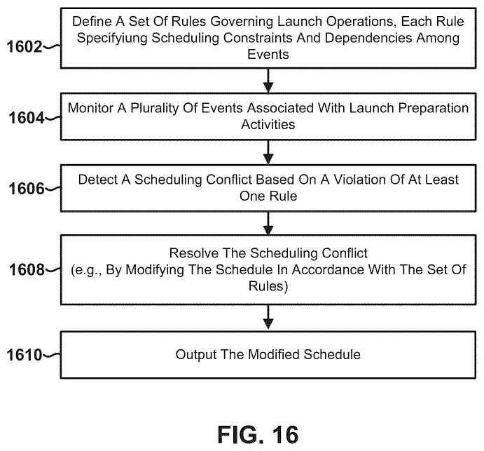

FIG. 16 is a process flow diagram illustrating a method 1600 of dynamically adjusting a launch schedule in response to real-time events in accordance with some embodiments. Method 1600 may be performed in a computing device (e.g., LOD computing system 204) by a processing system that includes one or more processors (e.g., 110, 112, 116, 116, 118, 121, 122, etc.), components (e.g., 207-272, 402-420, etc.), or subsystems discussed in this application. Means for performing the functions of the operations in method 1600 may include these processors, components, and subsystems. One or more processors within the processing system may be configured with software or firmware to perform some or all of the operations of method 1600.

In block 1602, the processing system may define a set of rules governing launch operations. The processing system may establish constraints and dependencies among events that impact scheduling decisions. The rules may specify conditions related to launch timing, resource availability, operational requirements, and dependencies between sequential activities. The processing system may store these rules in a data structure that enables efficient retrieval and application during scheduling operations.

In block 1604, the processing system may monitor a plurality of events associated with launch preparation activities. The processing system may collect data from various sources, including sensors, tracking systems, and user inputs, to assess the status of launch-related tasks. The processing system may update event statuses in real time and compare the data against the predefined rules. In some embodiments, the processing system may track weather conditions, vehicle readiness, ground support operations, and regulatory approvals. The processing system may receive telemetry from launch vehicle subsystems, crew communications, and automated diagnostic checks. The processing system may continuously evaluate whether any monitored event impacts the feasibility of the current launch schedule.

In block 1606, the processing system may detect a scheduling conflict based on a violation of at least one rule. The processing system may compare real-time event statuses with the predefined constraints and identify discrepancies that impact the planned launch timeline. The processing system may flag conflicts when an event does not meet its timing, resource, or dependency conditions. In some embodiments, the processing system may identify conflicts such as delays in fueling, unexpected weather changes, or system malfunctions. The processing system may determine whether these conflicts affect launch feasibility and assess whether adjustments to the schedule are required. The processing system may generate alerts indicating which constraints have been violated and provide a severity assessment of the impact on the launch sequence.

In block 1608, the processing system may resolve the scheduling conflict by modifying the schedule in accordance with the set of rules. The processing system may adjust event sequences, allocate alternative resources, or shift launch windows to accommodate changing conditions. The processing system may apply predefined resolution strategies or execute an optimization algorithm to determine an updated launch timeline. In some embodiments, the processing system may prioritize high-impact tasks and identify the least disruptive adjustments. The processing system may shift secondary activities while preserving mission-critical milestones. If a weather-related delay affects the launch window, the processing system may evaluate alternative windows based on updated meteorological forecasts. If a technical issue delays vehicle readiness, the processing system may assess whether maintenance tasks may be reordered to minimize overall delay.

In block 1610, the processing system may output the modified schedule. The processing system may generate an updated timeline reflecting adjustments made to accommodate detected conflicts. The processing system may transmit the updated schedule to mission control, launch teams, and other relevant stakeholders. In some embodiments, the processing system may present the modified schedule through a visual interface that highlights changes from the original plan. The processing system may provide detailed justifications for each adjustment, including the constraints that triggered the modification. The processing system may ensure that all modifications align with operational rules and mission objectives.

In some embodiments, the processing system may incorporate constraints associated with event timing, resource availability, and launch priority into the set of rules. The processing system may define timing constraints based on orbital mechanics, environmental conditions, and regulatory requirements. The processing system may track resource constraints related to personnel availability, vehicle status, and fuel reserves. The processing system may apply priority constraints to determine whether higher-priority missions take precedence over lower-priority launches.

In some embodiments, the processing system may receive real-time data from sensors, systems, or user inputs to monitor the plurality of events. The processing system may acquire telemetry from vehicle diagnostics, ground-based sensors, and environmental monitoring stations. The processing system may collect operational status updates from crew members, mission planners, and automated scheduling systems.

In some embodiments, the processing system may notify stakeholders of the modified schedule. The processing system may transmit schedule updates to mission control, launch operators, and external agencies involved in the launch process. The processing system may deliver notifications through direct messages, dashboard updates, or automated alerts.

In some embodiments, the processing system may customize notifications based on stakeholder roles. The processing system may provide a high-level summary of changes to executives and detailed event modifications to engineers. The processing system may issue automatic reminders for rescheduled tasks and generate confirmation requests to ensure that all relevant teams acknowledge the updated timeline.

Some embodiments may include methods of integrating launch operation modules into a unified interface, which may include aggregating outputs from hazard surveillance, weather prediction, collision avoidance, and scheduling modules using a computing system configured with a data aggregation module, generating a visualization of aggregated outputs (in which the visualization includes distinct overlays for trajectories, hazards, and scheduling recommendations, each derived from independently processed inputs), providing an interactive user interface that enables users to mark completion of predefined tasks associated with launch operations, submit requests for updates on hazard assessments or scheduling changes, and outputting real-time feedback in response to user interactions. The feedback may include actionable insights derived from aggregated outputs. In some embodiments, the real-time feedback may include alerts generated upon detecting new constraints or changes in launch conditions, and suggestions for alternative scheduling scenarios derived using historical data and machine learning algorithms. In some embodiments, the interface may include dynamically updated visual representations of trajectories, hazard zones, and weather conditions, and/or may be configured to adjust visual parameters in response to real-time data changes. In some embodiments, the methods may further include allowing users to adjust task priorities and schedules through an interactive task manager embedded in the interface, in which adjustments are logged and stored for future analysis.

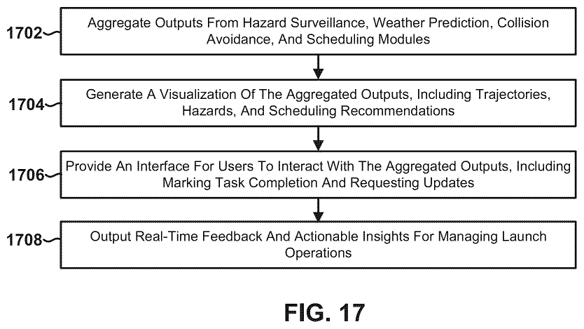

FIG. 17 is a process flow diagram illustrating a method 1700 of generating launch relevant information in accordance with some embodiments. Method 1700 may be performed in a computing device (e.g., LOD computing system 204) by a processing system that includes one or more processors (e.g., 110, 112, 115, 116, 118, 121, 122, etc.), components (e.g., 207-272, 402-420, etc.), or subsystems discussed in this application. Means for performing the functions of the operations in method 1700 may include these processors, components, and subsystems. One or more processors within the processing system may be configured with software or firmware to perform some or all of the operations of method 1700.

In block 1702, the processing system may aggregate outputs from hazard surveillance, weather prediction, collision avoidance, and scheduling modules. The processing system may receive data from multiple sources, including sensors, tracking systems, and predictive models, to create a consolidated operational dataset. The processing system may standardize data formats and synchronize time stamps to align outputs from different modules.

In some embodiments, the processing system may integrate surveillance data identifying unauthorized aircraft or maritime vessels within restricted zones, weather prediction data forecasting wind shear or lightning activity, collision avoidance data tracking orbital debris or satellite proximities, and scheduling data indicating optimal launch windows. The processing system may analyze these datasets to provide a unified operational picture of the launch environment.

In block 1704, the processing system may generate a visualization of the aggregated outputs, including trajectories, hazards, and scheduling recommendations. The processing system may construct a graphical representation of launch paths, restricted zones, meteorological conditions, and predicted collision risks. The processing system may overlay historical data and real-time updates to enhance situational awareness.

In some embodiments, the processing system may render a three-dimensional (3D) trajectory visualization that incorporates projected spacecraft flight paths, hazard perimeters, and atmospheric conditions. The processing system may display color-coded indicators for potential risks, such as high-wind zones or unauthorized vessel incursions. The processing system may allow users to adjust data layers to focus on specific constraints affecting launch operations.

In block 1706, the processing system may provide an interface for users to interact with the aggregated outputs, including marking task completion and requesting updates. The processing system may configure the interface to accept manual inputs, validate user actions, and update system parameters based on received commands. The processing system may allow mission controllers to verify task completion and request re-evaluation of constraints.

In some embodiments, the processing system may present interactive elements enabling users to confirm completion of fueling, payload integration, and final safety checks. The processing system may accept user-initiated queries for updated hazard assessments or refined launch predictions. The processing system may dynamically adjust interface elements to reflect changing mission conditions.

In block 1708, the processing system may output real-time feedback and actionable insights for managing launch operations. The processing system may generate alerts, recommendations, and status reports based on updated data from surveillance, weather, collision, and scheduling modules. The processing system may transmit these outputs to relevant stakeholders, including launch directors and regulatory authorities.

In some embodiments, the processing system may provide automated advisories on launch delays, re-routing options for aerial or maritime traffic, and adjustments to vehicle ignition sequences. The processing system may issue predictive recommendations on optimal launch times by analyzing live meteorological trends and regulatory restrictions. The processing system may continuously update insights to reflect evolving conditions affecting launch feasibility.

In some embodiments, the processing system may generate an interface that includes visual representations of trajectories, hazard zones, and weather conditions. The processing system may configure the interface to display real-time and predictive data related to launch operations. The processing system may align graphical elements with data from hazard surveillance, weather forecasting, and orbital tracking models.

In some embodiments, the processing system may present a graphical overlay of projected launch vehicle trajectories on a digital map, indicating restricted airspace, maritime exclusion zones, and weather-influenced regions. The processing system may include time-based visual markers representing estimated changes in environmental conditions affecting the launch sequence.

In some embodiments, the processing system may allow users to adjust task priorities and schedules through the interface. The processing system may provide an interactive scheduling tool that enables real-time modifications to launch timelines based on evolving constraints. The processing system may implement user permissions to restrict modifications to authorized personnel.

In some embodiments, the processing system may enable mission planners to adjust fueling sequences, crew deployment times, or payload integration deadlines. The processing system may recalculate downstream scheduling dependencies based on modifications to upstream activities. The processing system may display projected launch feasibility scores reflecting updated constraints.

In some embodiments, the processing system may generate real-time feedback, including alerts for new constraints or changes in launch conditions. The processing system may continuously evaluate incoming data and determine whether new constraints impact scheduled operations. The processing system may issue alerts to notify users of emerging hazards, regulatory updates, or system anomalies.

In some embodiments, the processing system may detect a new NOTAM indicating an unplanned airspace restriction and issue an alert to mission control. The processing system may recognize an approaching storm front and notify stakeholders of potential launch delays. The processing system may dynamically adjust alert thresholds to minimize false alarms while ensuring timely responses to operational risks.

Some embodiments may include methods for determining launch trajectory conditions for a vehicle, which may include receiving data from one or more remote sensors, the data including cloud reflectivity, latitude, longitude, altitude, and timestamp information, (in which the data is standardized to a format suitable for further analysis), constructing a three-dimensional model of cloud formations based on the received data, the model including spatial coordinates and reflectivity characteristics (in which the model is optimized for real-time analysis through data compression and loss minimization techniques), analyzing, by a first AI agent executed on a multi-core processor of the computing system, a trajectory of the vehicle relative to the three-dimensional model of cloud formations to identify a first constraint based on proximity and density of the cloud formations, receiving additional data indicative of upper-air conditions, the additional data including wind velocity, atmospheric pressure, and temperature variations at spatial coordinates associated with the trajectory of the vehicle (in which the additional data is processed to enhance signal-to-noise ratio), analyzing, by a second AI agent executed on the computing system, the additional data to identify a second constraint based on interactions between the upper-air conditions and the cloud formations along the trajectory of the vehicle, and integrating the first constraint and the second constraint using a probabilistic model to generate a confidence score representing the probability of successful traversal of the trajectory by the vehicle (in which the confidence score dynamically updates based on new incoming data), and outputting the confidence score to a user interface for visualization (in which the user interface is configured to display a three-dimensional trajectory map overlaid with constraints and annotated probability metrics).

In some embodiments, the method may include receiving predefined nominal trajectory data for the vehicle, determining one or more deviations from the nominal trajectory based on a predefined threshold using machine-learning algorithms trained on historical trajectory data, and applying the first artificial intelligence agent and the second artificial intelligence agent to each deviation to generate corresponding constraints for the deviations.

In some embodiments, constructing the three-dimensional model may include identifying spatial regions within the three-dimensional model having reflectivity values exceeding a predefined threshold, and marking the identified spatial regions as potential trajectory hazards, in which the hazard markings include dynamic annotations for severity levels.

In some embodiments, analyzing the additional data by the second artificial intelligence agent may include identifying temporal changes in water vapor content, atmospheric pressure, and wind direction over a predetermined interval, and mapping these changes to potential impact zones along the trajectory.

In some embodiments, the method may further include predicting movements of the cloud formations based on the additional data and updating the three-dimensional model of the cloud formations to reflect the predicted movements, in which the predictions are based on a recurrent neural network.

In some embodiments, outputting the indication of the probability of successful traversal may include generating a real-time visualization of the trajectory overlaid with the identified first constraint and second constraint, and dynamically updating the visualization based on real-time data received from the one or more remote sensors and user inputs.

In some embodiments, the method may further include receiving historical marine and air traffic data for a region surrounding a spaceport associated with the trajectory of the vehicle, predicting, using a predictive analytics model, the positions of vessels and aircraft during the trajectory, and identifying a third constraint based on potential intersections between the trajectory and the predicted positions, in which the constraint is weighted based on proximity and movement velocity.

In some embodiments, the method may further include integrating the third constraint with the first constraint and the second constraint to update the confidence score representing the probability of successful traversal of the trajectory.

In some embodiments, the method may further include detecting lightning activity within a predefined radius of a spaceport associated with the trajectory of the vehicle, clustering the detected lightning activity into spatial and temporal clusters using machine learning models, and identifying a fourth constraint based on the proximity of the clustered lightning activity to the trajectory, in which the constraint accounts for dynamic atmospheric conditions.

In some embodiments, the method may further include predicting movements of the lightning activity clusters based on upper-air conditions and updating the fourth constraint dynamically.

In some embodiments, the method may further include identifying a launch window for the vehicle based on the probability of successful traversal of the trajectory and predefined thresholds for acceptable risk levels, in which the launch window is recalculated dynamically as real-time data changes. In some embodiments, identifying the launch window may include excluding time intervals during which the probability of successful traversal falls below the predefined thresholds, and incorporating safety margins for atmospheric and traffic constraints. In some embodiments, the user interface provides an interactive visualization enabling adjustment of trajectory parameters and real-time recalculations of the confidence score based on the adjustments, in which user actions are logged for future optimization. In some embodiments, the method may further include storing the data, constraints, and generated probabilities in a relational database for use in future trajectory assessments and adaptive model training.

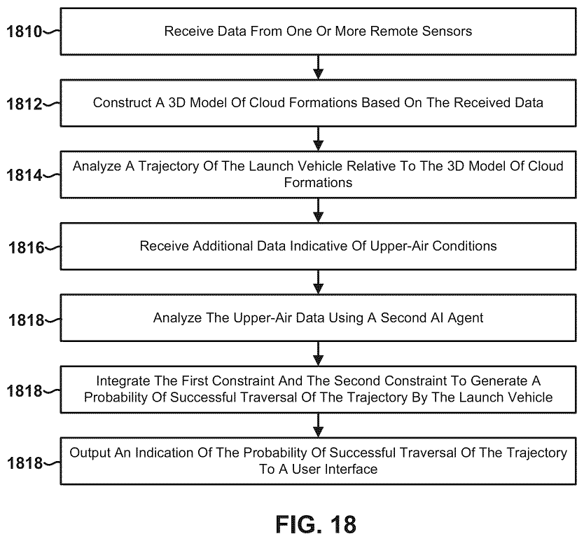

FIG. 18 is a process flow diagram illustrating a method 1800 of determining launch trajectory conditions for a vehicle in accordance with some embodiments. Method 1800 may be performed in a computing device (e.g., LOD computing system 204) by a processing system that includes one or more processors (e.g., 110, 112, 115, 116, 118, 121, 122, etc.), components (e.g., 207-272, 402-420, etc.), or subsystems discussed in this application. Means for performing the functions of the operations in method 1800 may include these processors, components, and subsystems. One or more processors within the processing system may be configured with software or firmware to perform some or all of the operations of method 1800.

In block 1802, the processing system may receive data from one or more remote sensors. The data may include cloud reflectivity, latitude, longitude, altitude, and timestamp information. The processing system may retrieve this data from satellites, ground-based radar, or airborne weather monitoring systems. The processing system may process the received data to associate each data point with a spatial coordinate and time reference.

In some embodiments, the processing system may analyze cloud reflectivity patterns to determine areas of increased optical density or turbulence. The processing system may filter the received data to exclude anomalous readings caused by sensor noise or transient atmospheric conditions. The processing system may then prepare the data for use in constructing a three-dimensional (3D) representation of cloud formations along the trajectory of a launch vehicle.

In block 1804, the processing system may construct a 3D model of cloud formations based on the received data. The 3D model may include spatial coordinates and reflectivity characteristics corresponding to atmospheric cloud structures. The processing system may map cloud density across multiple altitudes and align the mapped data with the vehicle's planned trajectory.

In some embodiments, the processing system may generate a volumetric representation of cloud formations using grid-based interpolation. The processing system may classify regions within the model based on reflectivity intensity and turbulence potential. The processing system may identify high-reflectivity areas as potential hazards that may interfere with launch vehicle stability.

In block 1806, the processing system may analyze a trajectory of the launch vehicle relative to the 3D model of cloud formations. The processing system may execute a first artificial intelligence (AI) agent configured to evaluate proximity and density of cloud formations along the vehicle's path. The processing system may determine whether atmospheric conditions meet predefined launch safety thresholds.

In some embodiments, the processing system may detect potential cloud-related constraints by identifying intersections between the vehicle's planned trajectory and high-reflectivity cloud regions. The processing system may quantify the probability of turbulence or visibility reduction based on cloud density. The processing system may adjust constraint severity levels in response to changing atmospheric conditions.

In block 1808, the processing system may receive additional data indicative of upper-air conditions. The data may include wind velocity, atmospheric pressure, and temperature variations at spatial coordinates corresponding to the trajectory of the launch vehicle. The processing system may collect this data from weather satellites, ground-based stations, or high-altitude weather balloons.

In some embodiments, the processing system may integrate upper-air data to refine assessments of atmospheric stability. The processing system may evaluate wind shear potential and identify altitude-specific air pressure fluctuations. The processing system may compare real-time upper-air data with historical records to detect anomalies affecting launch feasibility.

In block 1810, the processing system may analyze the upper-air data using a second AI agent. The processing system may identify interactions between wind velocity, atmospheric pressure, and cloud formations along the trajectory of the launch vehicle. The processing system may determine whether upper-air conditions introduce additional constraints on the planned flight path.

In some embodiments, the processing system may classify upper-air constraints based on turbulence intensity, pressure gradients, or rapid temperature shifts. The processing system may correlate detected constraints with cloud formation data to assess compound atmospheric risks. The processing system may refine constraint severity levels by incorporating meteorological trend predictions.

In block 1812, the processing system may integrate the first constraint and the second constraint to generate a probability of successful traversal of the trajectory by the launch vehicle. The processing system may compute a probability score based on statistical models trained on historical launch performance data. The processing system may weight different constraint factors according to their relative impact on vehicle stability.

In some embodiments, the processing system may evaluate whether the computed probability score satisfies operational thresholds for launch approval. The processing system may dynamically adjust weighting parameters based on real-time meteorological updates. The processing system may generate probability trend graphs indicating expected variations in atmospheric risk.

In block 1814, the processing system may output an indication of the probability of successful traversal of the trajectory to a user interface. The processing system may provide a real-time risk assessment display for launch operators. The processing system may transmit constraint severity levels and predicted atmospheric effects on vehicle performance.

In some embodiments, the processing system may present probability assessments as visual overlays on a digital flight path map. The processing system may allow users to interact with probability trend data and adjust launch conditions. The processing system may generate automated advisories recommending trajectory modifications based on predicted constraints.

In some embodiments, the processing system may receive data from a weather satellite network configured to monitor atmospheric conditions in real time. The processing system may access continuous meteorological updates from geostationary and low-Earth orbit (LEO) satellites.

In some embodiments, the processing system may synchronize received satellite data with stored historical records to enhance prediction accuracy. The processing system may refine cloud formation models using multi-satellite cross-validation techniques.

In some embodiments, the processing system may receive additional data from weather balloons providing vertical atmospheric profiles along the trajectory of the vehicle. The processing system may analyze high-altitude temperature, humidity, and pressure gradients captured at different altitudes.

In some embodiments, the processing system may integrate balloon-derived measurements with satellite observations. The processing system may correct for discrepancies between predicted and observed atmospheric conditions to improve forecast reliability.

In some embodiments, the processing system may identify spatial regions within the 3D model of cloud formations having reflectivity values exceeding a predefined threshold. The processing system may designate these regions as potential trajectory hazards.

In some embodiments, the processing system may apply pattern recognition techniques to classify cloud types based on reflectivity distributions. The processing system may categorize detected clouds as stratiform, convective, or cumulonimbus based on turbulence risk.

In some embodiments, the processing system may receive predefined nominal trajectory data for the launch vehicle. The processing system may compare the nominal trajectory to predicted atmospheric conditions to determine one or more deviations exceeding a predefined threshold. The processing system may apply AI-driven constraint analysis to each deviation.

In some embodiments, the processing system may recommend trajectory adjustments to minimize constraints. The processing system may identify alternative ascent profiles reducing exposure to high-risk atmospheric regions.

In some embodiments, the processing system may analyze changes in water vapor content, atmospheric pressure, and wind direction over a predetermined temporal interval. The processing system may assess meteorological trend patterns affecting future constraints.

In some embodiments, the processing system may predict upper-atmosphere turbulence based on correlations between rapid humidity shifts and wind shear events. The processing system may adjust launch probability scores accordingly.

In some embodiments, the processing system may predict movements of cloud formations based on additional atmospheric data. The processing system may update the 3D model to reflect predicted cloud displacements.

In some embodiments, the processing system may use AI-driven weather forecasting models trained on historical cloud migration patterns. The processing system may estimate future cloud positions to improve launch planning accuracy.

In some embodiments, the processing system may generate a visualization of the trajectory overlaid with identified constraints. The processing system may dynamically update the visualization based on real-time sensor data.

In some embodiments, the processing system may present real-time trajectory risk assessments to mission operators. The processing system may allow interactive user adjustments of launch parameters.

Some embodiments may include methods for mitigating risks associated with rocket launch delays, which may include evaluating a plurality of risks associated with a scheduled launch window (in which the risks include weather, airspace traffic, maritime traffic, and orbital objects, each risk being evaluated based on predefined criteria), generating a mitigation plan for each identified risk, the mitigation plan including specific actions for addressing each risk, including adjusting schedules, reassigning resources, or redirecting traffic, determining a likelihood of a scrub for the scheduled launch window based on the plurality of risks and predefined probabilistic thresholds, indicating the scheduled launch window as guaranteed if the likelihood of a scrub is below a predefined threshold and storing an indication of the guarantee in a database, and absorbing costs associated with a scrub if the scheduled launch window is guaranteed and fails due to unforeseen circumstances (in which the absorption of costs is subject to predefined exclusions).

In some embodiments, the mitigation plan may include dynamically updating contingency measures in response to real-time data received from weather sensors, air traffic control systems, and satellite tracking systems. In some embodiments, the method may include refining the predefined threshold based on machine learning models trained using historical data on launch delays, risks, and successful launches. In some embodiments, the likelihood of a scrub may be determined using a trained machine learning model that analyzes real-time risk data and assigns probabilities to potential outcomes.

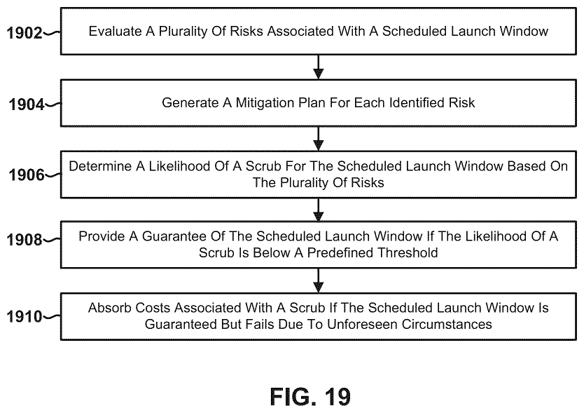

FIG. 19 is a process flow diagram illustrating a method 1900 of mitigating risks associated with rocket launch delays in accordance with some embodiments. Method 1900 may be performed in a computing device (e.g., LOD computing system 204) by a processing system that includes one or more processors (e.g., 110, 112, 115, 116, 118, 121, 122, etc.), components (e.g., 207-272, 402-420, etc.), or subsystems discussed in this application. Means for performing the functions of the operations in method 1900 may include these processors, components, and subsystems. One or more processors within the processing system may be configured with software or firmware to perform some or all of the operations of method 1900.

In block 1902, the processing system may evaluate a plurality of risks associated with a scheduled launch window. The risks may include weather conditions, airspace traffic, maritime traffic, and orbital objects. The processing system may retrieve data from weather monitoring stations, aviation and maritime tracking systems, and orbital surveillance networks. The processing system may analyze historical data and real-time updates to assess potential disruptions to launch operations.

In some embodiments, the processing system may apply statistical modeling techniques to quantify risk levels associated with each factor. The processing system may categorize risks based on likelihood and potential impact on launch performance. The processing system may generate a time-dependent risk profile for the scheduled launch window.

In block 1904, the processing system may generate a mitigation plan for each identified risk. The processing system may define contingency measures addressing potential delays or disruptions. The processing system may evaluate alternative launch windows, adjust resource allocation, or implement procedural adjustments based on identified risks.

In some embodiments, the processing system may classify mitigation strategies based on risk severity and operational feasibility. The processing system may recommend rescheduling criteria for launch operations affected by adverse weather or high air traffic congestion. The processing system may prioritize real-time constraints over historical patterns in determining mitigation responses.

In block 1906, the processing system may determine a likelihood of a scrub for the scheduled launch window based on the plurality of risks. The processing system may analyze risk factors using a predictive model trained on historical launch data. The processing system may compute a probability score indicating the likelihood of launch postponement.

In some embodiments, the processing system may compare the computed probability against predefined operational thresholds. The processing system may dynamically update probability scores as real-time data modifies the risk landscape. The processing system may use trend analysis to identify recurring scrub conditions.

In block 1908, the processing system may provide a guarantee of the scheduled launch window if the likelihood of a scrub is below a predefined threshold. The processing system may issue confirmation reports to stakeholders and operational teams. The processing system may ensure that necessary resources and personnel are allocated for the confirmed launch window.

In some embodiments, the processing system may implement contractual guarantees based on scrub probability assessments. The processing system may assign operational confidence ratings to launch schedules. The processing system may refine its guarantee logic based on historical performance of prior launch commitments.

In block 1910, the processing system may absorb costs associated with a scrub if the scheduled launch window is guaranteed but fails due to unforeseen circumstances. The processing system may allocate financial resources to cover penalties, rescheduling fees, or mission delays. The processing system may analyze scrub justifications to refine future mitigation strategies.

In some embodiments, the processing system may track the financial impact of launch delays over time. The processing system may integrate economic modeling techniques to assess long-term cost implications of scrubbing launches. The processing system may update launch pricing models based on past scrub frequency and associated expenses.

In some embodiments, the processing system may generate a mitigation plan including contingency measure, including rescheduling or resource reallocation. The processing system may define alternate launch scenarios to accommodate potential disruptions. The processing system may recommend operational adjustments based on evolving risk conditions.

In some embodiments, the processing system may adjust launch timelines dynamically based on emerging constraints. The processing system may reallocate resources such as launch personnel, fuel supplies, or tracking systems to optimize scheduling flexibility. The processing system may refine mitigation protocols using iterative risk assessment models.

In some embodiments, the processing system may update the predefined threshold for determining a scrub likelihood based on iterative learning from prior launches. The processing system may incorporate machine learning models trained on past launch outcomes. The processing system may refine scrub probability calculations based on newly observed patterns.

In some embodiments, the processing system may evaluate past launch failures to adjust threshold parameters. The processing system may compare predicted and actual scrub events to enhance forecasting accuracy. The processing system may optimize the balance between operational certainty and flexibility in launch scheduling.

In some embodiments, the processing system may determine the likelihood of a scrub using a machine learning model trained on historical launch data. The processing system may analyze correlations between past launch conditions and scrub events. The processing system may classify scrub risks into probability tiers.

In some embodiments, the processing system may adjust prediction accuracy by incorporating real-time sensor data. The processing system may retrain machine learning models based on updated launch constraints. The processing system may generate confidence scores for each scrub prediction to support informed decision-making.

Some embodiments include methods for coordinating rocket launches across multiple stakeholders, which may include receiving scheduling inputs from a plurality of stakeholders (in which the scheduling inputs include specific resource requirements and timeline constraints for launch operations), analyzing the received scheduling inputs to detect conflicts, in which conflicts are identified based on overlaps in resource allocation or timeline constraints exceeding predefined thresholds, resolving the detected conflicts by applying optimization techniques (in which the optimization techniques include at least linear programming or heuristic algorithms to minimize delays and resource contention), generating a master schedule based on the resolved conflicts, in which the master schedule satisfies the predefined thresholds for resource availability and launch timelines, and distributing the master schedule to the plurality of stakeholders via a secure network interface.

In some embodiments, the scheduling inputs further include environmental constraints, regulatory compliance parameters, and launch vehicle-specific readiness states. In some embodiments, detecting conflicts may include accessing a database storing historical launch data and resource utilization patterns, and applying machine learning models to predict potential conflicts based on historical patterns and real-time scheduling inputs. In some embodiments, the method may include generating a visual representation of the master schedule, in which the visual representation highlights resolved conflicts and associated resource allocations. Some embodiments may include distributing the master schedule may include encrypting the schedule using a public-private key infrastructure to ensure secure transmission to the stakeholders. Some embodiments may include receiving stakeholder feedback regarding the master schedule via the secure network interface and dynamically updating the master schedule in response to the received feedback using iterative optimization methods.

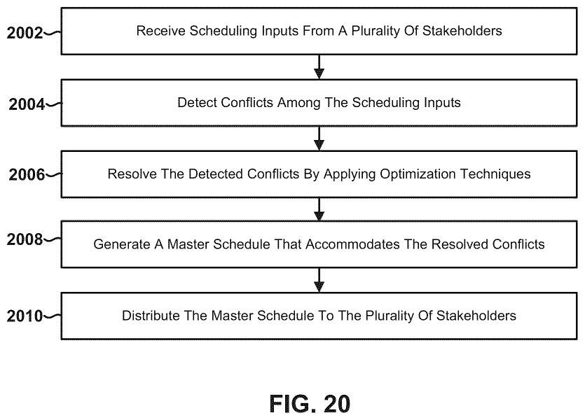

FIG. 20 is a process flow diagram illustrating a method 2000 of coordinating rocket launches across multiple stakeholders in accordance with some embodiments. Method 2000 may be performed in a computing device (e.g., LOD computing system 204) by a processing system that includes one or more processors (e.g., 110, 112, 115, 116, 118, 121, 122, etc.), components (e.g., 207-272, 402-420, etc.), or subsystems discussed in this application. Means for performing the functions of the operations in method 2000 may include these processors, components, and subsystems. One or more processors within the processing system may be configured with software or firmware to perform some or all of the operations of method 2000.

In block 2002, the processing system may receive scheduling inputs from a plurality of stakeholders. The scheduling inputs may specify resource requirements and timeline constraints for a rocket launch. The processing system may collect scheduling inputs from government agencies, commercial launch providers, airspace regulators, and ground operations teams. The scheduling inputs may include data on launch pad availability, fueling windows, crew readiness, weather constraints, and airspace clearance periods.

In some embodiments, the processing system may store scheduling inputs in a structured database. The processing system may classify inputs based on priority, duration, and interdependencies. The processing system may apply access controls to ensure that stakeholders modify only relevant scheduling parameters.

In block 2004, the processing system may detect conflicts among the scheduling inputs. The processing system may compare received inputs to identify overlapping resource allocations, timeline constraints, or operational dependencies. The processing system may flag conflicts where multiple stakeholders request access to the same resource during overlapping time intervals.

In some embodiments, the processing system may execute conflict detection algorithms to identify schedule inconsistencies. The processing system may evaluate launch windows, fueling periods, ground transport routes, and safety buffer zones to determine scheduling conflicts. The processing system may generate conflict reports summarizing identified overlaps and potential resolutions.

In block 2006, the processing system may resolve the detected conflicts by applying optimization techniques. The processing system may execute linear programming models or heuristic algorithms to generate feasible scheduling solutions. The processing system may reallocate resource assignments, adjust timeline dependencies, or prioritize launch activities based on predefined operational criteria.

In some embodiments, the processing system may use iterative simulations to evaluate alternative scheduling arrangements. The processing system may compute weighted trade-offs between competing constraints, such as launch priority, mission readiness, and airspace restrictions. The processing system may generate a ranked list of conflict-free scheduling alternatives.

In block 2008, the processing system may generate a master schedule that accommodates the resolved conflicts. The master schedule may incorporate stakeholder inputs while maintaining consistency with resource availability and operational timelines. The processing system may define sequential and parallel task dependencies to ensure scheduling feasibility.

In some embodiments, the processing system may format the master schedule for integration into mission planning software. The processing system may generate visual representations of the schedule, such as Gantt charts or interactive dashboards. The processing system may apply color-coded indicators to highlight resource utilization levels and scheduling buffers.

In block 2010, the processing system may distribute the master schedule to the plurality of stakeholders. The processing system may transmit scheduling data through secure communication channels. The processing system may provide stakeholders with access to real-time schedule updates and version-controlled revisions.

In some embodiments, the processing system may implement role-based access controls for schedule distribution. The processing system may allow launch directors to override scheduling constraints in response to operational contingencies. The processing system may log all schedule modifications for auditing and compliance tracking.

In some embodiments, the processing system may apply optimization techniques, including linear programming or heuristic algorithms. The processing system may evaluate multiple scheduling constraints and compute optimal resource assignments. The processing system may prioritize scheduling solutions that maximize launch cadence while minimizing resource contention.

In some embodiments, the processing system may apply integer linear programming models to optimize discrete resource allocations. The processing system may implement genetic algorithms to explore non-linear scheduling solutions. The processing system may refine optimization parameters based on historical scheduling outcomes.

In some embodiments, the processing system may identify conflicts by detecting overlaps in resource allocation or timeline constraints. The processing system may analyze scheduling inputs to determine whether multiple stakeholders require access to shared resources during the same time intervals. The processing system may flag conflicts involving overlapping launch pad assignments, fueling operations, or regulatory approvals.

In some embodiments, the processing system may use constraint satisfaction algorithms to classify scheduling conflicts. The processing system may categorize conflicts based on severity and required resolution time. The processing system may generate alerts to notify stakeholders of detected scheduling inconsistencies.

In some embodiments, the processing system may receive feedback from stakeholders and modify the master schedule based on the feedback. The processing system may allow stakeholders to propose schedule adjustments in response to operational changes. The processing system may evaluate proposed modifications to ensure compliance with scheduling constraints.

In some embodiments, the processing system may implement a feedback validation mechanism. The processing system may rank stakeholder feedback based on authority levels and operational impact. The processing system may update the master schedule iteratively based on verified stakeholder inputs.

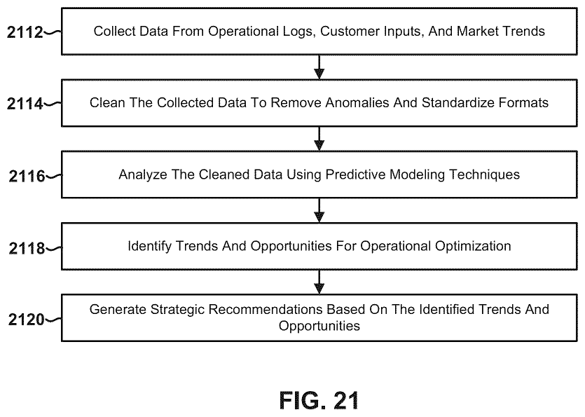

FIG. 21 is a process flow diagram illustrating a method 2100 of generating actionable insights from launch-related data in accordance with some embodiments. Method 2100 may be performed in a computing device (e.g., LOD computing system 204) by a processing system that includes one or more processors (e.g., 110, 112, 115, 116, 118, 121, 122, etc.), components (e.g., 207-272, 402-420, etc.), or subsystems discussed in this application. Means for performing the functions of the operations in method 2100 may include these processors, components, and subsystems. One or more processors within the processing system may be configured with software or firmware to perform some or all of the operations of method 2100.

In block 2102, the processing system may collect data from operational logs, customer inputs, and market trends. The processing system may retrieve operational logs from launch vehicle telemetry, maintenance records, and mission execution reports. The processing system may receive customer inputs related to launch service requirements, payload specifications, and scheduling preferences. The processing system may collect market trend data from industry reports, competitor activity, and regulatory filings.

In some embodiments, the processing system may be configured to collect telemetry data from launch vehicles, scheduling preferences from customer databases, and real-time market intelligence from third-party sources, and to integrate the data using metadata correlation for predictive analysis. In some embodiments, the processing system may collect telemetry data via secure APIs from launch vehicles, integrate scheduling inputs from customer systems, and access real-time market intelligence via third-party data feeds. The system may timestamp each data entry and assign metadata for chronological correlation.

In some embodiments, the processing system may store collected data in a structured database. The processing system may classify data into categories such as vehicle performance metrics, customer demand patterns, and economic indicators. The processing system may assign timestamps and metadata to each data entry for chronological tracking and correlation.

In block 2104, the processing system may clean the collected data to remove anomalies and standardize formats. In some embodiments, the processing system may clean the data using a multi-stage process that includes anomaly detection using isolation forest algorithms, format standardization by applying schema-matching algorithms, and temporal normalization to align data streams. In some embodiments, the processing system may apply outlier detection algorithms to identify and filter inconsistent or erroneous data points. The processing system may standardize numerical values, categorical labels, and time-series data for consistency across multiple data sources.

In some embodiments, the processing system may use machine learning-based anomaly detection models to refine data cleaning. The processing system may compare incoming data against historical distributions to identify deviations that indicate potential data quality issues. The processing system may apply normalization techniques to align data formats across various input sources.

In block 2106, the processing system may analyze the cleaned data using predictive modeling techniques. In some embodiments, the processing system may apply deep learning models, including LSTM networks, trained on historical launch performance data to predict constraints. In some embodiments, these models may execute on a SoC architecture designed for low-latency computation. In some embodiments, the processing system may execute machine learning algorithms trained on historical launch performance data. In some embodiments, the processing system may generate probability distributions for future operational events based on statistical trends and machine learning inferences.

In some embodiments, the processing system may be configured to execute machine learning models trained on historical launch performance data, and to predict launch readiness based on telemetry, weather, and scheduling constraints.

In some embodiments, the processing system may use regression models to predict launch success rates based on environmental conditions, vehicle readiness, and prior mission performance. The processing system may implement classification models to assess the likelihood of scheduling conflicts or system failures. The processing system may refine model parameters using real-time operational data.

In block 2108, the processing system may identify trends and opportunities for operational optimization. The processing system may extract patterns from predictive analysis to detect inefficiencies in launch preparation workflows. The processing system may evaluate resource utilization levels and recommend adjustments to improve scheduling accuracy and cost efficiency.

In some embodiments, the processing system may correlate launch delay patterns with weather disruptions, air traffic constraints, or supply chain fluctuations. The processing system may detect recurring bottlenecks in mission readiness processes and suggest procedural modifications to mitigate risks. The processing system may rank identified optimization opportunities based on their projected impact on mission success.

In block 2110, the processing system may generate strategic recommendations based on the identified trends and opportunities. The processing system may produce actionable insights for decision-makers to optimize infrastructure investments, resource allocations, and operational policies. The processing system may prioritize recommendations based on feasibility, cost-effectiveness, and potential impact on mission timelines.

In some embodiments, the processing system may generate structured reports summarizing optimization opportunities and associated recommendations. The processing system may include confidence scores for each recommendation, indicating the level of certainty derived from predictive analysis. The processing system may integrate recommended actions into automated decision-support systems for real-time operational adjustments.

In some embodiments, the processing system may apply predictive modeling techniques that include machine learning models trained on historical data. The processing system may execute supervised learning models that correlate past launch events with operational outcomes. The processing system may fine-tune predictive models based on new data collected from ongoing missions.

In some embodiments, the processing system may implement deep learning frameworks to analyze complex dependencies among multiple operational variables. The processing system may use reinforcement learning models to simulate alternative decision-making strategies and assess their long-term impact on launch success rates. The processing system may continuously retrain models using updated datasets.

In some embodiments, the processing system may generate strategic recommendations that include infrastructure expansion or resource reallocation. The processing system may analyze launch site capacity, fuel storage levels, and vehicle maintenance schedules to assess the sufficiency of the infrastructure. The processing system may recommend the construction of new facilities or redistribution of assets to improve operational efficiency.

In some embodiments, the processing system may detect trends in payload demand growth and suggest investment in additional launch pads or fueling stations. The processing system may identify underutilized assets and propose their reassignment to high-demand areas. The processing system may generate cost-benefit analyses to support decision-making for infrastructure adjustments.

In some embodiments, the processing system may generate visualizations of the identified trends for stakeholder review. The processing system may construct graphical representations of launch performance trends, scheduling forecasts, and risk assessments. The processing system may use interactive dashboards to allow stakeholders to explore data relationships dynamically.

In some embodiments, the processing system may generate visualizations that include risk heat maps, resource allocation graphs, and/or predictive launch timelines, using a GPU-accelerated rendering engine and may allow stakeholders to interact with these visualizations through an intuitive dashboard.

In some embodiments, the processing system may generate heat maps to illustrate operational bottlenecks and resource allocation imbalances. The processing system may develop timeline projections that display potential impacts of alternative scheduling strategies. The processing system may integrate visualization tools with real-time data feeds to provide continuously updated operational insights.

Some embodiments include methods for generating actionable insights from launch-related data, which may include receiving, by a computing device, data from operational logs, customer inputs, and market trend databases, normalizing the received data to align with predefined formats by applying a data standardization protocol executed by the computing device, analyzing, using a trained machine learning model executed by the computing device, the normalized data to predict trends, in which the analysis includes applying regression models and classification algorithms to detect patterns, correlating the identified trends with predefined optimization metrics to determine actionable opportunities, and outputting, by the computing device, strategic recommendations in a structured format to a user interface for stakeholder review.

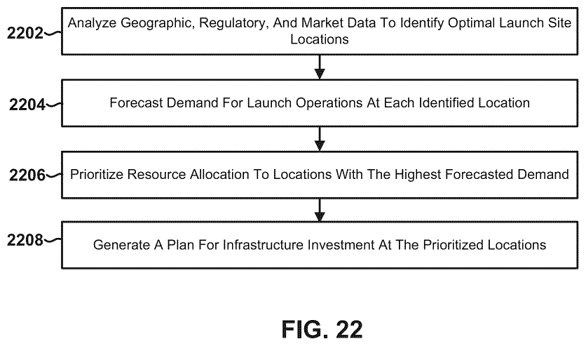

FIG. 22 is a process flow diagram illustrating a method 2200 enhancing launch site resource allocation in accordance with some embodiments. Method 2200 may be performed in a computing device (e.g., LOD computing system 204) by a processing system that includes one or more processors (e.g., 110, 112, 115, 116, 118, 121, 122, etc.), components (e.g., 207-272, 402-420, etc.), or subsystems discussed in this application. Means for performing the functions of the operations in method 2200 may include these processors, components, and subsystems. One or more processors within the processing system may be configured with software or firmware to perform some or all of the operations of method 2200.

In block 2202, the processing system may analyze geographic, regulatory, and market data to identify optimal launch site locations. The processing system may evaluate geographic data to assess proximity to transportation networks, aerospace hubs, and established launch corridors. The processing system may analyze regulatory data to determine airspace restrictions, maritime traffic constraints, and environmental compliance requirements. The processing system may assess market data to identify emerging commercial and governmental demand for launch services.

In some embodiments, the processing system may retrieve geographic data from satellite imagery, GIS (Geographic Information System) databases, and publicly available mapping resources. The processing system may access regulatory data from civil aviation authorities, maritime agencies, and national security directives. The processing system may integrate market data from customer inquiries, industry reports, and competitive analyses to refine site selection criteria.

In block 2204, the processing system may forecast demand for launch operations at each identified location. The processing system may apply predictive analytics to historical launch data, emerging commercial space trends, and planned government missions. The processing system may model demand fluctuations based on seasonal variations, regulatory approvals, and economic conditions affecting the space industry.

In some embodiments, the processing system may use machine learning algorithms to analyze correlations between past launch site utilization rates and external factors such as payload type, mission frequency, and geopolitical influences. The processing system may generate demand probability distributions for different locations and adjust predictions based on real-time market signals.

In block 2206, the processing system may prioritize resource allocation to locations with the highest forecasted demand. The processing system may rank launch sites based on projected mission volume, infrastructure readiness, and logistical feasibility. The processing system may allocate personnel, launch vehicle support systems, and ground-based tracking assets to the highest-priority sites.

In some embodiments, the processing system may optimize resource allocation using linear programming, heuristic optimization, or constraint-based scheduling techniques. The processing system may balance resource deployment across multiple sites while maintaining operational flexibility to accommodate unexpected demand shifts.

In block 2208, the processing system may generate a plan for infrastructure investment at the prioritized locations. The processing system may determine required upgrades to launch pads, fueling stations, telemetry systems, and crew support facilities. The processing system may estimate investment costs and projected return on investment for each proposed infrastructure enhancement.

In some embodiments, the processing system may incorporate financial modeling techniques to assess long-term viability of infrastructure investments. The processing system may generate reports detailing projected capital expenditures, expected site utilization rates, and anticipated revenue growth based on forecasted demand. The processing system may provide decision-makers with an optimized investment strategy for sustaining and expanding launch site operations.

In some embodiments, the processing system may evaluate proximity to key customer markets as part of analyzing the geographic data. The processing system may assess the distance between proposed launch sites and major satellite manufacturing hubs, defense contractors, and commercial space customers. The processing system may analyze logistical considerations, including shipping times for payloads, transport costs, and regulatory transit restrictions.

In some embodiments, the processing system may use clustering algorithms to group launch sites based on their accessibility to high-demand customer regions. The processing system may identify optimal sites that minimize operational delays while maximizing service availability for commercial and governmental clients.

In some embodiments, the processing system may forecast demand for launch operations based on historical launch data and market trends. The processing system may retrieve historical data from previous mission schedules, payload launch manifests, and global spaceflight records. The processing system may compare past launch frequencies with emerging trends in satellite deployment, deep-space exploration, and commercial crew transportation.

In some embodiments, the processing system may train machine learning models to predict demand fluctuations by analyzing factors such as satellite replacement cycles, launch contract announcements, and government space policy changes. The processing system may refine demand projections using real-time economic and geopolitical indicators affecting space industry growth.

In some embodiments, the processing system may dynamically adjust the resource allocation plan based on real-time changes in demand. The processing system may monitor launch manifest updates, payload readiness status, and emergency rescheduling requests to identify shifts in operational priorities. The processing system may reallocate personnel, fuel supplies, and mission support equipment in response to evolving demand conditions.

In some embodiments, the processing system may execute reinforcement learning algorithms to continuously refine resource allocation strategies. The processing system may adjust site priorities based on immediate mission requirements while maintaining long-term strategic planning. The processing system may generate adaptive scheduling recommendations to balance resource efficiency with operational responsiveness.

The methods described may apply computational techniques to generate actionable insights for space launch operations and resource management. Launch-related data, including operational logs, customer inputs, and market trends, may be received by a computing device. This data may be normalized into predefined formats using a data standardization protocol executed by the computing device. Advanced machine learning models analyze the normalized data to predict trends, applying regression models and classification algorithms to detect patterns. Identified trends may be correlated with predefined optimization metrics to determine actionable opportunities, and strategic recommendations may be output in a structured format for stakeholder review. These technical processes enhance data utilization and decision-making by transforming raw data into meaningful operational insights.

The processing system may analyze geographic, regulatory, and market data to identify optimal launch site locations. Geographic data may include proximity to transportation networks, aerospace hubs, and established launch corridors. Regulatory data may address airspace restrictions, maritime traffic constraints, and environmental compliance requirements. Market data may assess emerging demand from commercial and governmental clients. The system may retrieve geographic data from satellite imagery, GIS databases, and publicly available mapping resources. Regulatory data may be obtained from civil aviation authorities, maritime agencies, and national directives. Customer inquiries, industry reports, and competitive analyses may refine site selection criteria.

Demand forecasting may involve applying predictive analytics to historical launch data, emerging commercial trends, and planned governmental missions. Factors such as seasonal variations, regulatory approvals, and economic conditions affecting the space industry may also be modeled. Machine learning algorithms may analyze correlations between past launch site utilization and external factors, including payload types, mission frequency, and geopolitical influences. Demand probability distributions may be generated for identified locations, with real-time market signals further refining predictions. These forecasts support proactive resource allocation strategies tailored to operational needs.

The processing system may prioritize resource allocation by ranking sites based on projected mission volume, infrastructure readiness, and logistical feasibility. Resource deployment may be optimized using linear programming, heuristic optimization, or constraint-based scheduling techniques, balancing resource efficiency with operational flexibility. Infrastructure investment plans may address necessary upgrades to launch pads, fueling stations, telemetry systems, and crew support facilities. Financial modeling techniques may evaluate projected capital expenditures, site utilization rates, and revenue growth, guiding long-term operational sustainability.

Dynamic resource allocation may adjust to real-time demand fluctuations. Launch manifest updates, payload readiness statuses, and emergency rescheduling requests may inform reallocation decisions. Reinforcement learning algorithms may refine resource deployment strategies, prioritizing site resources based on immediate mission requirements while supporting long-term strategic planning. Adaptive scheduling recommendations may ensure balanced resource efficiency and operational responsiveness. These processes transform complex operational environments into manageable systems, demonstrating a practical application of computational techniques in space launch management.

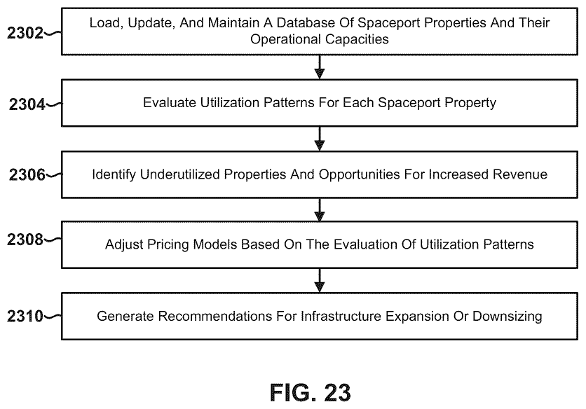

FIG. 23 is a process flow diagram illustrating a method 2300 of managing and monetizing spaceport facilities in accordance with some embodiments. Method 2300 may be performed in a computing device (e.g., LOD computing system 204) by a processing system that includes one or more processors (e.g., 110, 112, 115, 116, 118, 121, 122, etc.), components (e.g., 207-272, 402-420, etc.), or subsystems discussed in this application. Means for performing the functions of the operations in method 2300 may include these processors, components, and subsystems. One or more processors within the processing system may be configured with software or firmware to perform some or all of the operations of method 2300.

In block 2302, the processing system may maintain a database of spaceport properties and their operational capacities. The processing system may store records of each spaceport property, including location, launch pad availability, fueling infrastructure, and mission support facilities. The processing system may categorize properties based on usage history, technical specifications, and regulatory compliance.

In some embodiments, the processing system may continuously update the database by integrating data from telemetry feeds, operational reports, and external regulatory sources. The processing system may structure the data to allow efficient querying and retrieval of spaceport attributes for real-time analysis.

In block 2304, the processing system may evaluate utilization patterns for each spaceport property. The processing system may analyze past launch schedules, mission types, and asset deployment to determine occupancy trends. The processing system may assess capacity constraints, downtime between launches, and overall efficiency of facility usage.

In some embodiments, the processing system may apply statistical models or machine learning techniques to predict future utilization trends. The processing system may identify seasonal fluctuations, peak demand periods, and potential scheduling conflicts affecting spaceport operations.

In block 2306, the processing system may identify underutilized properties and opportunities for increased revenue. The processing system may compare actual facility usage against available capacity to determine excess resources. The processing system may assess historical demand patterns to identify gaps in scheduling that could accommodate additional missions.

In some embodiments, the processing system may generate recommendations for reallocating resources to maximize operational efficiency. The processing system may suggest repurposing inactive facilities for alternative uses, such as payload integration, vehicle storage, or third-party leasing.

In block 2308, the processing system may adjust pricing models based on the evaluation of utilization patterns. The processing system may calculate dynamic pricing adjustments based on demand fluctuations, maintenance costs, and competitive market conditions. The processing system may assign variable rates for peak and off-peak periods to optimize revenue.

In some embodiments, the processing system may apply predictive analytics to anticipate market shifts affecting pricing strategy. The processing system may adjust financial models based on external factors such as policy changes, commercial spaceflight demand, and emerging launch service providers.

In block 2310, the processing system may generate recommendations for infrastructure expansion or downsizing. The processing system may assess projected mission growth, technology advancements, and regulatory constraints to determine optimal facility investment strategies. The processing system may prioritize infrastructure projects based on expected return on investment and alignment with long-term spaceport objectives.

In some embodiments, the processing system may generate reports detailing recommended facility modifications, budget allocations, and projected operational benefits. The processing system may support decision-making by providing financial projections and risk assessments for proposed infrastructure changes.

In some embodiments, the processing system may determine utilization patterns from operational logs and customer feedback. The processing system may analyze launch event data, facility reservation records, and service request histories to quantify resource usage. The processing system may process customer feedback, including survey responses, service complaints, and satisfaction ratings, to assess facility performance.

In some embodiments, the processing system may correlate operational efficiency metrics with user experience insights. The processing system may refine utilization analysis by integrating qualitative feedback with quantitative facility performance indicators.

In some embodiments, the processing system may track maintenance costs and include them in pricing model adjustments. The processing system may record expenses associated with facility upkeep, including routine inspections, equipment repairs, and regulatory compliance costs. The processing system may factor depreciation rates and unexpected maintenance events into pricing calculations.

In some embodiments, the processing system may apply cost forecasting models to anticipate future maintenance expenditures. The processing system may dynamically adjust pricing structures to compensate for projected increases in facility upkeep costs.

In some embodiments, the processing system may generate recommendations for infrastructure expansion based on forecasted demand. The processing system may analyze industry growth trends, commercial launch contracts, and governmental space initiatives to predict future facility needs. The processing system may identify emerging technology requirements, such as reusable launch vehicle compatibility or increased payload processing capacity, as drivers for infrastructure expansion.

In some embodiments, the processing system may simulate various expansion scenarios to optimize investment planning. The processing system may evaluate trade-offs between capital expenditures and expected revenue growth, ensuring infrastructure development aligns with projected demand.

Thus, in some embodiments, the processing system applies computational processes to manage and monetize spaceport facilities by addressing challenges related to operational capacity assessment, resource optimization, and revenue generation. The processing system maintains a structured and dynamically updated database of spaceport properties. Each facility's record may include location, launch pad availability, fueling infrastructure, mission support systems, and other operational attributes. The processing system categorizes properties based on usage history, technical specifications, and regulatory compliance. Telemetry feeds, operational reports, and external regulatory data are continuously integrated into the database, ensuring real-time insights for operational decision-making. Data normalization and standardization protocols support efficient querying and retrieval of attributes, enabling rapid analysis and actionable insights. These operations improve the computing system's ability to process and manage complex, real-time data by reducing retrieval times and enhancing the accuracy of predictive analysis.

The processing system evaluates utilization patterns for spaceport properties by analyzing historical launch schedules, mission profiles, and resource deployment data. Capacity constraints, downtime between launches, and facility efficiency metrics are assessed using statistical models and machine learning techniques. Predictive analytics forecast future utilization trends, identifying seasonal fluctuations, peak demand periods, and scheduling conflicts. These insights allow the processing system to anticipate operational bottlenecks and inform resource allocation strategies. Advanced algorithms correlate variables such as payload types, mission frequency, geopolitical factors, and market demand shifts. These correlations improve prediction accuracy and enhance the computational efficiency of the system by automating complex data analysis that would otherwise require extensive human intervention.

The processing system identifies underutilized properties and evaluates revenue-generation opportunities by comparing facility usage against available capacity. It analyzes scheduling gaps, assesses historical demand patterns, and identifies facilities that may accommodate additional missions or alternative uses. In addition to optimizing operations, the system generates recommendations for repurposing inactive facilities, which may include uses such as payload integration, vehicle storage, or third-party leasing. Clustering algorithms group properties based on demand regions and accessibility metrics to align recommendations with logistical and operational priorities. By structuring these analyses within the computing system, the method improves processing efficiency, reduces computational overhead, and enhances the system's capability to manage vast datasets in real time.

Dynamic pricing models are adjusted based on utilization evaluations, incorporating demand fluctuations, maintenance costs, and market competition. Machine learning models calculate variable rates for peak and off-peak periods, ensuring that pricing strategies align with operational requirements and optimize revenue. Predictive analytics further enhance pricing strategies by considering external factors such as policy changes, emerging competitors, and market trends. Real-time updates to pricing models allow the system to dynamically adjust to shifts in operational conditions and industry developments. Unlike financial processes that determine pricing based on market speculation or external financial models, the described system continuously refines its models through real-time operational data integration, making decisions rooted in quantifiable facility performance and computing-driven pattern analysis.

The processing system develops infrastructure planning and investment strategies using robust analytical methods. It evaluates projected mission growth, technological advancements, and regulatory constraints to prioritize infrastructure modifications. Recommendations are tailored to align with organizational goals, including assessments of potential return on investment, operational impacts, and long-term benefits. Reports generated by the system detail proposed modifications, budget allocations, and anticipated performance improvements. Financial modeling and risk analysis tools provide quantitative and qualitative data to support informed investment decisions. By automating complex decision-making tasks through high-performance computing, the system improves processing capabilities. It reduces the need for manual intervention, further distinguishing it from conventional or manual solutions.

Operational data is integrated with customer feedback to quantify resource usage and evaluate facility performance. The system analyzes launch event data, facility reservation records, and service histories alongside customer survey responses and satisfaction ratings. By combining qualitative feedback with quantitative metrics, the system refines utilization analysis and correlates operational efficiency metrics with user experience. Unlike conventional (human-involved) processes that rely on subjective evaluation, the system applies machine learning algorithms and statistical models to derive insights from structured and unstructured data, improving the accuracy, speed, and reliability of decision-making. This comprehensive approach supports effective spaceport management by addressing operational challenges and enabling data-driven decision-making through computing advancements rather than human judgment alone.

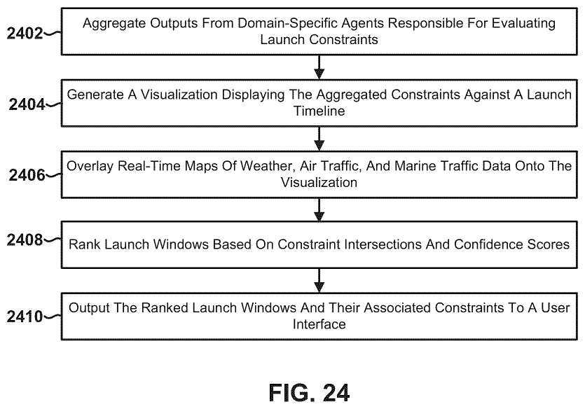

FIG. 24 is a process flow diagram illustrating a method 2400 of generating and outputting launch constraints and recommendations in accordance with some embodiments. Method 2400 may be performed in a computing device (e.g., LOD computing system 204) by a processing system that includes one or more processors (e.g., 110, 112, 115, 116, 118, 121, 122, etc.), components (e.g., 207-272, 402-420, etc.), or subsystems discussed in this application. Means for performing the functions of the operations in method 2400 may include these processors, components, and subsystems. One or more processors within the processing system may be configured with software or firmware to perform some or all of the operations of method 2400.

In block 2402, the processing system may aggregate outputs from domain-specific agents responsible for evaluating launch constraints. The processing system may collect airspace constraints based on flight activity and restricted zones, maritime constraints based on vessel positioning and navigation restrictions, weather constraints based on atmospheric conditions and forecasts, and orbital constraints based on space traffic analysis. The processing system may standardize the collected data to facilitate integration and comparison across different constraint categories.

In some embodiments, the processing system may retrieve constraint data from external sources, including aviation authorities, maritime monitoring systems, meteorological agencies, and orbital tracking networks. The processing system may execute data preprocessing routines to normalize constraint information across different formats and timeframes.

In block 2404, the processing system may generate a visualization displaying the aggregated constraints against a launch timeline. The processing system may construct a Gantt chart or a similar time-based graphical representation, where each constraint category is displayed in relation to the planned launch time. The processing system may apply time-dependent markers to indicate constraint severity and expected resolution times.

In some embodiments, the processing system may update the visualization dynamically as new data becomes available. The processing system may allow users to interact with the visualization by adjusting constraint filtering parameters, modifying time intervals, or requesting expanded constraint details.

In block 2406, the processing system may overlay real-time maps of weather, air traffic, and marine traffic data onto the visualization. The processing system may integrate geographic representations of constraint areas, such as storm cells, aircraft flight paths, and vessel locations, to provide contextual insights. The processing system may synchronize map overlays with the timeline visualization to display how real-time changes affect launch conditions.

In some embodiments, the processing system may generate interactive geographic layers that allow users to toggle visibility of specific constraint categories. The processing system may provide zoom functionality to examine localized constraint impacts near the launch site.

In block 2408, the processing system may rank launch windows based on constraint intersections and confidence scores. The processing system may analyze time intervals during which constraints align to identify launch opportunities with minimal risk. The processing system may assign confidence scores to each launch window based on historical data, constraint severity levels, and predictive models.

In some embodiments, the processing system may apply machine learning techniques to refine confidence scores over time. The processing system may adjust rankings dynamically in response to real-time updates in constraint conditions.

In block 2410, the processing system may output the ranked launch windows and their associated constraints to a user interface. The processing system may generate a summary view displaying optimal launch opportunities along with detailed constraint explanations. The processing system may format the output for integration with mission control systems or external scheduling tools.

In some embodiments, the processing system may provide an interactive interface allowing users to explore ranked launch windows, access historical constraint patterns, and configure alert settings for real-time updates.

In some embodiments, the processing system may generate automated alerts summarizing launch recommendations, risks, and alternatives for stakeholder review. The processing system may compile a structured report detailing constraint evaluations, ranked launch windows, and suggested contingency plans. The processing system may categorize alerts based on severity, highlighting constraints that pose immediate risks to scheduled launch operations.

In some embodiments, the processing system may configure alerts for distribution via multiple communication channels, including dashboard notifications, email summaries, and automated messaging systems. The processing system may allow users to customize alert thresholds based on operational preferences.

In some embodiments, the processing system may annotate the visualization with constraint severity levels and real-time updates. The processing system may apply color coding, numerical risk scores, or warning icons to indicate the impact of individual constraints. The processing system may refresh annotations dynamically as updated constraint data is received.

In some embodiments, the processing system may provide interactive annotation tools, allowing users to add comments, modify constraint thresholds, or flag specific conditions for further review. The processing system may store historical annotations to support post-mission analysis and decision-making audits.

Some embodiments include methods, and computing devices configured to implement the methods, for ensuring safe, efficient, reliable, and successful launches. In some embodiments, the computing device may be configured to implement and/or use a federated architecture to integrate data from diverse sources, including national airspace system data (e.g., information about airspace availability, flight paths, traffic, etc.), marine transportation system data (e.g., data on maritime traffic, vessel positions, sea routes, etc.), orbital object catalog data (e.g., information on satellites, space debris, other objects in orbit, etc.), weather monitoring system data (e.g., real-time and forecasted meteorological data, lightning flash, field mill, etc.), telemetry data from launch vehicles (e.g., real-time performance and positional data from the launch vehicle, etc.), trajectory (e.g., 3 sigma or standard deviation of nominal trajectory, simulated nominal stage 1 and stage 2 trajectories), satellite tracking system data (e.g., tracking data of satellites in orbit for collision avoidance, etc.), flight tracking system data (e.g., data from air traffic monitoring systems, etc.), spectrum monitoring data (e.g., information on the radio frequency spectrum for communication and navigation, etc.), geospatial information system (GIS) data (e.g., mapping and spatial data for launch areas, etc.), global positioning system (GPS) data (e.g., precise location data used for tracking and navigation, etc.), launch vehicle performance data (e.g., information on the capabilities and status of the launch vehicle, etc.), and environmental monitoring data (e.g., data on local environmental conditions at the launch site, Notice to Air Missions, Notice to Mariners, etc.). In some embodiments, the computing device may be configured to use the integrated data to identify safe launch windows and/or to otherwise enhance the timeliness and/or safety of space vehicle launches. For example, in some embodiments, the computing device may be configured to implement and/or use a nuanced high-precision collision avoidance solution that integrates information across different domains into a cohesive operational picture. In some embodiments, the computing device may be configured to implement and/or use condition-based launch criteria and a modular cloud-based infrastructure that provides greater flexibility and safety in launch operations and significantly decreases the overall expenses for spaceport users. In some embodiments, the computing device may be configured to prioritize public safety while complying with the objectives of the launch operator. The embodiments may enhance range capacity, streamline launches, and reduce the need for extensive on-site infrastructure and/or personnel.

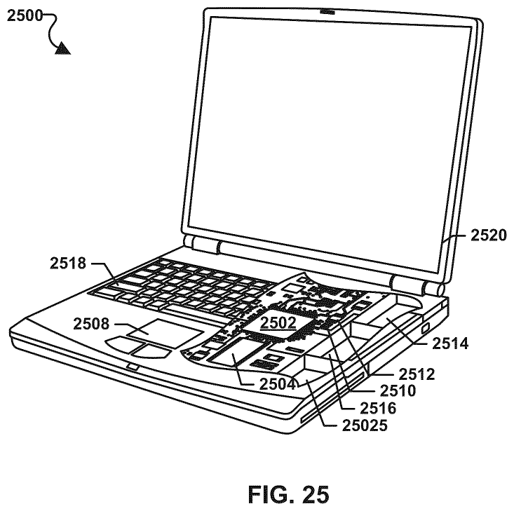

FIG. 25 is a component block diagram of an edge device in the form of a laptop computer 2500 that may be configured to implement one or more operations described herein. With reference to FIGS. 1-25, the laptop 2500 may include a system-on-chip (SoC) 102 and/or a processor 2502 coupled to a memory 2504, antennas 2506, a wireless transceiver 2508, a speaker 2510, a microphone 2512, a camera 2514, a touchpad 2516, a keyboard 2518, and a high-resolution display 2520. The memory 2504 may include volatile memory, non-volatile memory, dynamic memory, static memory, or any combination thereof. For example, the memory 2504 may include dynamic random-access memory (DRAM) for temporary storage and a non-volatile solid-state drive (SSD), such as a Non-Volatile Memory Express (NVMe) SSD, for persistent storage. The antennas 2506 may be coupled to the wireless transceiver 2508, which may support multiple wireless communication protocols, including Wi-Fi 6/6E, 5G cellular connectivity, and Bluetooth. The laptop 2500 may execute edge computing operations, process real-time data inputs, and interface with remote systems, making it suitable for implementing AI-assisted analytics, machine learning inference, and constraint processing as described in the various embodiments.

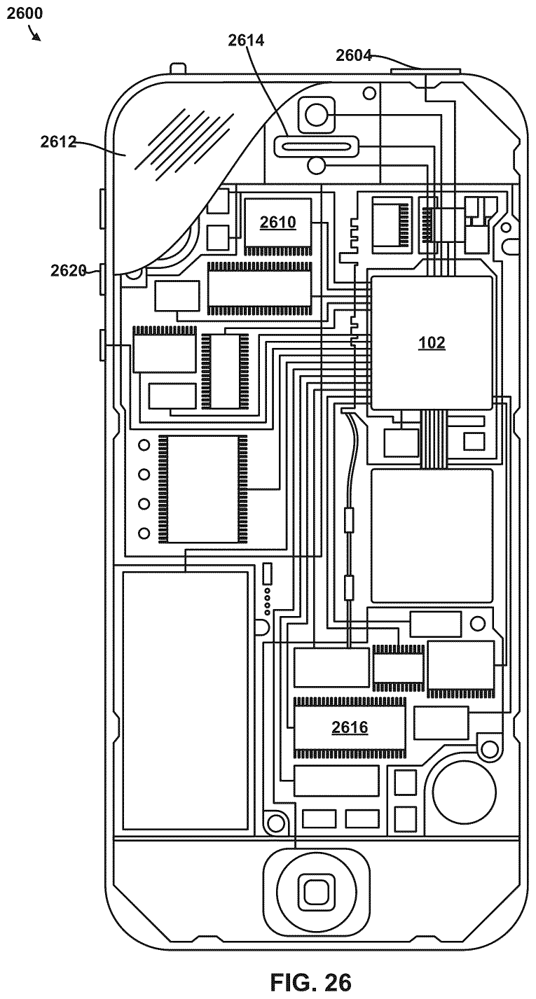

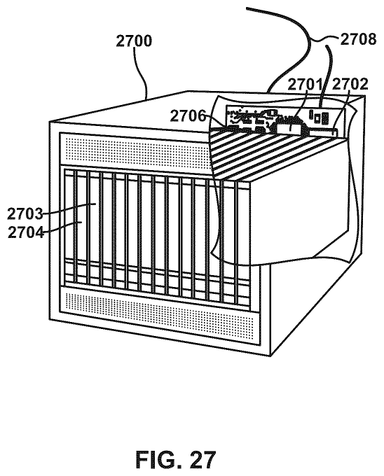

FIG. 26 is a component block diagram of an edge device in the form of a mobile computing device 2600 that may be configured to perform operations described in the various embodiments. With reference to FIGS. 1-26, the mobile computing device 2600 may include an SoC 102 coupled to internal memory 2616, a touch-sensitive display 2612, a speaker 2614, and a user-facing camera 2668. The SoC 102 may process data for implementing advanced AI-assisted analytics, real-time sensor data processing, and communication with external computing platforms. The SoC 102 may also interface with at least one subscriber identity module (SIM) or a SIM interface supporting multiple 5G New Radio (NR) subscriptions and connectivity with a 5G non-standalone (NSA) network. The mobile computing device 2600 may include an antenna 2604 coupled to a wireless transceiver 2666 integrated within the SoC 102, supporting wireless data transmission over cellular and Wi-Fi networks. The mobile computing device 2600 may also include user interface components such as menu selection buttons or rocker switches 2620 for receiving user inputs. The device may incorporate a sound encoding/decoding (CODEC) circuit 2610 configured to digitize audio input received from the microphone and decode incoming audio data for output through the speaker 2614. Additionally, one or more processors within the SoC 102, wireless transceiver 2666, and CODEC circuit 2610 may include integrated digital signal processing (DSP) circuits to manage complex signal processing tasks such as noise cancellation, voice recognition, and real-time audio enhancement.

All or portions of some embodiments may be implemented in cloud-based or edge-computing environments and may be executed on commercially available computing devices, including the server computing device 2600 illustrated in FIG. 26. The server computing device 2600 may include a SoC 102 or one or more processors 2602, such as a multi-core processor, coupled to memory 2604, storage interfaces 2606 (e.g., USB ports, NVMe slots), and network access ports 2608. The network access ports 2608 may support wired and wireless communication through a network interface card (NIC) 2610 that enables connectivity over an Internet Protocol (IP) network 2612. The server computing device 2600 may process large-scale data sets, support AI model training and inference, and integrate with cloud-based analytics platforms. In some embodiments, the server computing device 2600 may coordinate with edge devices such as laptop 2500 and mobile computing device 2600 to facilitate distributed data processing, constraint analysis, and machine learning inference in real-time operational environments.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Severs 900 often include multiple processors, with dedicated processors for specific tasks such as managing cloud computing operations, data analytics, or wireless communication functions. Software applications may be stored in the internal memory before being accessed and executed by the processor. Modern processors may include extensive internal memory, often augmented with fast access cache memory, to efficiently store and process application software instructions.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). Additionally, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-improved hardware accelerators, such as GPUs, TPUs, and other dedicated processing units, may be used to efficiently execute complex algorithms.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A space launch service platform (SLSP) computing system, comprising:
a processing system comprising one or more processors configured to:
receive constraint data associated with launch operations, the constraint data comprising at least one of terrestrial, atmospheric, orbital, or operational constraints derived from real-time monitoring systems, historical records, or predictive models;
normalize the received constraint data into a standardized format by performing operations comprising resolving inconsistencies, aligning measurement units to a common scale, and structuring data for computational analysis into numerical, categorical, or vectorized representations;
generate a constraint graph based on the standardized constraint data, the constraint graph comprising nodes representing individual constraints and edges representing interdependencies between the constraints;
identify a plurality of time intervals from the constraint graph, wherein each time interval is associated with a computed metric indicating constraint overlap across the time interval;
compute a confidence score for each identified time interval based on a statistical analysis of historical launch outcomes, real-time monitoring data, and predictions generated by machine learning models trained to evaluate constraint variability and operational feasibility;
select a launch window from the identified time intervals based on the confidence scores, wherein the selected launch window corresponds to the time interval with the highest confidence score and satisfies predefined launch criteria associated with safety, resource availability, and regulatory compliance; and
adjust at least one operational parameter associated with the launch based on the selected launch window, wherein the adjustment comprises modifying a trajectory profile, rescheduling ground operations, or reallocating resources at the launch site to align with the selected window.

2. The SLSP computing system of claim 1, wherein the processing system is configured to generate a launch readiness report comprising the selected launch window, adjusted operational parameters, and an evaluation of constraint satisfaction.

3. The SLSP computing system of claim 1, wherein the processing system is configured to receive constraint data by aggregating terrestrial object data, orbital object data, weather data, upper atmospheric data, and operational data from multiple sources, including real-time monitoring systems, historical databases, and predictive modeling systems, and to categorize the received constraint data into structured datasets corresponding to predefined categories for terrestrial, atmospheric, orbital, and operational parameters.

4. The SLSP computing system of claim 1, wherein the processing system is configured to normalize the received constraint data by applying an artificial intelligence model configured to correct inconsistencies, fill missing values, and classify the constraint data into predefined categories.

5. The SLSP computing system of claim 1, wherein the processing system is configured to generate the constraint graph by mapping temporal relationships between airspace availability, maritime clearance zones, weather conditions, and orbital conjunction risks, wherein the constraint graph encodes interdependencies among constraints to enhance the accuracy of launch feasibility assessments.

6. The SLSP computing system of claim 1, wherein the processing system is configured to compute the confidence score for each identified time interval by executing a machine learning model trained on historical launch schedules, atmospheric conditions, mission outcomes, and real-time constraint variability to predict the likelihood of satisfying operational criteria.

7. The SLSP computing system of claim 1, wherein the processing system is configured to select the launch window by generating a ranked list of alternative launch windows, each associated with a respective confidence score, to provide contingency options in response to real-time changes in constraint conditions.

8. The SLSP computing system of claim 1, wherein the processing system is configured to:
monitor real-time updates to constraint data; and
dynamically adjust the selected launch window to:
accommodate changes in constraint conditions; and
maintain compliance with predefined operational requirements.

9. The SLSP computing system of claim 1, wherein the processing system is configured to modify a planned trajectory of the launch vehicle based on real-time updates to constraint data to remain in compliance with airspace, maritime, and orbital clearance regulations.

10. The SLSP computing system of claim 1, wherein the processing system is configured to execute a reinforcement learning model to iteratively refine the launch window selection by incorporating feedback from prior launches and updating machine learning parameters based on historical and real-time performance data.

11. A computer-implemented method for identifying a launch window for a launch vehicle, the method comprising:
receiving constraint data associated with launch operations, the constraint data comprising at least one of terrestrial, atmospheric, orbital, or operational constraints derived from real-time monitoring systems, historical records, or predictive models;
normalizing the received constraint data into a standardized format by performing operations comprising resolving inconsistencies, aligning measurement units to a common scale, and structuring data for computational analysis into numerical, categorical, or vectorized representations;
generating a constraint graph based on the standardized constraint data, the constraint graph comprising nodes representing individual constraints and edges representing interdependencies between the constraints;
identifying a plurality of time intervals from the constraint graph, wherein each time interval is associated with a computed metric indicating constraint overlap across the time interval;
computing a confidence score for each identified time interval based on a statistical analysis of historical launch outcomes, real-time monitoring data, and predictions generated by machine learning models trained to evaluate constraint variability and operational feasibility;
selecting a launch window from the identified time intervals based on the confidence scores, wherein the selected launch window corresponds to the time interval with the highest confidence score and satisfies predefined launch criteria associated with safety, resource availability, and regulatory compliance; and
adjusting at least one operational parameter associated with the launch based on the selected launch window, wherein the adjustment comprises modifying a trajectory profile, rescheduling ground operations, or reallocating resources at the launch site to align with the selected window.

12. The method of claim 11, further comprising generating a launch readiness report comprising the selected launch window, adjusted operational parameters, and an evaluation of constraint satisfaction.

13. The method of claim 11, wherein receiving the constraint data further comprises aggregating terrestrial object data, orbital object data, weather data, upper atmospheric data, and operational data from multiple sources, including real-time monitoring systems, historical databases, and predictive modeling systems, and to categorize the received constraint data into structured datasets corresponding to predefined categories for terrestrial, atmospheric, orbital, and operational parameters.

14. The method of claim 11, wherein normalizing the received constraint data further comprises applying an artificial intelligence model configured to correct inconsistencies, fill missing values, and classify the constraint data into predefined categories.

15. The method of claim 11, wherein generating the constraint graph comprises mapping temporal relationships between airspace availability, maritime clearance zones, weather conditions, and orbital conjunction risks, wherein the constraint graph encodes interdependencies among constraints to enhance the accuracy of launch feasibility assessments.

16. The method of claim 11, wherein computing the confidence score for each identified time interval comprises executing a machine learning model trained on historical launch schedules, atmospheric conditions, mission outcomes, and real-time constraint variability to predict the likelihood of satisfying operational criteria.

17. The method of claim 11, wherein selecting the launch window further comprises generating a ranked list of alternative launch windows, each associated with a respective confidence score, to provide contingency options in response to real-time changes in constraint conditions.

18. The method of claim 11, further comprising:
monitoring real-time updates to constraint data; and
dynamically adjusting the selected launch window to accommodate changes in constraint conditions and maintain compliance with predefined operational requirements.

19. The method of claim 11, further comprising modifying a planned trajectory of the launch vehicle based on real-time updates to constraint data to remain in compliance with airspace, maritime, and orbital clearance regulations.

20. The method of claim 11, further comprising executing a reinforcement learning model to iteratively refine the launch window selection by incorporating feedback from prior launches and updating machine learning parameters based on historical and real-time performance data.

21. A non-transitory processor-readable storage medium having stored thereon processor-executable instructions configured to cause a processing system in a computing device to perform operations for identifying a launch window for a launch vehicle, the operations comprising:
receiving constraint data associated with launch operations, the constraint data comprising at least one of terrestrial, atmospheric, orbital, or operational constraints derived from real-time monitoring systems, historical records, or predictive models;
normalizing the received constraint data into a standardized format by performing operations comprising resolving inconsistencies, aligning measurement units to a common scale, and structuring data for computational analysis into numerical, categorical, or vectorized representations;
generating a constraint graph based on the standardized constraint data, the constraint graph comprising nodes representing individual constraints and edges representing interdependencies between the constraints;
identifying a plurality of time intervals from the constraint graph, wherein each time interval is associated with a computed metric indicating constraint overlap across the time interval;
computing a confidence score for each identified time interval based on a statistical analysis of historical launch outcomes, real-time monitoring data, and predictions generated by machine learning models trained to evaluate constraint variability and operational feasibility;
selecting a launch window from the identified time intervals based on the confidence scores, wherein the selected launch window corresponds to the time interval with the highest confidence score and satisfies predefined launch criteria associated with safety, resource availability, and regulatory compliance; and
adjusting at least one operational parameter associated with the launch based on the selected launch window, wherein the adjustment comprises modifying a trajectory profile, rescheduling ground operations, or reallocating resources at the launch site to align with the selected window.

22. The non-transitory processor-readable storage medium of claim 21, wherein the stored processor-executable instructions are configured to cause the processing system to perform operations further comprising generating a launch readiness report comprising the selected launch window, adjusted operational parameters, and an evaluation of constraint satisfaction.

23. The non-transitory processor-readable storage medium of claim 21, wherein the stored processor-executable instructions are configured to cause the processing system to perform operations such that receiving the constraint data further comprises aggregating terrestrial object data, orbital object data, weather data, upper atmospheric data, and operational data from multiple sources, including real-time monitoring systems, historical databases, and predictive modeling systems, and to categorize the received constraint data into structured datasets corresponding to predefined categories for terrestrial, atmospheric, orbital, and operational parameters.

24. The non-transitory processor-readable storage medium of claim 21, wherein the stored processor-executable instructions are configured to cause the processing system to perform operations such that normalizing the received constraint data further comprises applying an artificial intelligence model configured to correct inconsistencies, fill missing values, and classify the constraint data into predefined categories.

25. The non-transitory processor-readable storage medium of claim 21, wherein the stored processor-executable instructions are configured to cause the processing system to perform operations such that generating the constraint graph comprises mapping temporal relationships between airspace availability, maritime clearance zones, weather conditions, and orbital conjunction risks, wherein the constraint graph encodes interdependencies among constraints to enhance the accuracy of launch feasibility assessments.

26. The non-transitory processor-readable storage medium of claim 21, wherein the stored processor-executable instructions are configured to cause the processing system to perform operations such that computing the confidence score for each identified time interval comprises executing a machine learning model trained on historical launch schedules, atmospheric conditions, mission outcomes, and real-time constraint variability to predict the likelihood of satisfying operational criteria.

27. The non-transitory processor-readable storage medium of claim 21, wherein the stored processor-executable instructions are configured to cause the processing system to perform operations such that selecting the launch window further comprises generating a ranked list of alternative launch windows, each associated with a respective confidence score, to provide contingency options in response to real-time changes in constraint conditions.

28. The non-transitory processor-readable storage medium of claim 21, wherein the stored processor-executable instructions are configured to cause the processing system to perform operations further comprising:
monitoring real-time updates to constraint data; and
dynamically adjusting the selected launch window to accommodate changes in constraint conditions and maintain compliance with predefined operational requirements.

29. The non-transitory processor-readable storage medium of claim 21, wherein the stored processor-executable instructions are configured to cause the processing system to perform operations further comprising modifying a planned trajectory of the launch vehicle based on real-time updates to constraint data to remain in compliance with airspace, maritime, and orbital clearance regulations.

30. The non-transitory processor-readable storage medium of claim 21, wherein the stored processor-executable instructions are configured to cause the processing system to perform operations further comprising executing a reinforcement learning model to iteratively refine the launch window selection by incorporating feedback from prior launches and updating machine learning parameters based on historical and real-time performance data.
